(19) United States
(12) Patent Application Publication
(10) Pub. No.: US 2014/0221308 A1
(43) Pub. Date: Aug. 7, 2014

(54) METHODS AND COMPOSITIONS OF REDUCING AND PREVENTING BACTERIAL GROWTH AND THE FORMATION OF BIOFILM ON A SURFACE UTILIZING CHITOSAN-DERIVATIVE COMPOUNDS

(71) Applicants: Shenda Baker, Upland, CA (US); William P. Wiesmann, Washington, DC (US); Stacy M. Townsend, Rancho Cucamonga, CA (US)

(72) Inventors: Shenda Baker, Upland, CA (US); William P. Wiesmann, Washington, DC (US); Stacy M. Townsend, Rancho Cucamonga, CA (US)

(73) Assignee: SYNEDGEN, INC., Claremont, CA (US)

(21) Appl. No.: 14/130,253

(22) PCT Filed: Jun. 29, 2012
(86) PCT No.: PCT/US12/45003

§ 371 Date: Apr. 21, 2014

Related U.S. Application Data
(60) Provisional application No. 61/503,963, filed on Jul. 1, 2011.

(51) Int. Cl. A01N 43/16

(52) U.S. Cl. CPC A01N 43/16
USPC 514/55

(57) ABSTRACT

A method of treating a surface, the method comprising contacting (e.g., spraying) an effective amount of a composition comprising a chitosan (e.g., soluble or derivatized chitosan) with the surface, thereby treating the surface. Non-pharmaceutical compositions (e.g., liquid or dry powder compositions) include chitosan (e.g., a soluble or derivatized chitosan). The compounds and compositions described herein are biocompatible (e.g., non-toxic) and/or biodegradable (e.g., eco-friendly). Methods using the compositions described herein include methods of treating a surface (e.g., an inert and/or non-animal surface, e.g., a synthetic or semi-synthetic surface (e.g., cellulose, ceramic, plastic, metal, glass, wood, or stone); or a food or food product surface, the method comprising contacting (e.g., spraying) an effective amount of a composition comprising a chitosan (e.g., a soluble or derivatized chitosan described herein) with the inert and/or non-animal surface, or the food or food product surface, thereby treating the surface.

### FIELD OF THE INVENTION

The invention relates to soluble or derivatized chitosans and their use to reduce bacteria, prevent bacterial growth, reduce bacterial biofilms, or prevent bacterial biofilm formation, on an inert and/or non-animal surface, or a food or food product surface.

### BACKGROUND

Pathogenic bacteria can adhere to a host or a surface. In some instances, the bacteria can colonize, forming a biofilm. Bacterial contamination on the surfaces (e.g., in the form of a biofilm) of medical devices is one of the causes of nosocomial infections. Existing standard operating procedures, such as standard sanitizing and disinfection procedures in an institutional setting, often involve toxic chemicals and are not eco-friendly. Further, there has been increasing concerns raised by the general public and industry regulators in terms of food safety caused by food-borne bacteria. However, many intervention strategies that are currently employed to ensure food safety involve potentially harmful synthetic additives. Thus, biocompatible and biodegradable compounds or compositions are needed for surface sanitization and disinfection, for example, in a hospital setting or during food processing and packaging.

### SUMMARY OF THE INVENTION

Non-pharmaceutical compositions (e.g., liquid or dry powder compositions) comprising a chitosan (e.g., a soluble or derivatized chitosan) are described herein. The compounds and compositions described herein are biocompatible (e.g., non-toxic) and/or biodegradable (e.g., eco-friendly). Exemplary compositions include aqueous solutions. Exemplary methods using the compositions described herein include methods of treating a surface (e.g., an inert and/or non-animal surface, e.g., a synthetic or semi-synthetic surface (e.g., cellulose, ceramic, plastic, metal, glass, wood, or stone); or a food or food product surface, the method comprising contacting (e.g., spraying) an effective amount of a composition comprising a chitosan (e.g., a soluble or derivatized chitosan described herein) with the inert and/or non-animal surface, or the food or food product surface, thereby treating the surface. These inert and/or non-animal surfaces can exist, e.g., in a high density population area such as a hospital, food processing or handling facility, nursing home, school, military facility, prison, public transportation, kitchen, or restaurant. In some embodiments, the method reduces the bioburden on the surface (e.g., by killing bacteria on the surface). In some embodiments, the method reduces (e.g., disrupts) bacterial biofilm on the surface. In some embodiments, the method prevents or inhibits (e.g., slows) the formation of bacterial biofilm or the growth of bacteria on the surface. The methods described herein can be used in addition to (e.g., without changing, e.g., together with or after) one or more existing standard operating procedures (e.g., sanitizing and/or disinfection procedures and/or techniques), for example, in an institutional setting. Methods of processing food or preserving a food product are described herein. The method comprises contacting an effective amount of a composition described herein with the food or food product (e.g., at the surface of the food or food product), e.g., to increase shelf life, inhibit bacterial spoilage, or control bacterial contamination of the food or food product. Described herein are also food products and packaging for a food product comprising a chitosan (e.g., a soluble or derivatized chitosan described herein).

In one aspect, the invention features a method of treating a surface (e.g., a surface described herein), the method comprising: contacting (e.g., spraying) an effective amount of a composition comprising a chitosan (e.g., a soluble chitosan or derivatized chitosan described herein) with the surface, thereby treating the surface.

In some embodiments, the surface comprises an inert and/or non-animal surface.

In some embodiments, the surface comprises a food or food product surface.

In some embodiments, the composition reduces, delays, or prevents bacterial growth on the surface.

In some embodiments, the composition reduces, delays, or prevents bacterial biofilm formation on the surface.

In some embodiments, the soluble or derivatized chitosan is soluble in aqueous solution from about pH 6.8 to about pH 7.4.

In some embodiments, the soluble or derivatized chitosan is soluble in aqueous solution from about pH 3 to about pH 9.

In some embodiments, the soluble chitosan is underivatized.

In some embodiments, the derivatized chitosan comprises a chitosan of the following formula (I):

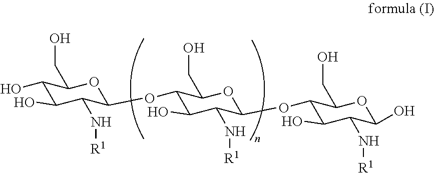

wherein:

n is an integer between 20 and 6000; and

each R¹ is independently selected for each occurrence from hydrogen, acetyl, and either:

a) a group of formula (II):

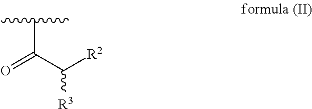

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments the derivatized chitosan comprises of the following formula (I) wherein at least 90% by number or weight of R¹ moieties are as defined in formula (I) (e.g., at least about 95%, at least about 96%, at least about 97%, at least about 98%, or at least about 99%):

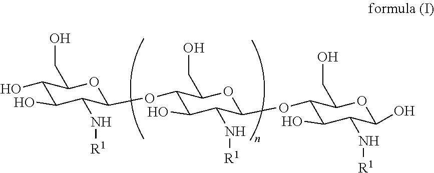

wherein:

n is an integer between 20 and 6000; and

each R¹ is independently selected for each occurrence from hydrogen, acetyl, and either:

a) a group of formula (II):

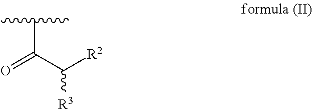

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, between 25-95% of R¹ substituents are hydrogen.

In some embodiments, between 55-90% of R¹ substituents are hydrogen.

In some embodiments, between 1-50% of R¹ substituents are acetyl.

In some embodiments, between 4-20% of R¹ substituents are acetyl.

In some embodiments, between 2-50% of R¹ substituents are a group of formula (II).

In some embodiments, between 4-30% of R¹ substituents are a group of formula (II).

In some embodiments, 55-90% of R¹ substituents are hydrogen, 4-20% of R¹ substituents are acetyl, 4-30% of R¹ substituents are a group of formula (II).

In some embodiments, R² is amino and R³ is an arginine side chain.

In some embodiments, R¹ is selected from one of the following:

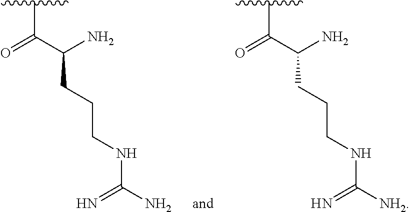 [SMILES: *C(=O)[C@@H](N)CCCNC(=N)N ; *C(=O)[C@H](N)CCCNC(=N)N]

In some embodiments, R² is amino and R³ is a lysine side chain.

In some embodiments, R¹ is selected from one of the following:

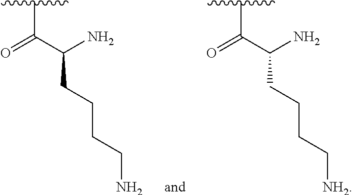 [SMILES: *C(=O)[C@@H](N)CCCCN ; *C(=O)[C@H](N)CCCCN]

In some embodiments, R² is amino and R³ is a histidine side chain.

In some embodiments, R¹ is selected from one of the following:

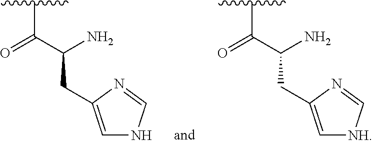 [SMILES: *C(=O)[C@@H](N)Cc1c[nH]cn1 ; *C(=O)[C@H](N)Cc1c[nH]cn1]

In some embodiments, at least 1% of R¹ substituents are selected from one of the following:

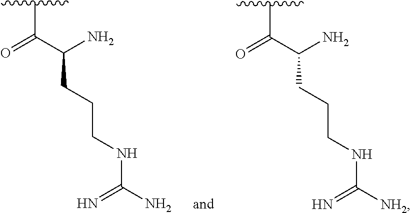 [SMILES: *C(=O)[C@@H](N)CCCNC(=N)N ; *C(=O)[C@H](N)CCCNC(=N)N]

AND at least 1% of R¹ substituents are selected from the following:

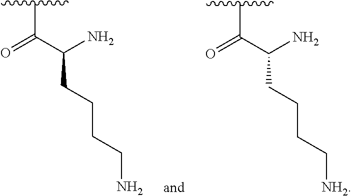 [SMILES: *C(=O)[C@@H](N)CCCCN ; *C(=O)[C@H](N)CCCCN]

In some embodiments, R² is amino and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

In some embodiments, R¹ is selected from one of the following:

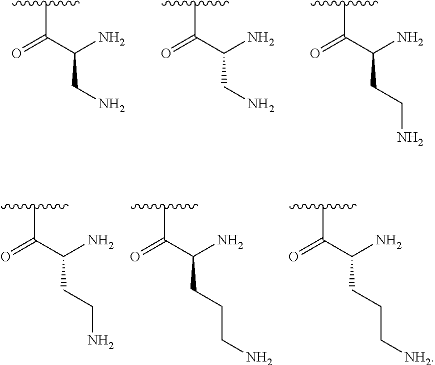

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

In some embodiments, R¹ is selected from one of the following:

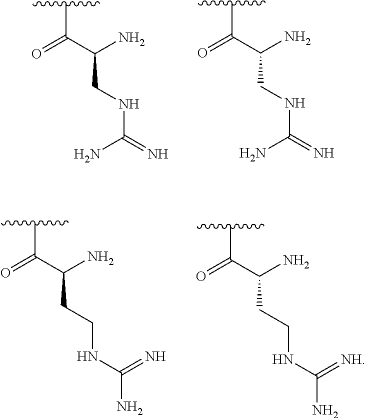 [SMILES: *C(=O)[C@@H](N)CNC(=N)N ; *C(=O)[C@H](N)CNC(=N)N ; *C(=O)[C@@H](N)CCNC(=N)N ; *C(=O)[C@H](N)CCNC(=N)N]

In some embodiments, R² is amino that is substituted with a nitrogen protecting group prior to substitution on chitosan and removed subsequent to substitution on chitosan.

In some embodiments, the nitrogen protecting group is tert-butyloxycarbonyl (Boc).

In some embodiments, in the synthetic process a nitrogen protecting group is used, which can provide an intermediate polymer having a nitrogen protecting group such as Boc.

In some embodiments, R² is amino.

In some embodiments, R² is hydrogen and R³ is amino.

In some embodiments, R² is hydrogen and R³ is guanidino.

In some embodiments, R² is hydrogen and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

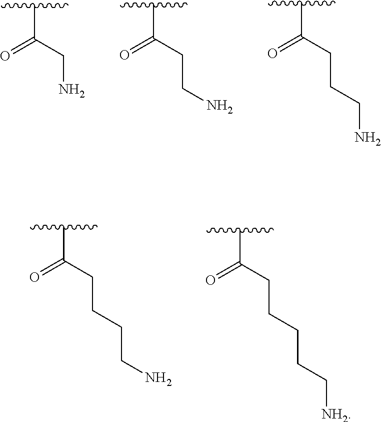 [SMILES: *C(=O)CN ; *C(=O)CCN ; *C(=O)CCCN ; *C(=O)CCCCN ; *C(=O)CCCCCN]

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

In some embodiments, R¹ is selected from one of the following:

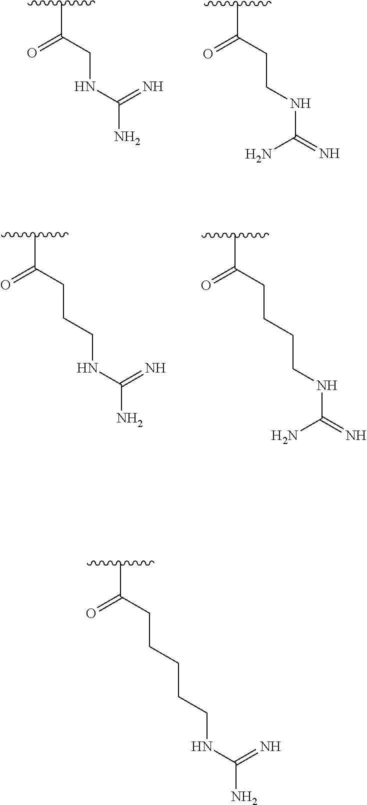 [SMILES: *C(=O)CNC(=N)N ; *C(=O)CCNC(=N)N ; *C(=O)CCCNC(=N)N ; *C(=O)CCCCNC(=N)N ; *C(=O)CCCCCNC(=N)N]

In some embodiments, at least 25% of R¹ substituents are H, at least 1% of R¹ substituents are acetyl, and at least 2% of R¹ substituents independently selected from any of the formulae specifically shown above.

In some embodiments, the functionalized chitosan of formula (I) may be further derivatized on the free hydroxyl moieties.

In some embodiments, the molecular weight of the functionalized chitosan is between 5,000 and 1,000,000 Da.

In some embodiments, the molecular weight of the functionalized chitosan is between 10,000 and 350,000 Da.

In some embodiments, the molecular weight of the functionalized chitosan is between 10,000 and 60,000 Da.

In some embodiments, the molecular weight of the functionalized chitosan is between 15,000 and 45,000 Da.

In some embodiments, the molecular weight of the functionalized chitosan is between 15,000 and 35,000 Da.

In some embodiments, the molecular weight of the functionalized chitosan is between 15,000 and 25,000 Da.

In some embodiments, the functionalized chitosan is soluble in aqueous solution between pH 6 and 8.

In some embodiments, the functionalized chitosan is soluble in aqueous solution between pH 6.8 and pH 7.4.

In some embodiments, the chitosan is functionalized at between 5% and 50%.

In a preferred embodiment, the chitosan is functionalized at between 20% and 30%.

In some embodiments, the degree of deacetylation (% DDA) of the derivatized chitosan is between 75% and 95%.

In some embodiments, the degree of deacetylation (% DDA) of the derivatized chitosan is between 80% and 90%.

In some embodiments, the polydispersity index (PDI) of the derivatized chitosan is between 1.0 and 2.5.

In some embodiments, the polydispersity index (PDI) of the derivatized chitosan is between 1.2 and 1.8.

In some embodiments, the functionalized chitosan is substantially free of other impurities, e.g., salt, e.g., NaCl.

In some embodiments, the composition has less than about 20%, 15%, 10%, 5%, 2%, or 1%, or is substantially free, of a chitosan polymer wherein one or more of the nitrogen-containing groups of the glucosamine monomer is substituted with a polymerized amino acid, e.g., polyarginine (e.g., diargine, triargine, etc).

In some embodiments, the composition has less than about 20%, 15%, 10%, 5%, 2%, or 1%, or is substantially free, of a chitosan polymer having a molecular weight of less than 15,000 Da, 10,000 Da, or 5,000 Da.

In one aspect, the invention features a method of reducing (e.g., killing) bacteria, e.g., bacterial contamination, on an inert surface and/or a non-animal surface, the method comprising: contacting (e.g., spraying) an effective amount of a composition comprising a soluble or derivatized chitosan with the surface, thereby reducing (e.g., killing) bacteria, e.g., bacterial contamination, on the surface.

In some embodiments, the composition sanitizes the surface.

In some embodiments, the composition is biocompatible (e.g., non-toxic) and/or biodegradable (e.g., eco-friendly), e.g., compared to an existing standard operating procedure (e.g., a sanitizing or disinfection procedure and/or technique), e.g., in an institutional setting.

In some embodiments, the composition is a liquid composition, e.g., an aqueous-based solution.

In some embodiments, the method further comprises allowing the liquid to be removed or the surface to dry after the composition has been contacted with the surface, e.g., by evaporation, leaving the soluble or derivatized chitosan on the surface.

In some embodiments, the soluble or derivatized chitosan is allowed to remain on the surface, e.g., without removing the derivatized chitosan (e.g., by wiping, rinsing, scraping, or abrading the surface), e.g., until the sanitizing activity of the derivatized chitosan diminishes.

In some embodiments, the method further comprises allowing the liquid to be removed or the surface to dry after the composition has been contacted with the surface, without removing the soluble or derivatized chitosan, e.g., by wiping, rinsing, scraping, or abrading the surface, e.g., for at least about 5 minutes, 10 minutes, 20 minutes, 30 minutes, 45 minutes, 1 hour, 2 hours, 4 hours, 6 hours, 12 hours, or 24 hours.

In some embodiments, the method further comprises removing the soluble or derivatized chitosan, e.g., by washing, wiping, rinsing, scraping, or abrading the surface after the composition has been contacted with the surface, e.g., at least about 5 minutes, 10 minutes, 20 minutes, 30 minutes, 45 minutes, 1 hour, 2 hours, 4 hours, 6 hours, 12 hours, or 24 hours after the composition has been contacted with the surface.

In some embodiments, the composition is a dry powder composition, e.g., a dry powder composition that is dispersible or dissolvable in an aqueous solution.

In some embodiments, the method further comprises forming the composition by mixing a soluble or derivatized chitosan described herein, e.g., in a form of dried powder, with a solvent.

In some embodiments, the composition reduces (e.g., kills) the bacteria, e.g., bacterial contamination, by at least 90, 95, 99, 99.9, or 99.99%.

In a typical embodiment, the composition reduces (e.g., kills) the bacteria, e.g., bacterial contamination, by at least 99.99%.

In a typical embodiment, the composition reduces (e.g., kills) the bacteria, e.g., bacterial contamination, by at least 99.99% within an hour of contact.

In some embodiments, the effective amount is between about 0.1 and about 2.0 μg/cm², about 0.1 and 1.5 μg/cm², about 0.1 and 1.0 μg/cm², about 0.1 and 0.5 μg/cm², about 0.1 and 0.25 μg/cm², about 1.5 and 2.0 μg/cm², or about 1.0 and 2.0 μg/cm², about 0.5 and 2.0 μg/cm², about 0.25 and 2.0 μg/cm², about 0.25 and 1.5 μg/cm², or about 0.5 and 1.0 μg/cm².

In a typical embodiment, the effective amount is between about 0.6 and about 1.5 μg/cm², e.g., when the surface is a plastic surface.

In a typical embodiment, the effective amount is between about 0.25 and about 1.0 μg/cm², e.g., when the surface is a metal surface.

In some embodiments, the surface is a synthetic or semi-synthetic surface, e.g. a polymer surface.

In some embodiments, the surface is selected from the group consisting of a cellulose surface, a ceramic surface, a plastic surface (e.g., Bakelite, polystyrene, polyvinyl chloride (PVC), poly(methyl methacrylate) (PMMA, also known as acrylic glass)), a metal surface, a glass surface, a wood surface, a rubber surface, a stone surface (e.g., granite, marble, nanocrystal stone, nanoquartz stone), or a hybrid thereof.

In some embodiments, the surface is a non-porous surface.

In some embodiments, the surface is in e.g., a hospital or medical/dental facility, a nursing home, a laboratory, a pharmaceutical or medical device manufacturing facility, a school or preschool, a childcare center, a military facility, a prison, a restaurant, a kitchen, a food processing and/or handling facility, a bathroom or toilet facility, a gym or fitness center, a barbershop or beauty salon, a library, a museum, a public transportation (e.g., a plane, train or bus), an airport, a train or bus station, a hotel, a steam room, a spa, or a paper mill.

In some embodiments, the bacteria comprise Gram-negative and/or Gram-positive bacteria.

In some embodiments, the bacteria cause one or more of nosocomial or community-acquired infection(s).

In some embodiments, the bacteria are resistant to one or more of antibiotic(s).

In some embodiments, the bacteria comprise one or more of the bacteria described herein.

In some embodiments, the bacteria comprise Salmonella choleraesuis, Staphylococcus aureus, Klebsiella pneumoniae, Enterobacter aerogenes, Pseudomonas aeruginosa, MRSA, E. coli, vancomycin resistant Enterococcus faecalis, Acinetobacter baumannii, MDR Acinetobacter baumannii, or MDR Klebsiella pneumoniae.

In some embodiments, the method further comprises placing the composition in a container (e.g., an aerosol spray bottle or can) for dispensing the composition e.g., as a spray.

In some embodiments, the soluble or derivatized chitosan is soluble in aqueous solution from about pH 6.8 to about pH 7.4.

In some embodiments, the soluble or derivatized chitosan is soluble in aqueous solution from about pH 3 to about pH 9.

In some embodiments, the soluble chitosan is underivatized.

In some embodiments, the derivatized chitosan comprises a chitosan of the following formula (I):

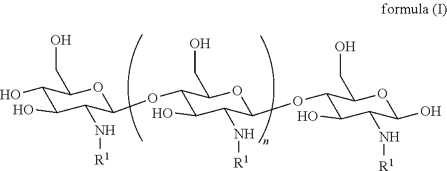

wherein:

n is an integer between 20 and 6000; and

each R¹ is independently selected for each occurrence from hydrogen, acetyl, and either:

a) a group of formula (II):

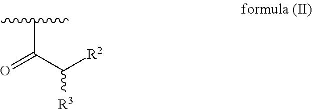

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, the derivatized chitosan comprises of the following formula (I) wherein at least 90% by number or weight of R¹ moieties are as defined in formula (I) (e.g., at least about 95%, at least about 96%, at least about 97%, at least about 98%, or at least about 99%):

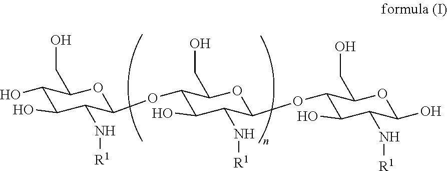

wherein:

n is an integer between 20 and 6000; and

each R¹ is independently selected for each occurrence from hydrogen, acetyl, and either:

a) a group of formula (II):

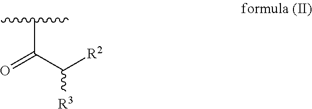

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, between 25-95% of R¹ substituents are hydrogen.

In some embodiments, between 55-90% of R¹ substituents are hydrogen.

In some embodiments, between 1-50% of R¹ substituents are acetyl.

In some embodiments, between 4-20% of R¹ substituents are acetyl.

In some embodiments, between 2-50% of R¹ substituents are a group of formula (II).

In some embodiments, between 4-30% of R¹ substituents are a group of formula (II).

In some embodiments, 55-90% of R¹ substituents are hydrogen, 4-20% of R¹ substituents are acetyl, 4-30% of R¹ substituents are a group of formula (II).

In some embodiments, R² is amino and R³ is an arginine side chain.

In some embodiments, R¹ is selected from one of the following:

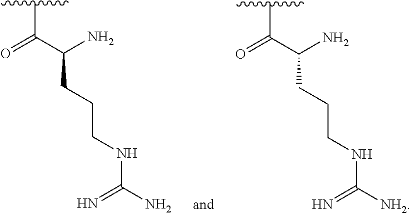 [SMILES: *C(=O)[C@@H](N)CCCNC(=N)N ; *C(=O)[C@H](N)CCCNC(=N)N]

In some embodiments, R² is amino and R³ is a lysine side chain.

In some embodiments, R¹ is selected from one of the following:

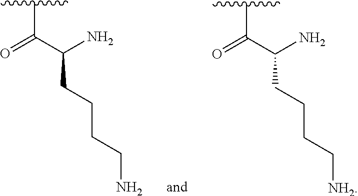 [SMILES: *C(=O)[C@@H](N)CCCCN ; *C(=O)[C@H](N)CCCCN]

In some embodiments, R² is amino and R³ is a histidine side chain.

In some embodiments, R¹ is selected from one of the following:

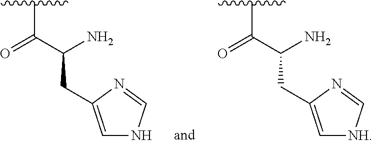 [SMILES: *C(=O)[C@@H](N)Cc1c[nH]cn1 ; *C(=O)[C@H](N)Cc1c[nH]cn1]

In some embodiments, at least 1% of R¹ substituents are selected from one of the following:

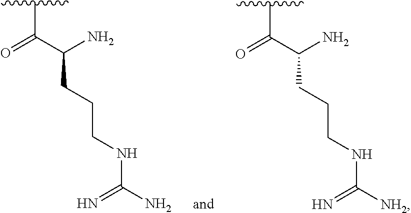 [SMILES: *C(=O)[C@@H](N)CCCNC(=N)N ; *C(=O)[C@H](N)CCCNC(=N)N]

AND at least 1% of R¹ substituents are selected from the following:

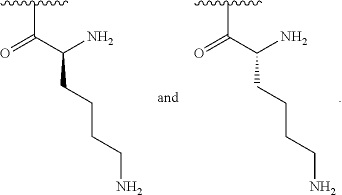 [SMILES: *C(=O)[C@@H](N)CCCCN ; *C(=O)[C@H](N)CCCCN]

In some embodiments, R² is amino and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

In some embodiments, R¹ is selected from one of the following:

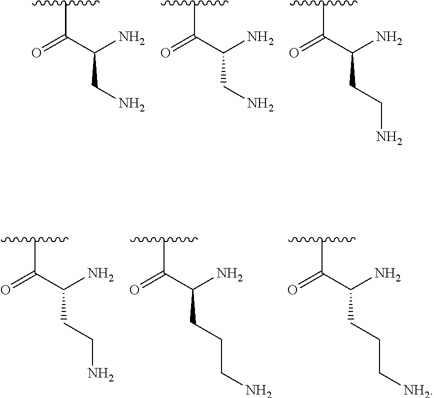

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

In some embodiments, R¹ is selected from one of the following:

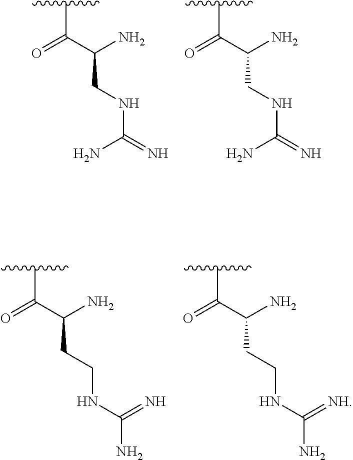 [SMILES: *C(=O)[C@@H](N)CNC(=N)N ; *C(=O)[C@H](N)CNC(=N)N ; *C(=O)[C@@H](N)CCNC(=N)N ; *C(=O)[C@H](N)CCNC(=N)N]

In some embodiments, R² is amino that is substituted with a nitrogen protecting group prior to substitution on chitosan and removed subsequent to substitution on chitosan.

In some embodiments, the nitrogen protecting group is tert-butyloxycarbonyl (Boc).

In some embodiments, in the synthetic process a nitrogen protecting group is used, which can provide an intermediate polymer having a nitrogen protecting group such as Boc.

In some embodiments, R² is amino.

In some embodiments, R² is hydrogen and R³ is amino.

In some embodiments, R² is hydrogen and R³ is guanidino.

In some embodiments, R² is hydrogen and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

In some embodiments, R¹ is selected from one of the following:

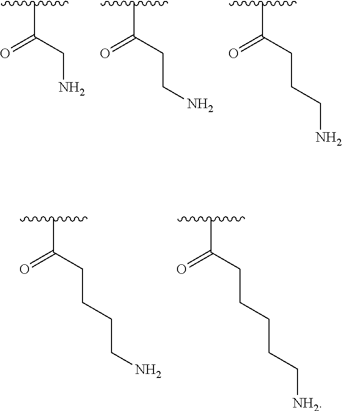

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

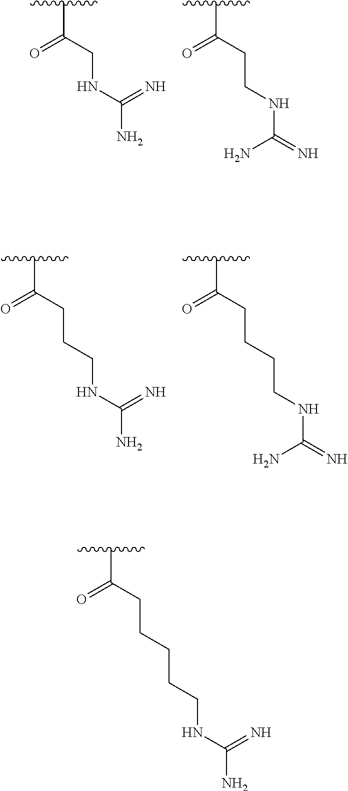 [SMILES: *C(=O)CNC(=N)N ; *C(=O)CCNC(=N)N ; *C(=O)CCCNC(=N)N ; *C(=O)CCCCNC(=N)N ; *C(=O)CCCCCNC(=N)N]

In some embodiments, at least 25% of R¹ substituents are H, at least 1% of R¹ substituents are acetyl, and at least 2% of R¹ substituents independently selected from any of the formulae specifically shown above.

In some embodiments, the functionalized chitosan of formula (I) may be further derivatized on the free hydroxyl moieties.

In some embodiments, the molecular weight of the functionalized chitosan is between 5,000 and 1,000,000 Da.

In some embodiments, the molecular weight of the functionalized chitosan is between 10,000 and 350,000 Da.

In some embodiments, the molecular weight of the functionalized chitosan is between 10,000 and 60,000 Da.

In some embodiments, the molecular weight of the functionalized chitosan is between 15,000 and 45,000 Da.

In some embodiments, the molecular weight of the functionalized chitosan is between 15,000 and 35,000 Da.

In some embodiments, the molecular weight of the functionalized chitosan is between 15,000 and 25,000 Da.

In some embodiments, the functionalized chitosan is soluble in aqueous solution between pH 6 and 8.

In some embodiments, the functionalized chitosan is soluble in aqueous solution between pH 6.8 and pH 7.4.

In some embodiments, the chitosan is functionalized at between 5% and 50%.

In a preferred embodiment, the chitosan is functionalized at between 20% and 30%.

In some embodiments, the degree of deacetylation (% DDA) of the derivatized chitosan is between 75% and 95%.

In some embodiments, the degree of deacetylation (% DDA) of the derivatized chitosan is between 80% and 90%.

In some embodiments, the polydispersity index (PDI) of the derivatized chitosan is between 1.0 and 2.5.

In some embodiments, the polydispersity index (PDI) of the derivatized chitosan is between 1.2 and 1.8.

In some embodiments, the functionalized chitosan is substantially free of other impurities, e.g., salt, e.g., NaCl.

In some embodiments, the composition has less than about 20%, 15%, 10%, 5%, 2%, or 1%, or is substantially free, of a chitosan polymer wherein one or more of the nitrogen-containing groups of the glucosamine monomer is substituted with a polymerized amino acid, e.g., polyarginine (e.g., diargine, triargine, etc).

In some embodiments, the composition has less than about 20%, 15%, 10%, 5%, 2%, or 1%, or is substantially free, of a chitosan polymer having a molecular weight of less than 15,000 Da, 10,000 Da, or 5,000 Da.

In another aspect, the invention features a method of reducing the ability of a biofilm to form, or bacteria to grow, on an inert surface and/or a non-animal surface, the method comprising: contacting (e.g., spraying) an effective amount of a composition comprising a soluble or derivatized chitosan with the surface, thereby reducing the ability of a biofilm to form, or bacteria to grow, on the surface.

In some embodiments, the composition is used as a residual surface agent with prophylactic activity.

In some embodiments, the composition is biocompatible (e.g., non-toxic) and/or biodegradable (e.g., eco-friendly), e.g., compared to an existing standard operating procedure (e.g., a sanitizing or disinfection procedure and/or technique), e.g., in an institutional setting.

In some embodiments, the composition is used in addition to (e.g., without changing, e.g., together with or after) one or more existing standard operating procedures (e.g., sanitizing or disinfection procedures and/or techniques), e.g., in an institutional setting.

In some embodiments, the composition is a liquid composition, e.g., aqueous-based solution.

In some embodiments, the method further comprises allowing the liquid to be removed or the surface to dry after the composition has been contacted with the surface, e.g., by evaporation, leaving the soluble or derivatized chitosan on the surface.

In some embodiments, the soluble or derivatized chitosan is allowed to remain on the surface, e.g., without removing the composition (e.g., by wiping, rinsing, scraping, or abrading the surface), e.g., until next disinfection.

In some embodiments, the method further comprises allowing the liquid to be removed or the surface to dry after the composition has been contacted with the surface, without removing the soluble or derivatized chitosan, e.g., by wiping, rinsing, scraping, or abrading the surface, e.g., for at least about 1 hour, 2 hours, 4 hours, 6 hours, 12 hours, 24 hours, 36 hours, 48 hours, or 72 hours.

In some embodiments, the method further comprises removing the soluble or derivatized chitosan, e.g., by washing, wiping, rinsing, scraping, or abrading the surface after the composition has been contacted with the surface, e.g., at least about 1 hour, 2 hours, 4 hours, 6 hours, 12 hours, 24 hours, 36 hours, 48 hours, or 72 hours, after the composition has been contacted with the surface.

In some embodiments, the composition is a dry powder composition, e.g., a dry powder composition that is dispersible or dissolvable in an aqueous solution.

In some embodiments, the composition prophylactically reduces (e.g., kills) the bacteria, e.g., bacterial contamination, by at least 90, 95, 99, 99.9 or 99.99% provided the surface is not washed, wiped, rinsed, scraped, or abraded, for at least one day, one week, or one month.

In a typical embodiment, the composition prophylactically reduces (e.g., kills) the bacteria, e.g., bacterial contamination, by at least 99.9% provided the surface is not washed, wiped, rinsed, scraped, or abraded, for up to one week.

In a typical embodiment, the bacteria is prophylactically reduced (e.g., killed) for at least one week.

In some embodiments, the surface is a synthetic or semi-synthetic surface, e.g. a polymer surface.

In some embodiments, the surface is selected from the group consisting of a cellulose surface, a ceramic surface, a plastic surface (e.g., Bakelite, polystyrene, polyvinyl chloride (PVC), poly(methyl methacrylate) (PMMA, also known as acrylic glass)), a metal surface, a glass surface, a wood surface, a rubber surface, a stone surface (e.g., granite, marble, nanocrystal stone, nanoquartz stone), or a hybrid thereof.

In some embodiments, the surface is a non-porous surface.

In some embodiments, the surface is in e.g., a hospital or medical/dental facility, a nursing home, a laboratory, a pharmaceutical or medical device manufacturing facility, a school or preschool, a childcare center, a military facility, a prison, a restaurant, a kitchen, a food processing and/or handling facility, a bathroom or toilet facility, a gym or fitness center, a barbershop or beauty salon, a library, a museum, a public transportation (e.g., a plane, train or bus), an airport, a train or bus station, a hotel, a steam room, a spa, or a paper mill.

In some embodiments, the effective amount is between about 0.1 and about 100 μg/cm², e.g., between about 0.1 and 50 μg/cm², between about 0.1 and 25 μg/cm², between about 0.1 and 10 μg/cm², between about 0.1 and 5 μg/cm², between about 0.1 and 1 μg/cm², between about 1.0 and 100 μg/cm², between about 10 and 100 μg/cm², between about 25 and 100 μg/cm², between about 50 and 100 μg/cm², between about 0.2 and 25 μg/cm², between about 0.5 and 10 μg/cm², or between about 1.0 and 5.0 μg/cm².

In a typical embodiment, the effective amount is between about 0.4 and 25 μg/cm².

In a typical embodiment, the effective amount is between about 0.25 and about 1.0 μg/cm², e.g., when the surface is a metal surface.

In some embodiments, the bacteria comprise Gram-negative and/or Gram-positive bacteria.

In some embodiments, the bacteria cause one or more of nosocomial or community-acquired infection(s).

In some embodiments, the bacteria are resistant to one or more of antibiotic(s).

In some embodiments, the bacteria comprise one or more of the bacteria described herein.

In some embodiments, the bacteria comprise Salmonella choleraesuis, Staphylococcus aureus, Klebsiella pneumoniae, Enterobacter aerogenes, Pseudomonas aeruginosa, MRSA, E. coli, vancomycin resistant Enterococcus faecalis, Acinetobacter baumannii, MDR Acinetobacter baumannii, or MDR Klebsiella pneumoniae.

In some embodiments, the method further comprises forming the composition by mixing a soluble or derivatized chitosan described herein, e.g., in a form of dried powder, with a solvent.

In some embodiments, the method further comprises placing the composition in a container (e.g., an aerosol spray bottle or can) for dispensing the composition as a spray.

In some embodiments, the viscosity of the biofilm is reduced by at least 50%, compared to the biofilm that has not been contacted with the composition.

In some embodiments, the viscosity of the biofilm is reduced by at least two-fold, compared to the biofilm that has not been contacted with the composition.

In some embodiments, the biofilm is partially dissolved compared to the biofilm that has not been contacted with the composition.

In some embodiments, the soluble or derivatized chitosan is soluble in aqueous solution from about pH 6.8 to about pH 7.4.

In some embodiments, the soluble or derivatized chitosan is soluble in aqueous solution from about pH 3 to about pH 9.

In some embodiments, the soluble chitosan is underivatized.

In some embodiments, the derivatized chitosan comprises a chitosan of the following formula (I):

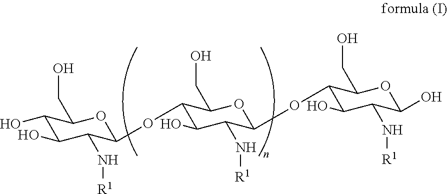

wherein:

n is an integer between 20 and 6000; and

each R¹ is independently selected for each occurrence from hydrogen, acetyl, and either:

a) a group of formula (II):

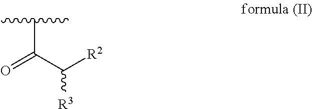

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, the derivatized chitosan comprises of the following formula (I) wherein at least 90% by number or weight of R¹ moieties are as defined in formula (I) (e.g., at least about 95%, at least about 96%, at least about 97%, at least about 98%, or at least about 99%):

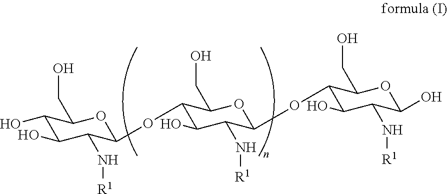

wherein:

n is an integer between 20 and 6000; and

each R¹ is independently selected for each occurrence from hydrogen, acetyl, and either:

a) a group of formula (II):

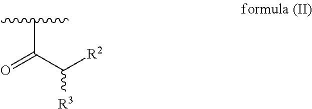

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, between 25-95% of R¹ substituents are hydrogen.

In some embodiments, between 55-90% of R¹ substituents are hydrogen.

In some embodiments, between 1-50% of R¹ substituents are acetyl.

In some embodiments, between 4-20% of R¹ substituents are acetyl.

In some embodiments, between 2-50% of R¹ substituents are a group of formula (II).

In some embodiments, between 4-30% of R¹ substituents are a group of formula (II).

In some embodiments, 55-90% of R¹ substituents are hydrogen, 4-20% of R¹ substituents are acetyl, 4-30% of R¹ substituents are a group of formula (II).

In some embodiments, R² is amino and R³ is an arginine side chain.

In some embodiments, R¹ is selected from one of the following:

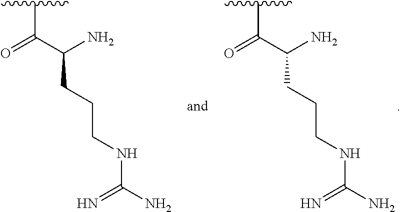 [SMILES: *C(=O)[C@@H](N)CCCNC(=N)N ; *C(=O)[C@H](N)CCCNC(=N)N]

In some embodiments, R² is amino and R³ is a lysine side chain.

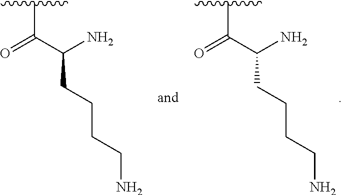 [SMILES: *C(=O)[C@@H](N)CCCCN ; *C(=O)[C@H](N)CCCCN]

In some embodiments, R² is amino and R³ is a histidine side chain.

In some embodiments, R¹ is selected from one of the following:

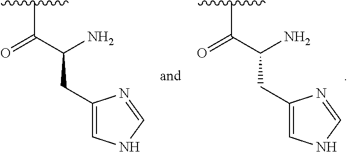 [SMILES: *C(=O)[C@@H](N)Cc1c[nH]cn1 ; *C(=O)[C@H](N)Cc1c[nH]cn1]

In some embodiments, at least 1% of R¹ substituents are selected from one of the following:

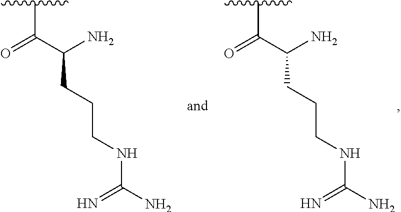 [SMILES: *C(=O)[C@@H](N)CCCNC(=N)N ; *C(=O)[C@H](N)CCCNC(=N)N]

AND at least 1% of R¹ substituents are selected from the following:

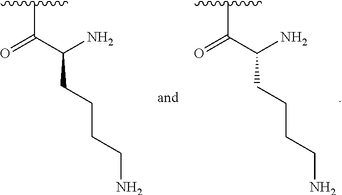 [SMILES: *C(=O)[C@@H](N)CCCCN ; *C(=O)[C@H](N)CCCCN]

In some embodiments, R² is amino and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

In some embodiments, R¹ is selected from one of the following:

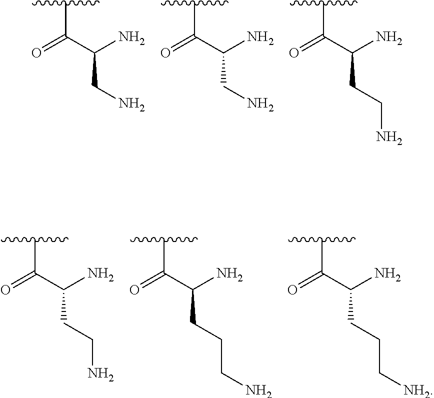

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

In some embodiments, R¹ is selected from one of the following:

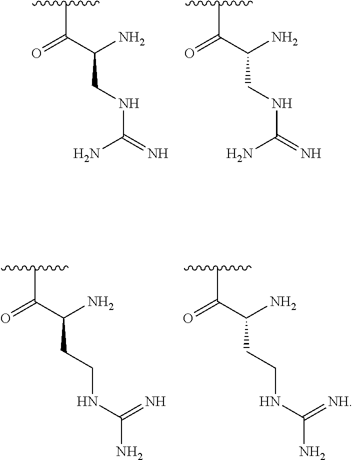 [SMILES: *C(=O)[C@@H](N)CNC(=N)N ; *C(=O)[C@H](N)CNC(=N)N ; *C(=O)[C@@H](N)CCNC(=N)N ; *C(=O)[C@H](N)CCNC(=N)N]

In some embodiments, R² is amino that is substituted with a nitrogen protecting group prior to substitution on chitosan and removed subsequent to substitution on chitosan.

In some embodiments, the nitrogen protecting group is tert-butyloxycarbonyl (Boc).

In some embodiments, in the synthetic process a nitrogen protecting group is used, which can provide an intermediate polymer having a nitrogen protecting group such as Boc.

In some embodiments, R² is amino.

In some embodiments, R² is hydrogen and R³ is amino.

In some embodiments, R² is hydrogen and R³ is guanidino.

In some embodiments, R² is hydrogen and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

In some embodiments, R¹ is selected from one of the following:

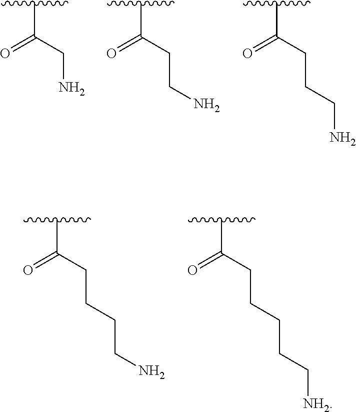 [SMILES: *C(=O)CN ; *C(=O)CCN ; *C(=O)CCCN ; *C(=O)CCCCN ; *C(=O)CCCCCN]

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

In some embodiments, R¹ is selected from one of the following:

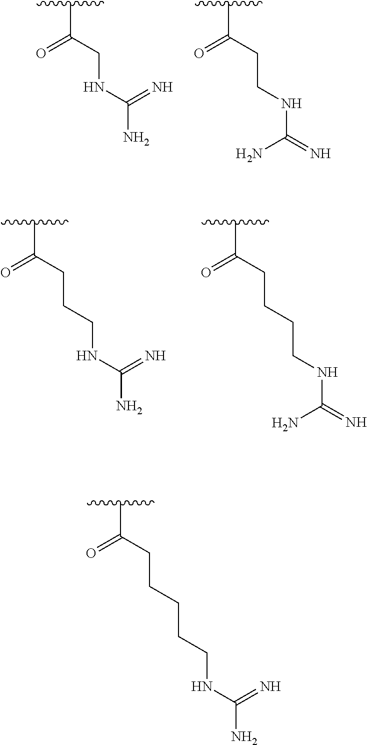 [SMILES: *C(=O)CNC(=N)N ; *C(=O)CCNC(=N)N ; *C(=O)CCCNC(=N)N ; *C(=O)CCCCNC(=N)N ; *C(=O)CCCCCNC(=N)N]

In some embodiments, at least 25% of R¹ substituents are H, at least 1% of R¹ substituents are acetyl, and at least 2% of R¹ substituents independently selected from any of the formulae specifically shown above.

In some embodiments, the functionalized chitosan of formula (I) may be further derivatized on the free hydroxyl moieties.

In some embodiments, the molecular weight of the functionalized chitosan is between 5,000 and 1,000,000 Da.

In some embodiments, the molecular weight of the functionalized chitosan is between 10,000 and 350,000 Da.

In some embodiments, the molecular weight of the functionalized chitosan is between 10,000 and 60,000 Da.

In some embodiments, the molecular weight of the functionalized chitosan is between 15,000 and 45,000 Da.

In some embodiments, the molecular weight of the functionalized chitosan is between 15,000 and 35,000 Da.

In some embodiments, the molecular weight of the functionalized chitosan is between 15,000 and 25,000 Da.

In some embodiments, the functionalized chitosan is soluble in aqueous solution between pH 6 and 8.

In some embodiments, the functionalized chitosan is soluble in aqueous solution between pH 6.8 and pH 7.4.

In some embodiments, the chitosan is functionalized at between 5% and 50%.

In a preferred embodiment, the chitosan is functionalized at between 20% and 30%.

In some embodiments, the degree of deacetylation (% DDA) of the derivatized chitosan is between 75% and 95%.

In some embodiments, the degree of deacetylation (% DDA) of the derivatized chitosan is between 80% and 90%.

In some embodiments, the polydispersity index (PDI) of the derivatized chitosan is between 1.0 and 2.5.

In some embodiments, the polydispersity index (PDI) of the derivatized chitosan is between 1.2 and 1.8.

In some embodiments, the functionalized chitosan is substantially free of other impurities, e.g., salt, e.g., NaCl.

In some embodiments, the composition has less than about 20%, 15%, 10%, 5%, 2%, or 1%, or is substantially free, of a chitosan polymer wherein one or more of the nitrogen-containing groups of the glucosamine monomer is substituted with a polymerized amino acid, e.g., polyarginine (e.g., diargine, triargine, etc).

In some embodiments, the composition has less than about 20%, 15%, 10%, 5%, 2%, or 1%, or is substantially free, of a chitosan polymer having a molecular weight of less than 15,000 Da, 10,000 Da, or 5,000 Da.

In yet another aspect, the invention features a non-pharmaceutical composition, e.g., a liquid composition, e.g., an aqueous solution, or a dried powder composition, comprising a soluble or derivatized chitosan described herein.

In some embodiments, the composition further comprises a cleansing agent, e.g., organic detergents (e.g., organic sulfonates).

In some embodiments, the composition further comprises a solvent, e.g, an alcohol-based solvent (e.g., methanol, ethanol, propanol and isopropanol).

In some embodiments, the composition further comprises a buffer, e.g., sodium borate decahydrate and trisodium phosphate.

In some embodiments, the composition further comprises a water softener or chelating agent, e.g., tetrasodium ethylenediamine tetraacetic acid (EDTA) and nitrilotriacetic acid (NTA)

In some embodiments, the composition further comprises an abrasive cleansing agent, e.g., sodium metasilicate, cesium oxide and alumina,

In some embodiments, the composition further comprises a fragrant or odorant.

In some embodiments, the soluble or derivatized chitosan is soluble in aqueous solution from about pH 6.8 to about pH 7.4.

In some embodiments, the soluble or derivatized chitosan is soluble in aqueous solution from about pH 3 to about pH 9.

In some embodiments the soluble chitosan is underivatized.

In some embodiments, the derivatized chitosan comprises a chitosan of the following formula (I):

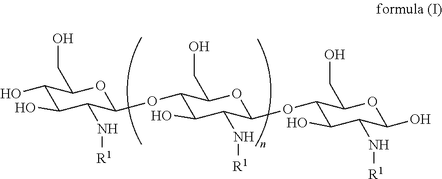

wherein:

n is an integer between 20 and 6000; and

each R¹ is independently selected for each occurrence from hydrogen, acetyl, and either:

a) a group of formula (II):

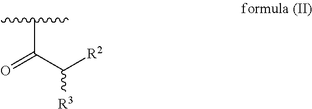

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, the derivatized chitosan comprises of the following formula (I) wherein at least 90% by number or weight of R¹ moieties are as defined in formula (I) (e.g., at least about 95%, at least about 96%, at least about 97%, at least about 98%, or at least about 99%):

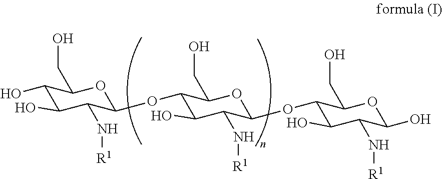

wherein:

n is an integer between 20 and 6000; and

each R¹ is independently selected for each occurrence from hydrogen, acetyl, and either:

a) a group of formula (II):

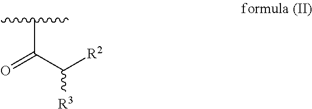

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, between 25-95% of R¹ substituents are hydrogen.

In some embodiments, between 55-90% of R¹ substituents are hydrogen.

In some embodiments, between 1-50% of R¹ substituents are acetyl.

In some embodiments, between 4-20% of R¹ substituents are acetyl.

In some embodiments, between 2-50% of R¹ substituents are a group of formula (II).

In some embodiments, between 4-30% of R¹ substituents are a group of formula (II).

In some embodiments, 55-90% of R¹ substituents are hydrogen, 4-20% of R¹ substituents are acetyl, 4-30% of R¹ substituents are a group of formula (II).

In some embodiments, R² is amino and R³ is an arginine side chain.

In some embodiments, R¹ is selected from one of the following:

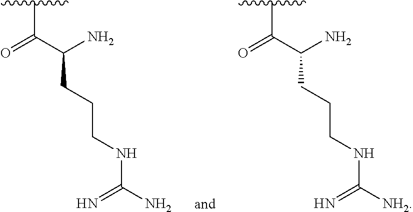 [SMILES: *C(=O)[C@@H](N)CCCNC(=N)N ; "and" ; *C(=O)[C@H](N)CCCNC(=N)N]

In some embodiments, R² is amino and R³ is a lysine side chain.

In some embodiments, R¹ is selected from one of the following:

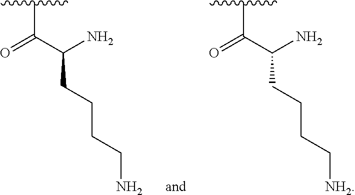 [SMILES: *C(=O)[C@@H](N)CCCCN ; "and" ; *C(=O)[C@H](N)CCCCN]

In some embodiments, R² is amino and R³ is a histidine side chain.

In some embodiments, R¹ is selected from one of the following:

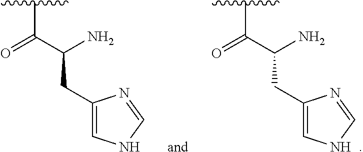 [SMILES: *C(=O)[C@@H](N)Cc1c[nH]cn1 ; "and" ; *C(=O)[C@H](N)Cc1c[nH]cn1 ; "."]

In some embodiments, at least 1% of R¹ substituents are selected from one of the following:

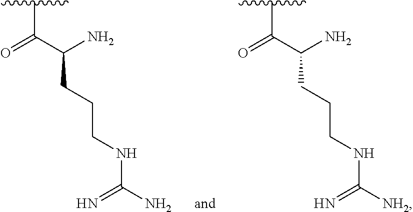 [SMILES: *C(=O)[C@@H](N)CCCNC(=N)N ; "and" ; *C(=O)[C@H](N)CCCNC(=N)N]

AND at least 1% of R¹ substituents are selected from the following:

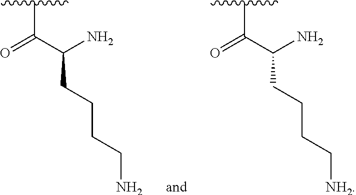 [SMILES: *C(=O)[C@@H](N)CCCCN ; "and" ; *C(=O)[C@H](N)CCCCN]

In some embodiments, R² is amino and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

In some embodiments, R¹ is selected from one of the following:

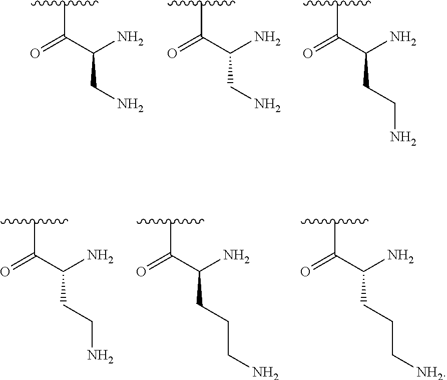 [SMILES: *C(=O)[C@@H](N)CN ; *C(=O)[C@H](N)CN ; *C(=O)[C@@H](N)CCN ; *C(=O)[C@H](N)CCN ; *C(=O)[C@@H](N)CCCN ; *C(=O)[C@H](N)CCCN]

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

In some embodiments, R¹ is selected from one of the following:

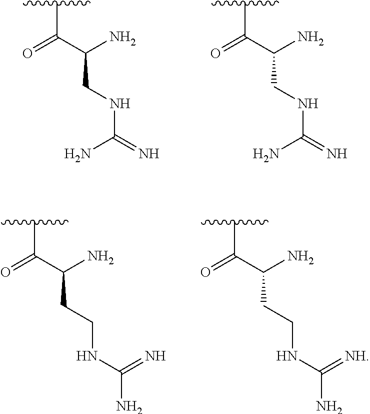 [SMILES: *C(=O)[C@@H](N)CNC(=N)N ; *C(=O)[C@H](N)CNC(=N)N ; *C(=O)[C@@H](N)CCNC(=N)N ; *C(=O)[C@H](N)CCNC(=N)N]

In some embodiments, R² is amino that is substituted with a nitrogen protecting group prior to substitution on chitosan and removed subsequent to substitution on chitosan.

In some embodiments, the nitrogen protecting group is tert-butyloxycarbonyl (Boc).

In some embodiments, in the synthetic process a nitrogen protecting group is used, which can provide an intermediate polymer having a nitrogen protecting group such as Boc.

In some embodiments, R² is amino.

In some embodiments, R² is hydrogen and R³ is amino.

In some embodiments, R² is hydrogen and R³ is guanidino.

In some embodiments, R² is hydrogen and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

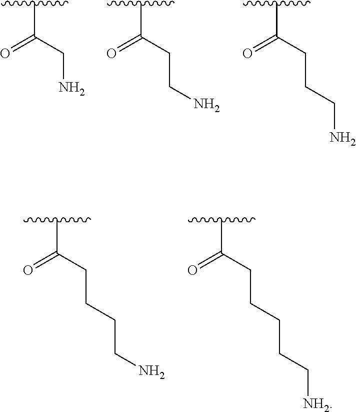 [SMILES: *C(=O)CN ; *C(=O)CCN ; *C(=O)CCCN ; *C(=O)CCCCN ; *C(=O)CCCCCN]

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

In some embodiments, R¹ is selected from one of the following:

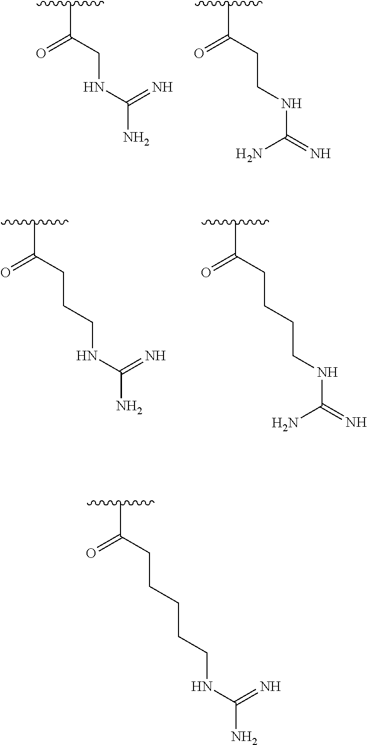 [SMILES: *C(=O)CNC(=N)N ; *C(=O)CCNC(=N)N ; *C(=O)CCCNC(=N)N ; *C(=O)CCCCNC(=N)N ; *C(=O)CCCCCNC(=N)N]

In some embodiments, at least 25% of R¹ substituents are H, at least 1% of R¹ substituents are acetyl, and at least 2% of R¹ substituents independently selected from any of the formulae specifically shown above.

In some embodiments, the functionalized chitosan of formula (I) may be further derivatized on the free hydroxyl moieties.

In some embodiments, the molecular weight of the functionalized chitosan is between 5,000 and 1,000,000 Da.

In some embodiments, the molecular weight of the functionalized chitosan is between 10,000 and 350,000 Da.

In some embodiments, the molecular weight of the functionalized chitosan is between 10,000 and 60,000 Da.

In some embodiments, the molecular weight of the functionalized chitosan is between 15,000 and 45,000 Da.

In some embodiments, the molecular weight of the functionalized chitosan is between 15,000 and 35,000 Da.

In some embodiments, the molecular weight of the functionalized chitosan is between 15,000 and 25,000 Da.

In some embodiments, the functionalized chitosan is soluble in aqueous solution between pH 6 and 8.

In some embodiments, the functionalized chitosan is soluble in aqueous solution between pH 6.8 and pH 7.4.

In some embodiments, the chitosan is functionalized at between 5% and 50%.

In a preferred embodiment, the chitosan is functionalized at between 20% and 30%.

In some embodiments, the degree of deacetylation (% DDA) of the derivatized chitosan is between 75% and 95%.

In some embodiments, the degree of deacetylation (% DDA) of the derivatized chitosan is between 80% and 90%.

In some embodiments, the polydispersity index (PDI) of the derivatized chitosan is between 1.0 and 2.5.

In some embodiments, the polydispersity index (PDI) of the derivatized chitosan is between 1.2 and 1.8.

In some embodiments, the functionalized chitosan is substantially free of other impurities, e.g., salt, e.g., NaCl.

In some embodiments, the composition has less than about 20%, 15%, 10%, 5%, 2%, or 1%, or is substantially free, of a chitosan polymer wherein one or more of the nitrogen-containing groups of the glucosamine monomer is substituted with a polymerized amino acid, e.g., polyarginine (e.g., diargine, triargine, etc).

In some embodiments, the composition has less than about 20%, 15%, 10%, 5%, 2%, or 1%, or is substantially free, of a chitosan polymer having a molecular weight of less than 15,000 Da, 10,000 Da, or 5,000 Da.

In one aspect, the invention features a kit comprising a soluble or derivatized chitosan described herein and instructions to treat an inert and/or non-animal surface, or a food or food product surface.

In some embodiments, the soluble or derivatized chitosan is soluble in aqueous solution from about pH 6.8 to about pH 7.4.

In some embodiments, the soluble or derivatized chitosan is soluble in aqueous solution from about pH 3 to about pH 9.

In some embodiments, the soluble chitosan is underivatized.

In some embodiments, the derivatized chitosan comprises a chitosan of the following formula (I):

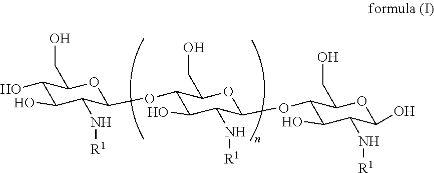

wherein:

n is an integer between 20 and 6000; and

each R¹ is independently selected for each occurrence from hydrogen, acetyl, and either:

a) a group of formula (II):

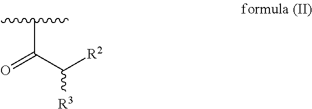

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, the derivatized chitosan comprises of the following formula (I) wherein at least 90% by number or weight of R¹ moieties are as defined in formula (I) (e.g., at least about 95%, at least about 96%, at least about 97%, at least about 98%, or at least about 99%):

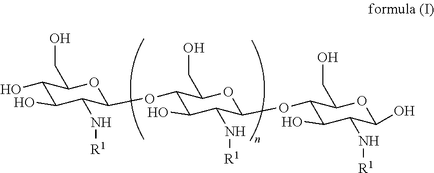

wherein:

n is an integer between 20 and 6000; and

each R¹ is independently selected for each occurrence from hydrogen, acetyl, and either:

a) a group of formula (II):

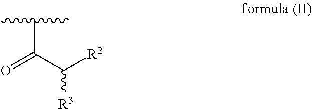

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, between 25-95% of R¹ substituents are hydrogen.

In some embodiments, between 55-90% of R¹ substituents are hydrogen.

In some embodiments, between 1-50% of R¹ substituents are acetyl.

In some embodiments, between 4-20% of R¹ substituents are acetyl.

In some embodiments, between 2-50% of R¹ substituents are a group of formula (II).

In some embodiments, between 4-30% of R¹ substituents are a group of formula (II).

In some embodiments, 55-90% of R¹ substituents are hydrogen, 4-20% of R¹ substituents are acetyl, 4-30% of R¹ substituents are a group of formula (II).

In some embodiments, R² is amino and R³ is an arginine side chain.

In some embodiments, R¹ is selected from one of the following:

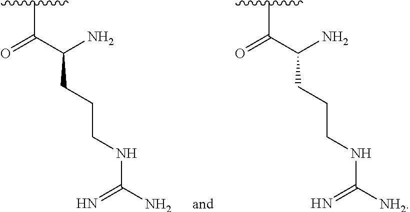 [SMILES: *C(=O)[C@@H](N)CCCNC(=N)N ; *C(=O)[C@H](N)CCCNC(=N)N]

In some embodiments, R² is amino and R³ is a lysine side chain.

In some embodiments, R¹ is selected from one of the following:

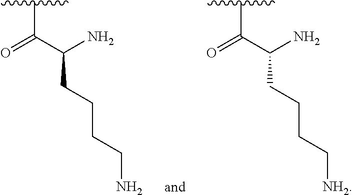 [SMILES: *C(=O)[C@@H](N)CCCCN ; *C(=O)[C@H](N)CCCCN]

In some embodiments, R² is amino and R³ is a histidine side chain.

In some embodiments, R¹ is selected from one of the following:

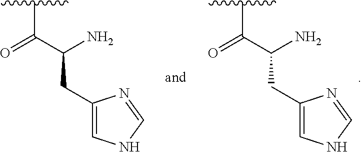 [SMILES: *C(=O)[C@@H](N)Cc1c[nH]cn1 ; *C(=O)[C@H](N)Cc1c[nH]cn1]

In some embodiments, at least 1% of R¹ substituents are selected from one of the following:

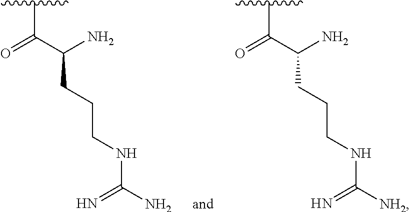 [SMILES: *C(=O)[C@@H](N)CCCNC(=N)N ; *C(=O)[C@H](N)CCCNC(=N)N]

AND at least 1% of R¹ substituents are selected from the following:

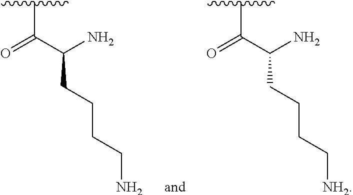 [SMILES: *C(=O)[C@@H](N)CCCCN ; *C(=O)[C@H](N)CCCCN]

In some embodiments, R² is amino and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

In some embodiments, R¹ is selected from one of the following:

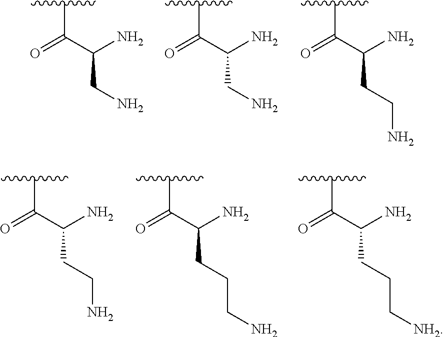 [SMILES: *C(=O)[C@@H](N)CN ; *C(=O)[C@H](N)CN ; *C(=O)[C@@H](N)CCN ; *C(=O)[C@H](N)CCN ; *C(=O)[C@@H](N)CCCN ; *C(=O)[C@H](N)CCCN]

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

In some embodiments, R¹ is selected from one of the following:

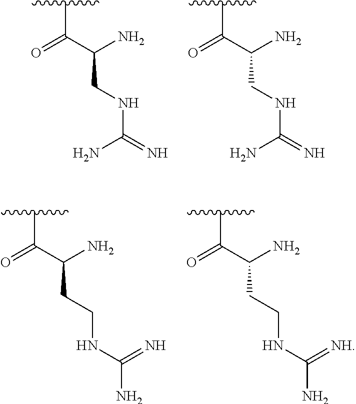 [SMILES: *C(=O)[C@@H](N)CNC(=N)N ; *C(=O)[C@H](N)CNC(=N)N ; *C(=O)[C@@H](N)CCNC(=N)N ; *C(=O)[C@H](N)CCNC(=N)N]

In some embodiments, R² is amino that is substituted with a nitrogen protecting group prior to substitution on chitosan and removed subsequent to substitution on chitosan.

In some embodiments, the nitrogen protecting group is tert-butyloxycarbonyl (Boc).

In some embodiments, in the synthetic process a nitrogen protecting group is used, which can provide an intermediate polymer having a nitrogen protecting group such as Boc.

In some embodiments, R² is amino.

In some embodiments, R² is hydrogen and R³ is amino.

In some embodiments, R² is hydrogen and R³ is guanidino.

In some embodiments, R² is hydrogen and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

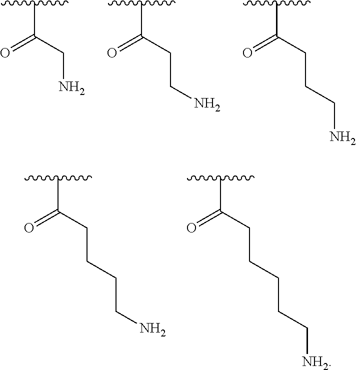 [SMILES: *C(=O)CN ; *C(=O)CCN ; *C(=O)CCCN ; *C(=O)CCCCN ; *C(=O)CCCCCN]

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

In some embodiments, R¹ is selected from one of the following:

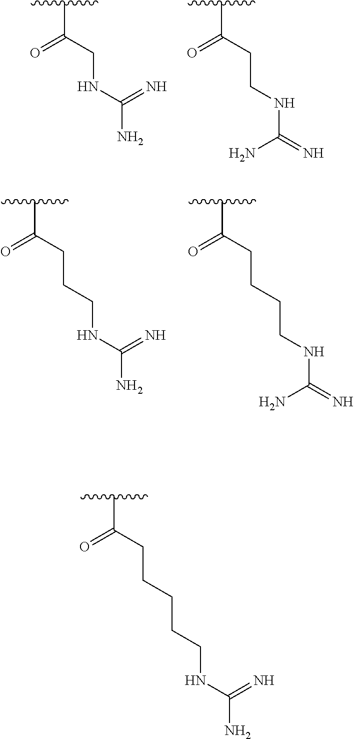 [SMILES: *C(=O)CNC(=N)N ; *C(=O)CCNC(=N)N ; *C(=O)CCCNC(=N)N ; *C(=O)CCCCNC(=N)N ; *C(=O)CCCCCNC(=N)N]

In some embodiments, at least 25% of R¹ substituents are H, at least 1% of R¹ substituents are acetyl, and at least 2% of R¹ substituents independently selected from any of the formulae specifically shown above.

In some embodiments, the functionalized chitosan of formula (I) may be further derivatized on the free hydroxyl moieties.

In some embodiments, the molecular weight of the functionalized chitosan is between 5,000 and 1,000,000 Da.

In some embodiments, the molecular weight of the functionalized chitosan is between 10,000 and 350,000 Da.

In some embodiments, the molecular weight of the functionalized chitosan is between 10,000 and 60,000 Da.

In some embodiments, the molecular weight of the functionalized chitosan is between 15,000 and 45,000 Da.

In some embodiments, the molecular weight of the functionalized chitosan is between 15,000 and 35,000 Da.

In some embodiments, the molecular weight of the functionalized chitosan is between 15,000 and 25,000 Da.

In some embodiments, the functionalized chitosan is soluble in aqueous solution between pH 6 and 8.

In some embodiments, the functionalized chitosan is soluble in aqueous solution between pH 6.8 and pH 7.4.

In some embodiments, the chitosan is functionalized at between 5% and 50%.

In a preferred embodiment, the chitosan is functionalized at between 20% and 30%.

In some embodiments, the degree of deacetylation (% DDA) of the derivatized chitosan is between 75% and 95%.

In some embodiments, the degree of deacetylation (% DDA) of the derivatized chitosan is between 80% and 90%.

In some embodiments, the polydispersity index (PDI) of the derivatized chitosan is between 1.0 and 2.5.

In some embodiments, the polydispersity index (PDI) of the derivatized chitosan is between 1.2 and 1.8.

In some embodiments, the functionalized chitosan is substantially free of other impurities, e.g., salt, e.g., NaCl.

In some embodiments, the soluble or derivatized chitosan has less than about 20%, 15%, 10%, 5%, 2%, or 1%, or is substantially free, of a chitosan polymer wherein one or more of the nitrogen-containing groups of the glucosamine monomer is substituted with a polymerized amino acid, e.g., polyarginine (e.g., diargine, triargine, etc).

In some embodiments, the soluble or derivatized chitosan has less than about 20%, 15%, 10%, 5%, 2%, or 1%, or is substantially free, of a chitosan polymer having a molecular weight of less than 15,000 Da, 10,000 Da, or 5,000 Da.

In another aspect, the invention features a device constructed to treat an inert and/or non-animal surface, or a food or food product surface, the device comprising a soluble or derivatized chitosan described herein.

In some embodiments, the device comprises a container, e.g., a liquid holding container, e.g., being closed by a liquid or foam dispensing valve or cap.

In some embodiments, the device further comprises a positive displacement pump, e.g., that acts directly on the fluid.

In some embodiments, the container comprises a spray bottle or can.

In some embodiments, the device comprises a prefilled mop or a soaked wipe.

In some embodiments, the soluble or derivatized chitosan is soluble in aqueous solution from about pH 6.8 to about pH 7.4.

In some embodiments, the soluble or derivatized chitosan is soluble in aqueous solution from about pH 3 to about pH 9.

In some embodiments, the soluble chitosan is underivatized.

In some embodiments, the derivatized chitosan comprises a chitosan of the following formula (I):

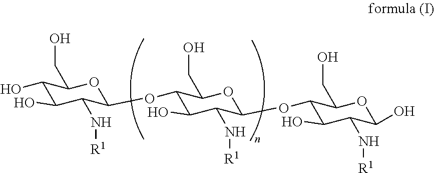

wherein:

n is an integer between 20 and 6000; and

each R¹ is independently selected for each occurrence from hydrogen, acetyl, and either:

a) a group of formula (II):

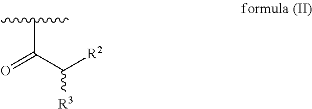

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, the derivatized chitosan comprises of the following formula (I) wherein at least 90% by number or weight of R¹ moieties are as defined in formula (I) (e.g., at least about 95%, at least about 96%, at least about 97%, at least about 98%, or at least about 99%):

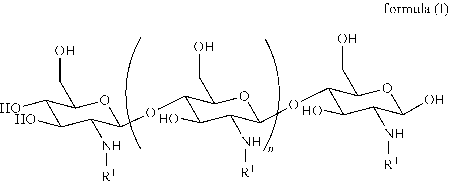

wherein:

n is an integer between 20 and 6000; and

each R¹ is independently selected for each occurrence from hydrogen, acetyl, and either:

a) a group of formula (II):

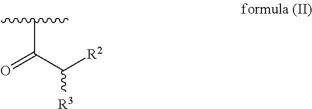

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, between 25-95% of R¹ substituents are hydrogen.

In some embodiments, between 55-90% of R¹ substituents are hydrogen.

In some embodiments, between 1-50% of R¹ substituents are acetyl.

In some embodiments, between 4-20% of R¹ substituents are acetyl.

In some embodiments, between 2-50% of R¹ substituents are a group of formula (II).

In some embodiments, between 4-30% of R¹ substituents are a group of formula (II).

In some embodiments, 55-90% of R¹ substituents are hydrogen, 4-20% of R¹ substituents are acetyl, 4-30% of R¹ substituents are a group of formula (II).

In some embodiments, R² is amino and R³ is an arginine side chain.

In some embodiments, R¹ is selected from one of the following:

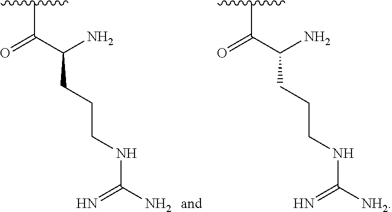 [SMILES: *C(=O)[C@@H](N)CCCNC(=N)N ; *C(=O)[C@H](N)CCCNC(=N)N]

In some embodiments, R² is amino and R³ is a lysine side chain.

In some embodiments, R¹ is selected from one of the following:

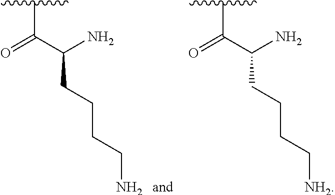 [SMILES: *C(=O)[C@@H](N)CCCCN ; *C(=O)[C@H](N)CCCCN]

In some embodiments, R² is amino and R³ is a histidine side chain.

In some embodiments, R¹ is selected from one of the following:

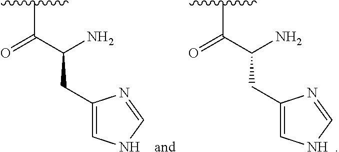 [SMILES: *C(=O)[C@@H](N)Cc1c[nH]cn1 ; *C(=O)[C@H](N)Cc1c[nH]cn1]

In some embodiments, at least 1% of R¹ substituents are selected from one of the following:

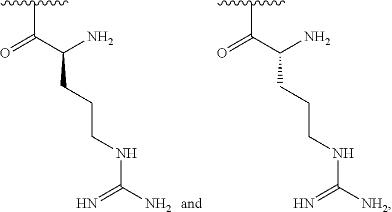 [SMILES: *C(=O)[C@@H](N)CCCNC(=N)N ; *C(=O)[C@H](N)CCCNC(=N)N]

AND at least 1% of R¹ substituents are selected from the following:

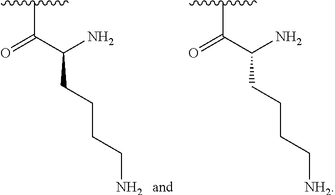 [SMILES: *C(=O)[C@@H](N)CCCCN ; *C(=O)[C@H](N)CCCCN]

In some embodiments, R² is amino and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

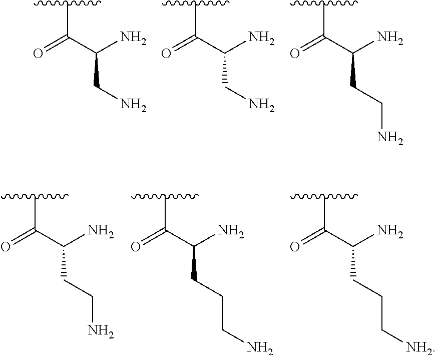

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

In some embodiments, R¹ is selected from one of the following:

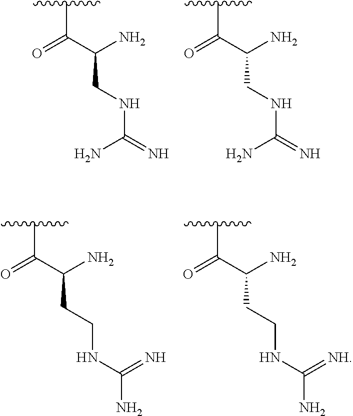 [SMILES: *C(=O)[C@@H](N)CNC(=N)N ; *C(=O)[C@H](N)CNC(=N)N ; *C(=O)[C@@H](N)CCNC(=N)N ; *C(=O)[C@H](N)CCNC(=N)N]

In some embodiments, R² is amino that is substituted with a nitrogen protecting group prior to substitution on chitosan and removed subsequent to substitution on chitosan.

In some embodiments, the nitrogen protecting group is tert-butyloxycarbonyl (Boc).

In some embodiments, in the synthetic process a nitrogen protecting group is used, which can provide an intermediate polymer having a nitrogen protecting group such as Boc.

In some embodiments, R² is amino.

In some embodiments, R² is hydrogen and R³ is amino.

In some embodiments, R² is hydrogen and R³ is guanidino.

In some embodiments, R² is hydrogen and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

In some embodiments, R¹ is selected from one of the following:

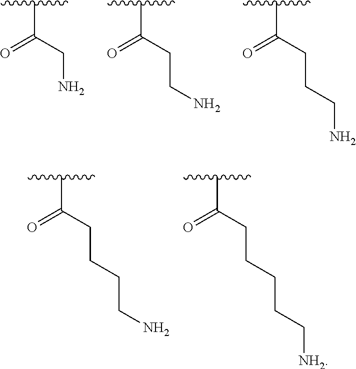 [SMILES: *C(=O)CN ; *C(=O)CCN ; *C(=O)CCCN ; *C(=O)CCCCN ; *C(=O)CCCCCN]

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

In some embodiments, R¹ is selected from one of the following:

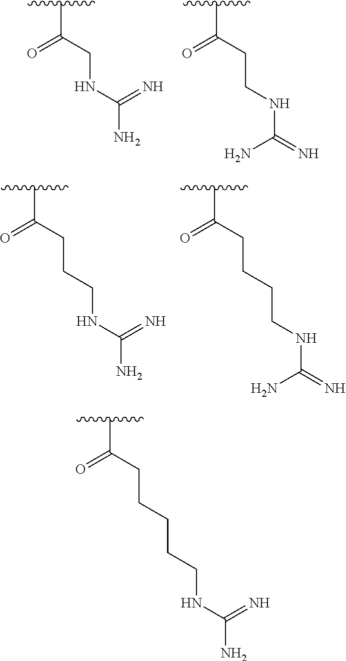

In some embodiments, at least 25% of R′ substituents are H, at least 1% of R′ substituents are acetyl, and at least 2% of R¹ substituents independently selected from any of the formulae specifically shown above.

In some embodiments, the functionalized chitosan of formula (I) may be further derivatized on the free hydroxyl moieties.

In some embodiments, the molecular weight of the functionalized chitosan is between 5,000 and 1,000,000 Da.

In some embodiments, the molecular weight of the functionalized chitosan is between 10,000 and 350,000 Da.

In some embodiments, the molecular weight of the functionalized chitosan is between 10,000 and 60,000 Da.

In some embodiments, the molecular weight of the functionalized chitosan is between 15,000 and 45,000 Da.

In some embodiments, the molecular weight of the functionalized chitosan is between 15,000 and 35,000 Da.

In some embodiments, the molecular weight of the functionalized chitosan is between 15,000 and 25,000 Da.

In some embodiments, the functionalized chitosan is soluble in aqueous solution between pH 6 and 8.

In some embodiments, the functionalized chitosan is soluble in aqueous solution between pH 6.8 and pH 7.4.

In some embodiments, the chitosan is functionalized at between 5% and 50%.

In a preferred embodiment, the chitosan is functionalized at between 20% and 30%.

In some embodiments, the degree of deacetylation (% DDA) of the derivatized chitosan is between 75% and 95%.

In some embodiments, the degree of deacetylation (% DDA) of the derivatized chitosan is between 80% and 90%.

In some embodiments, the polydispersity index (PDI) of the derivatized chitosan is between 1.0 and 2.5.

In some embodiments, the polydispersity index (PDI) of the derivatized chitosan is between 1.2 and 1.8.

In some embodiments, the functionalized chitosan is substantially free of other impurities, e.g., salt, e.g., NaCl.

In some embodiments, the soluble or derivatized chitosan has less than about 20%, 15%, 10%, 5%, 2%, or 1%, or is substantially free, of a chitosan polymer wherein one or more of the nitrogen-containing groups of the glucosamine monomer is substituted with a polymerized amino acid, e.g., polyarginine (e.g., diargine, triargine, etc).

In some embodiments, the soluble or derivatized chitosan has less than about 20%, 15%, 10%, 5%, 2%, or 1%, or is substantially free, of a chitosan polymer having a molecular weight of less than 15,000 Da, 10,000 Da, or 5,000 Da.

In yet another aspect, the invention features a device (e.g., a medical device) comprising a soluble or derivatized chitosan described herein on the surface, e.g., a ventilation tube coated with a soluble or derivatized chitosan on its surface.

In some embodiments, the device is selected from the group consisting of a ventilator, aspirator, transfusion unit, electrosurgical unit, fetal monitor, heart-lung machine, incubator, infusion pump, invasive blood pressure unit, pulse oximeter, radiation-therapy machine, stent, ultrasound sensor, endoscope, implantable RFID chip, surgical drill and saw, laparoscopic insufflator, electronic thermometer, breast pump, surgical microscope, ultrasonic nebulizer, sphygmomanometer, surgical table, mouth mirror, dental probe, dental retractor, dental drill, dental excavator, and dental scaler.

In some embodiments, the device is attached to a subject, e.g., a patient.

In some embodiments, the soluble or derivatized chitosan is soluble in aqueous solution from about pH 6.8 to about pH 7.4.

In some embodiments, the soluble or derivatized chitosan is soluble in aqueous solution from about pH 3 to about pH 9.

In some embodiments, the soluble chitosan is underivatized.

In some embodiments, the derivatized chitosan comprises a chitosan of the following formula (I):

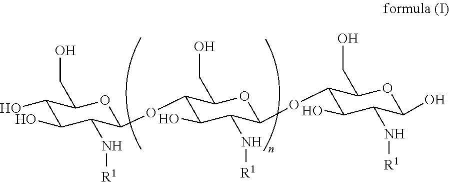

wherein:

n is an integer between 20 and 6000; and

each R¹ is independently selected for each occurrence from hydrogen, acetyl, and either:

a) a group of formula (II):

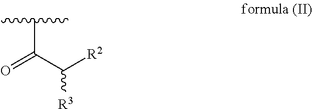

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, the derivatized chitosan comprises of the following formula (I) wherein at least 90% by number or weight of R¹ moieties are as defined in formula (I) (e.g., at least about 95%, at least about 96%, at least about 97%, at least about 98%, or at least about 99%):

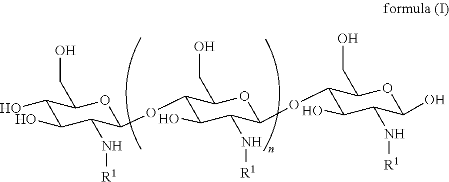

wherein:

n is an integer between 20 and 6000; and

each R¹ is independently selected for each occurrence from hydrogen, acetyl, and either:

a) a group of formula (II):

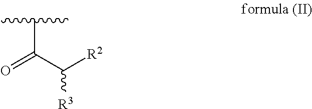

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, between 25-95% of R¹ substituents are hydrogen.

In some embodiments, between 55-90% of R¹ substituents are hydrogen.

In some embodiments, between 1-50% of R¹ substituents are acetyl.

In some embodiments, between 4-20% of R¹ substituents are acetyl.

In some embodiments, between 2-50% of R¹ substituents are a group of formula (II).

In some embodiments, between 4-30% of R¹ substituents are a group of formula (II).

In some embodiments, 55-90% of R¹ substituents are hydrogen, 4-20% of R¹ substituents are acetyl, 4-30% of R¹ substituents are a group of formula (II).

In some embodiments, R² is amino and R³ is an arginine side chain.

In some embodiments, R¹ is selected from one of the following:

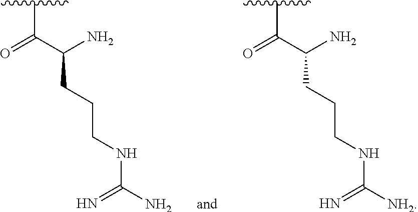 [SMILES: *C(=O)[C@@H](N)CCCNC(=N)N ; "and" ; *C(=O)[C@H](N)CCCNC(=N)N]

In some embodiments, R² is amino and R³ is a lysine side chain.

In some embodiments, R¹ is selected from one of the following:

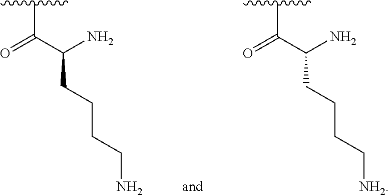 [SMILES: *C(=O)[C@@H](N)CCCCN ; "and" ; *C(=O)[C@H](N)CCCCN]

In some embodiments, R² is amino and R³ is a histidine side chain.

In some embodiments, R¹ is selected from one of the following:

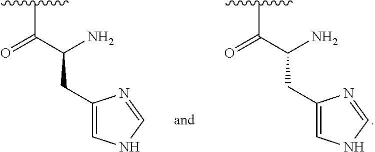 [SMILES: *C(=O)[C@@H](N)Cc1c[nH]cn1 ; *C(=O)[C@H](N)Cc1c[nH]cn1]

In some embodiments, at least 1% of R¹ substituents are selected from one of the following:

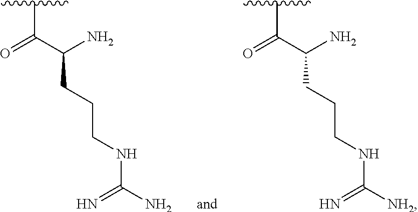 [SMILES: *C(=O)[C@@H](N)CCCNC(=N)N ; "and" ; *C(=O)[C@H](N)CCCNC(=N)N]

AND at least 1% of R¹ substituents are selected from the following:

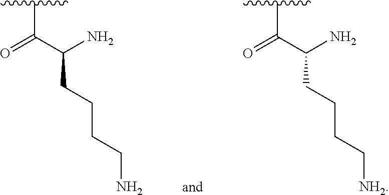 [SMILES: *C(=O)[C@@H](N)CCCCN ; "and" ; *C(=O)[C@H](N)CCCCN]

In some embodiments, R² is amino and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

In some embodiments, R¹ is selected from one of the following:

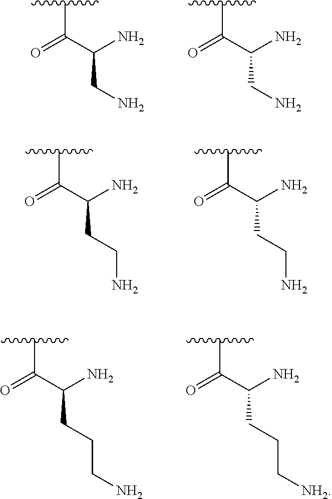 [SMILES: *C(=O)[C@@H](N)CN ; *C(=O)[C@H](N)CN ; *C(=O)[C@@H](N)CCN ; *C(=O)[C@H](N)CCN ; *C(=O)[C@@H](N)CCCN ; *C(=O)[C@H](N)CCCN]

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

In some embodiments, R¹ is selected from one of the following:

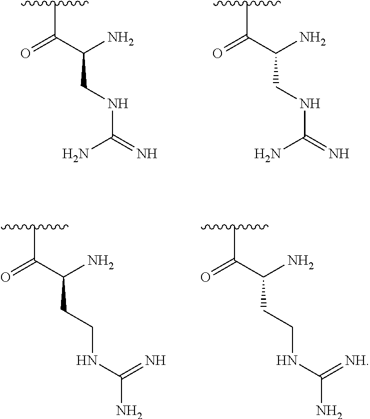 [SMILES: *C(=O)[C@@H](N)CNC(=N)N ; *C(=O)[C@H](N)CNC(=N)N ; *C(=O)[C@@H](N)CCNC(=N)N ; *C(=O)[C@H](N)CCNC(=N)N]

In some embodiments, R² is amino that is substituted with a nitrogen protecting group prior to substitution on chitosan and removed subsequent to substitution on chitosan.

In some embodiments, the nitrogen protecting group is tert-butyloxycarbonyl (Boc).

In some embodiments, in the synthetic process a nitrogen protecting group is used, which can provide an intermediate polymer having a nitrogen protecting group such as Boc.

In some embodiments, R² is amino.

In some embodiments, R² is hydrogen and R³ is amino.

In some embodiments, R² is hydrogen and R³ is guanidino.

In some embodiments, R² is hydrogen and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

In some embodiments, R¹ is selected from one of the following:

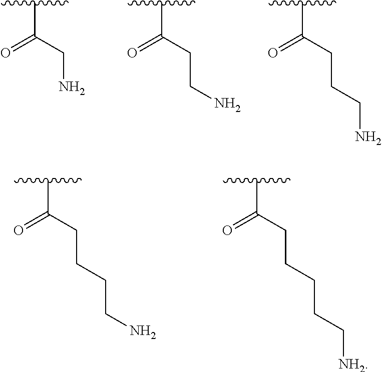 [SMILES: *C(=O)CN ; *C(=O)CCN ; *C(=O)CCCN ; *C(=O)CCCCN ; *C(=O)CCCCCN]

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

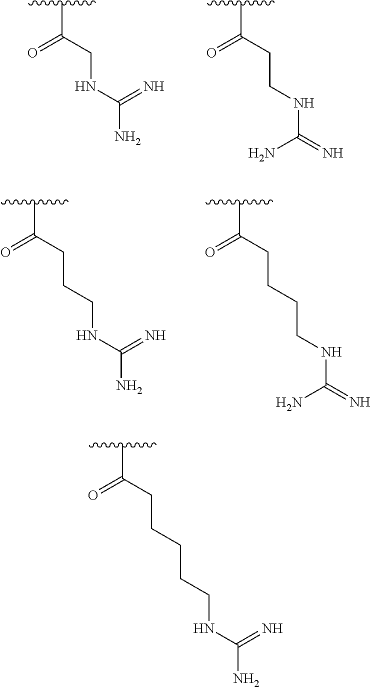 [SMILES: *C(=O)CNC(=N)N ; *C(=O)CCNC(=N)N ; *C(=O)CCCNC(=N)N ; *C(=O)CCCCNC(=N)N ; *C(=O)CCCCCNC(=N)N]

In some embodiments, at least 25% of R¹ substituents are H, at least 1% of R¹ substituents are acetyl, and at least 2% of R¹ substituents independently selected from any of the formulae specifically shown above.

In some embodiments, the functionalized chitosan of formula (I) may be further derivatized on the free hydroxyl moieties.

In some embodiments, the molecular weight of the functionalized chitosan is between 5,000 and 1,000,000 Da.

In some embodiments, the molecular weight of the functionalized chitosan is between 10,000 and 350,000 Da.

In some embodiments, the molecular weight of the functionalized chitosan is between 10,000 and 60,000 Da.

In some embodiments, the molecular weight of the functionalized chitosan is between 15,000 and 45,000 Da.

In some embodiments, the molecular weight of the functionalized chitosan is between 15,000 and 35,000 Da.

In some embodiments, the molecular weight of the functionalized chitosan is between 15,000 and 25,000 Da.

In some embodiments, the functionalized chitosan is soluble in aqueous solution between pH 6 and 8.

In some embodiments, the functionalized chitosan is soluble in aqueous solution between pH 6.8 and pH 7.4.

In some embodiments, the chitosan is functionalized at between 5% and 50%.

In a preferred embodiment, the chitosan is functionalized at between 20% and 30%.

In some embodiments, the degree of deacetylation (% DDA) of the derivatized chitosan is between 75% and 95%.

In some embodiments, the degree of deacetylation (% DDA) of the derivatized chitosan is between 80% and 90%.

In some embodiments, the polydispersity index (PDI) of the derivatized chitosan is between 1.0 and 2.5.

In some embodiments, the polydispersity index (PDI) of the derivatized chitosan is between 1.2 and 1.8.

In some embodiments, the functionalized chitosan is substantially free of other impurities, e.g., salt, e.g., NaCl.

In some embodiments, the soluble or derivatized chitosan has less than about 20%, 15%, 10%, 5%, 2%, or 1%, or is substantially free, of a chitosan polymer wherein one or more of the nitrogen-containing groups of the glucosamine monomer is substituted with a polymerized amino acid, e.g., polyarginine (e.g., diargine, triargine, etc).

In some embodiments, the soluble or derivatized chitosan has less than about 20%, 15%, 10%, 5%, 2%, or 1%, or is substantially free, of a chitosan polymer having a molecular weight of less than 15,000 Da, 10,000 Da, or 5,000 Da.

In one aspect, the invention features a method of processing food (e.g., transforming raw materials into a food product, or transform food from one form to another form, for consumption by humans or animals), or preserving (e.g., treating, handling) a food product (e.g., to increase shelf life or safety of a food product, to slow down spoilage (e.g., loss of quality, edibility, or nutritional value), or to control bacterial contamination), the method comprising: contacting an effective amount of a composition comprising a soluble or derivatized chitosan with the food or food product (e.g., at the surface of the food or food product).

In some embodiments, the method further comprises one or more standard food processing and/or preservation methods.

In some embodiments, the standard food processing and/or preservation method is selected from the group consisting of heating to kill or denature micro-organisms (e.g., boiling), oxidation (e.g., use of sulfur dioxide), ozonation (e.g., use of ozone or ozonated water to kill undesired microbes), toxic inhibition (e.g., smoking, use of carbon dioxide, vinegar, alcohol etc.), dehydration (drying), osmotic inhibition (e.g., use of syrups), low temperature inactivation (e.g., refrigeration, freezing), ultra high pressure (e.g., Fresherized®, a type of “cold” pasteurization; intense water pressure kills microbes which cause food deterioration and affect food safety), vacuum packing, salting or curing, sugaring, artificial food additives (e.g., antimicrobial (calcium propionate, sodium nitrate, sodium nitrite, sulfites (sulfur dioxide, sodium bisulfite, potassium hydrogen sulfite, etc.) and disodium EDTA), antioxidant (e.g., BHA, BHT)), irradiation, pickling, lye, canning, bottling, jellying, potting, jugging, pulsed electric field processing, and modifying atmosphere.

In some embodiments, the food or food product comprises meat, e.g., beef, pork, fish, poultry.

In some embodiments, the food or food product comprises a vegetable or a fruit.

In some embodiments, the chitosan derivative is added into the water to wash the food or food product.

In some embodiments, the soluble or derivatized chitosan is soluble in aqueous solution from about pH 6.8 to about pH 7.4.

In some embodiments, the soluble or derivatized chitosan is soluble in aqueous solution from about pH 3 to about pH 9.

In some embodiments, the soluble chitosan is underivatized.

In some embodiments, the derivatized chitosan comprises a chitosan of the following formula (I):

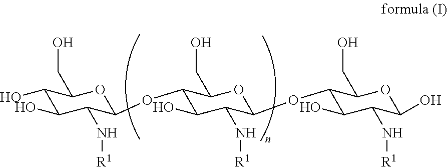

wherein:

n is an integer between 20 and 6000; and

each R¹ is independently selected for each occurrence from hydrogen, acetyl, and either:

a) a group of formula (II):

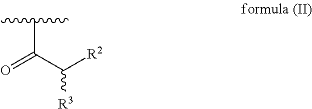

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, the derivatized chitosan comprises of the following formula (I) wherein at least 90% by number or weight of R¹ moieties are as defined in formula (I) (e.g., at least about 95%, at least about 96%, at least about 97%, at least about 98%, or at least about 99%):

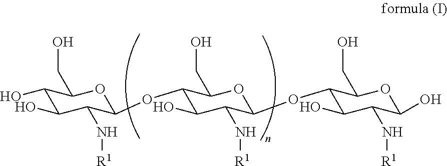

wherein:

n is an integer between 20 and 6000; and

each R¹ is independently selected for each occurrence from hydrogen, acetyl, and either:

a) a group of formula (II):

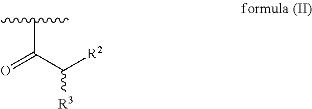

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, between 25-95% of R¹ substituents are hydrogen.

In some embodiments, between 55-90% of R¹ substituents are hydrogen.

In some embodiments, between 1-50% of R¹ substituents are acetyl.

In some embodiments, between 4-20% of R¹ substituents are acetyl.

In some embodiments, between 2-50% of R¹ substituents are a group of formula (II).

In some embodiments, between 4-30% of R¹ substituents are a group of formula (II).

In some embodiments, 55-90% of R¹ substituents are hydrogen, 4-20% of R¹ substituents are acetyl, 4-30% of R¹ substituents are a group of formula (II).

In some embodiments, R² is amino and R³ is an arginine side chain.

In some embodiments, R¹ is selected from one of the following:

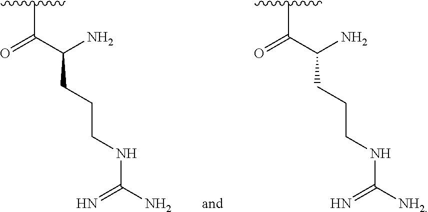 [SMILES: *C(=O)[C@@H](N)CCCNC(=N)N ; "and" ; *C(=O)[C@H](N)CCCNC(=N)N]

In some embodiments, R² is amino and R³ is a lysine side chain.

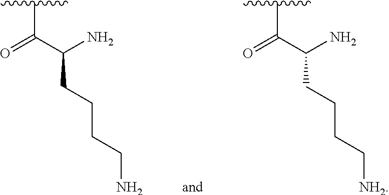 [SMILES: *C(=O)[C@@H](N)CCCCN ; "and" ; *C(=O)[C@H](N)CCCCN]

In some embodiments, R² is amino and R³ is a histidine side chain.

In some embodiments, R¹ is selected from one of the following:

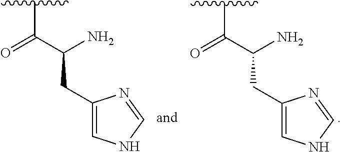 [SMILES: *C(=O)[C@@H](N)Cc1c[nH]cn1 ; *C(=O)[C@H](N)Cc1c[nH]cn1]

In some embodiments, at least 1% of R¹ substituents are selected from one of the following:

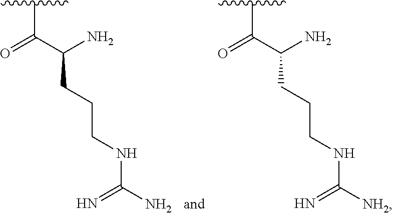 [SMILES: *C(=O)[C@@H](N)CCCNC(=N)N ; *C(=O)[C@H](N)CCCNC(=N)N]

AND at least 1% of R¹ substituents are selected from the following:

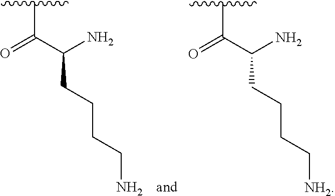 [SMILES: *C(=O)[C@@H](N)CCCCN ; *C(=O)[C@H](N)CCCCN]

In some embodiments, R² is amino and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

In some embodiments, R¹ is selected from one of the following:

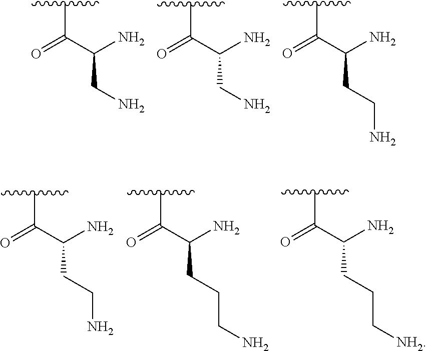

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

In some embodiments, R¹ is selected from one of the following:

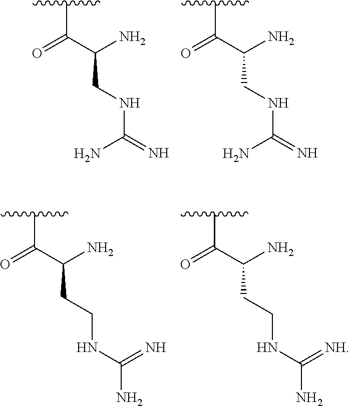 [SMILES: *C(=O)[C@@H](N)CNC(=N)N ; *C(=O)[C@H](N)CNC(=N)N ; *C(=O)[C@@H](N)CCNC(=N)N ; *C(=O)[C@H](N)CCNC(=N)N]

In some embodiments, R² is amino that is substituted with a nitrogen protecting group prior to substitution on chitosan and removed subsequent to substitution on chitosan.

In some embodiments, the nitrogen protecting group is tert-butyloxycarbonyl (Boc).

In some embodiments, in the synthetic process a nitrogen protecting group is used, which can provide an intermediate polymer having a nitrogen protecting group such as Boc.

In some embodiments, R² is amino.

In some embodiments, R² is hydrogen and R³ is amino.

In some embodiments, R² is hydrogen and R³ is guanidino.

In some embodiments, R² is hydrogen and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

In some embodiments, R¹ is selected from one of the following:

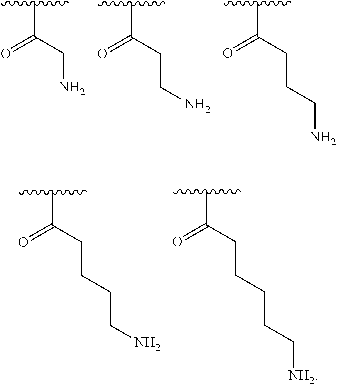

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

In some embodiments, R¹ is selected from one of the following:

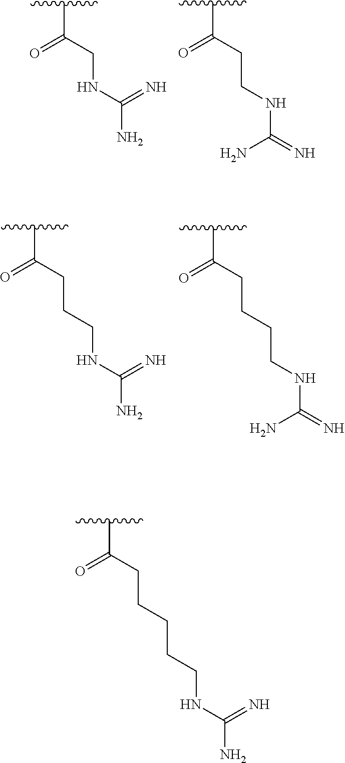 [SMILES: *C(=O)CNC(=N)N ; *C(=O)CCNC(=N)N ; *C(=O)CCCNC(=N)N ; *C(=O)CCCCNC(=N)N ; *C(=O)CCCCCNC(=N)N]

In some embodiments, at least 25% of R¹ substituents are H, at least 1% of R¹ substituents are acetyl, and at least 2% of R¹ substituents independently selected from any of the formulae specifically shown above.

In some embodiments, the functionalized chitosan of formula (I) may be further derivatized on the free hydroxyl moieties.

In some embodiments, the molecular weight of the functionalized chitosan is between 5,000 and 1,000,000 Da.

In some embodiments, the molecular weight of the functionalized chitosan is between 10,000 and 350,000 Da.

In some embodiments, the molecular weight of the functionalized chitosan is between 10,000 and 60,000 Da.

In some embodiments, the molecular weight of the functionalized chitosan is between 15,000 and 45,000 Da.

In some embodiments, the molecular weight of the functionalized chitosan is between 15,000 and 35,000 Da.

In some embodiments, the molecular weight of the functionalized chitosan is between 15,000 and 25,000 Da.

In some embodiments, the functionalized chitosan is soluble in aqueous solution between pH 6 and 8.

In some embodiments, the functionalized chitosan is soluble in aqueous solution between pH 6.8 and pH 7.4.

In some embodiments, the chitosan is functionalized at between 5% and 50%.

In a preferred embodiment, the chitosan is functionalized at between 20% and 30%.

In some embodiments, the degree of deacetylation (% DDA) of the derivatized chitosan is between 75% and 95%.

In some embodiments, the degree of deacetylation (% DDA) of the derivatized chitosan is between 80% and 90%.

In some embodiments, the polydispersity index (PDI) of the derivatized chitosan is between 1.0 and 2.5.

In some embodiments, the polydispersity index (PDI) of the derivatized chitosan is between 1.2 and 1.8.

In some embodiments, the functionalized chitosan is substantially free of other impurities, e.g., salt, e.g., NaCl.

In some embodiments, the composition has less than about 20%, 15%, 10%, 5%, 2%, or 1%, or is substantially free, of a chitosan polymer wherein one or more of the nitrogen-containing groups of the glucosamine monomer is substituted with a polymerized amino acid, e.g., polyarginine (e.g., diargine, triargine, etc).

In some embodiments, the composition has less than about 20%, 15%, 10%, 5%, 2%, or 1%, or is substantially free, of a chitosan polymer having a molecular weight of less than 15,000 Da, 10,000 Da, or 5,000 Da.

In another aspect, the invention features a method for treating a surface for food processing (e.g., a surface in a food processing facility, a surface on a food processing or packaging machine), the method comprising: contacting an effective amount of a composition comprising a soluble or derivatized chitosan with the surface.

In some embodiments, the soluble or derivatized chitosan is soluble in aqueous solution from about pH 6.8 to about pH 7.4.

In some embodiments, the soluble or derivatized chitosan is soluble in aqueous solution from about pH 3 to about pH 9.

In some embodiments, the soluble chitosan is underivatized.

In some embodiments, the derivatized chitosan comprises a chitosan of the following formula (I):

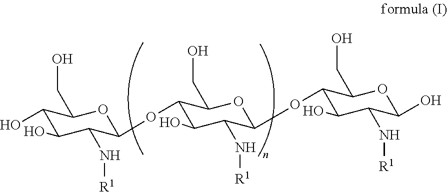

wherein:

n is an integer between 20 and 6000; and

each R¹ is independently selected for each occurrence from hydrogen, acetyl, and either:

a) a group of formula (II):

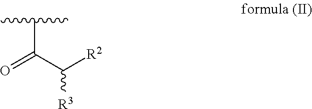

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, the derivatized chitosan comprises of the following formula (I) wherein at least 90% by number or weight of R¹ moieties are as defined in formula (I) (e.g., at least about 95%, at least about 96%, at least about 97%, at least about 98%, or at least about 99%):

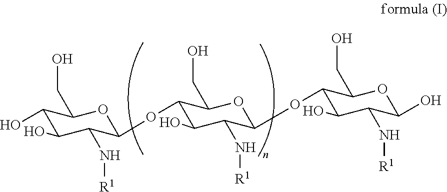

wherein:

n is an integer between 20 and 6000; and

each R¹ is independently selected for each occurrence from hydrogen, acetyl, and either:

a) a group of formula (II):

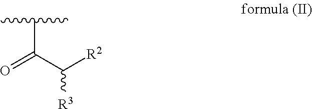

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, between 25-95% of R¹ substituents are hydrogen.

In some embodiments, between 55-90% of R¹ substituents are hydrogen.

In some embodiments, between 1-50% of R¹ substituents are acetyl.

In some embodiments, between 4-20% of R¹ substituents are acetyl.

In some embodiments, between 2-50% of R¹ substituents are a group of formula (II).

In some embodiments, between 4-30% of R¹ substituents are a group of formula (II).

In some embodiments, 55-90% of R¹ substituents are hydrogen, 4-20% of R¹ substituents are acetyl, 4-30% of R¹ substituents are a group of formula (II).

In some embodiments, R² is amino and R³ is an arginine side chain.

In some embodiments, R¹ is selected from one of the following:

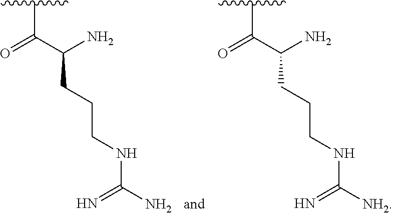 [SMILES: *C(=O)[C@@H](N)CCCNC(=N)N ; *C(=O)[C@H](N)CCCNC(=N)N]

In some embodiments, R² is amino and R³ is a lysine side chain.

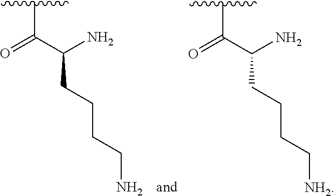 [SMILES: *C(=O)[C@@H](N)CCCCN ; *C(=O)[C@H](N)CCCCN]

In some embodiments, R² is amino and R³ is a histidine side chain.

In some embodiments, R¹ is selected from one of the following:

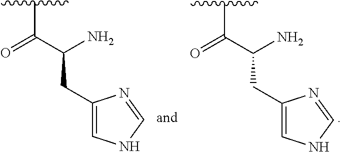 [SMILES: *C(=O)[C@@H](N)Cc1c[nH]cn1 ; *C(=O)[C@H](N)Cc1c[nH]cn1]

In some embodiments, at least 1% of R¹ substituents are selected from one of the following:

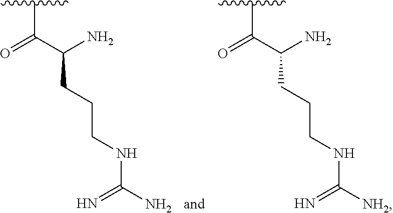 [SMILES: *C(=O)[C@@H](N)CCCNC(=N)N ; *C(=O)[C@H](N)CCCNC(=N)N]

AND at least 1% of R¹ substituents are selected from the following:

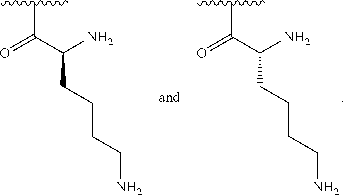 [SMILES: *C(=O)[C@@H](N)CCCCN ; *C(=O)[C@H](N)CCCCN]

In some embodiments, R² is amino and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

In some embodiments, R¹ is selected from one of the following:

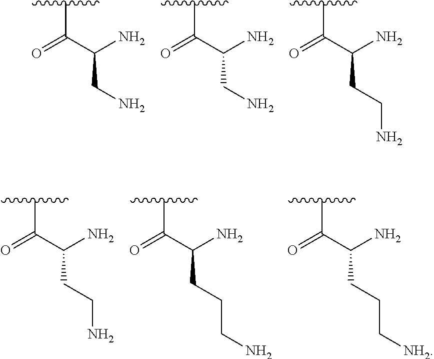

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

In some embodiments, R¹ is selected from one of the following:

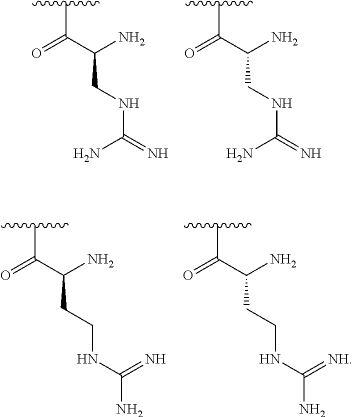 [SMILES: *C(=O)[C@@H](N)CNC(=N)N ; *C(=O)[C@H](N)CNC(=N)N ; *C(=O)[C@@H](N)CCNC(=N)N ; *C(=O)[C@H](N)CCNC(=N)N]

In some embodiments, R² is amino that is substituted with a nitrogen protecting group prior to substitution on chitosan and removed subsequent to substitution on chitosan.

In some embodiments, the nitrogen protecting group is tert-butyloxycarbonyl (Boc).

In some embodiments, in the synthetic process a nitrogen protecting group is used, which can provide an intermediate polymer having a nitrogen protecting group such as Boc.

In some embodiments, R² is amino.

In some embodiments, R² is hydrogen and R³ is amino.

In some embodiments, R² is hydrogen and R³ is guanidino.

In some embodiments, R² is hydrogen and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

In some embodiments, R¹ is selected from one of the following:

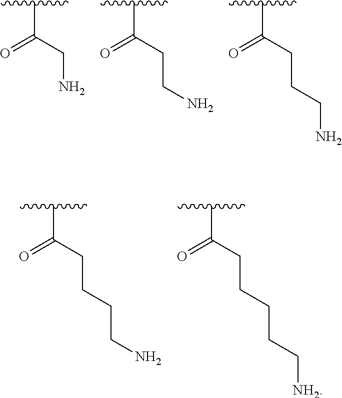

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

In some embodiments, R¹ is selected from one of the following:

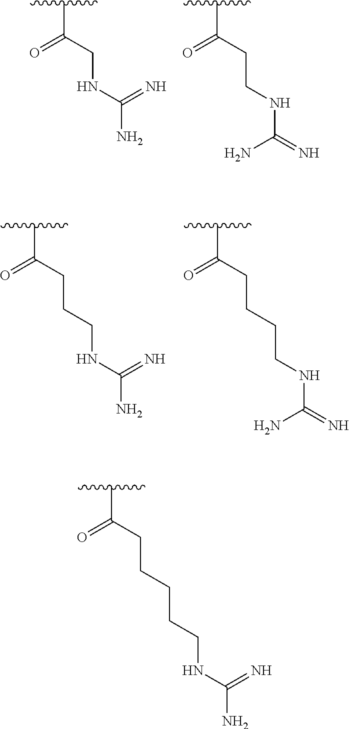 [SMILES: *C(=O)CNC(=N)N ; *C(=O)CCNC(=N)N ; *C(=O)CCCNC(=N)N ; *C(=O)CCCCNC(=N)N ; *C(=O)CCCCCNC(=N)N]

In some embodiments, at least 25% of R¹ substituents are H, at least 1% of R¹ substituents are acetyl, and at least 2% of R¹ substituents independently selected from any of the formulae specifically shown above.

In some embodiments, the functionalized chitosan of formula (I) may be further derivatized on the free hydroxyl moieties.

In some embodiments, the molecular weight of the functionalized chitosan is between 5,000 and 1,000,000 Da.

In some embodiments, the molecular weight of the functionalized chitosan is between 10,000 and 350,000 Da.

In some embodiments, the molecular weight of the functionalized chitosan is between 10,000 and 60,000 Da.

In some embodiments, the molecular weight of the functionalized chitosan is between 15,000 and 45,000 Da.

In some embodiments, the molecular weight of the functionalized chitosan is between 15,000 and 35,000 Da.

In some embodiments, the molecular weight of the functionalized chitosan is between 15,000 and 25,000 Da.

In some embodiments, the functionalized chitosan is soluble in aqueous solution between pH 6 and 8.

In some embodiments, the functionalized chitosan is soluble in aqueous solution between pH 6.8 and pH 7.4.

In some embodiments, the chitosan is functionalized at between 5% and 50%.

In a preferred embodiment, the chitosan is functionalized at between 20% and 30%.

In some embodiments, the degree of deacetylation (% DDA) of the derivatized chitosan is between 75% and 95%.

In some embodiments, the degree of deacetylation (% DDA) of the derivatized chitosan is between 80% and 90%.

In some embodiments, the polydispersity index (PDI) of the derivatized chitosan is between 1.0 and 2.5.

In some embodiments, the polydispersity index (PDI) of the derivatized chitosan is between 1.2 and 1.8.

In some embodiments, the functionalized chitosan is substantially free of other impurities, e.g., salt, e.g., NaCl.

In some embodiments, the composition has less than about 20%, 15%, 10%, 5%, 2%, or 1%, or is substantially free, of a chitosan polymer wherein one or more of the nitrogen-containing groups of the glucosamine monomer is substituted with a polymerized amino acid, e.g., polyarginine (e.g., diargine, triargine, etc).

In some embodiments, the composition has less than about 20%, 15%, 10%, 5%, 2%, or 1%, or is substantially free, of a chitosan polymer having a molecular weight of less than 15,000 Da, 10,000 Da, or 5,000 Da.

In yet another aspect, the invention features a food product (e.g., a stabilized food product with enhanced shelf life and safety) comprising a food product of animal or plant source, and a soluble or derivatized chitosan, wherein the soluble or derivatized chitosan is present on the surface of the food product.

In some embodiments, the soluble or derivatized chitosan is soluble in aqueous solution from about pH 6.8 to about pH 7.4.

In some embodiments, the soluble or derivatized chitosan is soluble in aqueous solution from about pH 3 to about pH 9.

In some embodiments, the soluble chitosan is underivatized.

In some embodiments, the derivatized chitosan comprises a chitosan of the following formula (I):

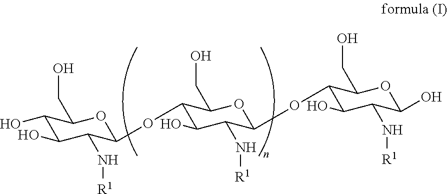

wherein:

n is an integer between 20 and 6000; and

each R¹ is independently selected for each occurrence from hydrogen, acetyl, and either:

a) a group of formula (II):

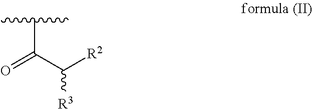

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, the derivatized chitosan comprises of the following formula (I) wherein at least 90% by number or weight of R¹ moieties are as defined in formula (I) (e.g., at least about 95%, at least about 96%, at least about 97%, at least about 98%, or at least about 99%):

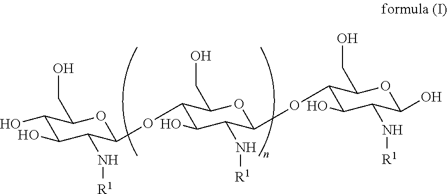

wherein:

n is an integer between 20 and 6000; and

each R¹ is independently selected for each occurrence from hydrogen, acetyl, and either:

a) a group of formula (II):

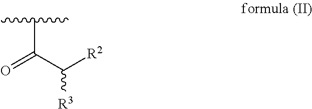

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, between 25-95% of R¹ substituents are hydrogen.

In some embodiments, between 55-90% of R¹ substituents are hydrogen.

In some embodiments, between 1-50% of R¹ substituents are acetyl.

In some embodiments, between 4-20% of R¹ substituents are acetyl.

In some embodiments, between 2-50% of R¹ substituents are a group of formula (II).

In some embodiments, between 4-30% of R¹ substituents are a group of formula (II).

In some embodiments, 55-90% of R¹ substituents are hydrogen, 4-20% of R¹ substituents are acetyl, 4-30% of R¹ substituents are a group of formula (II).

In some embodiments, R² is amino and R³ is an arginine side chain.

In some embodiments, R¹ is selected from one of the following:

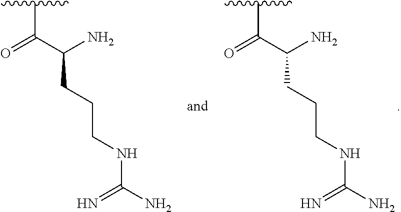 [SMILES: *C(=O)[C@@H](N)CCCNC(=N)N ; *C(=O)[C@H](N)CCCNC(=N)N]

In some embodiments, R² is amino and R³ is a lysine side chain.

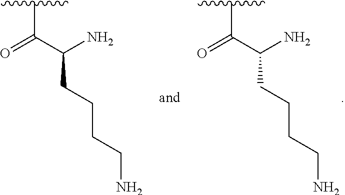 [SMILES: *C(=O)[C@@H](N)CCCCN ; *C(=O)[C@H](N)CCCCN]

In some embodiments, R² is amino and R³ is a histidine side chain.

In some embodiments, R¹ is selected from one of the following:

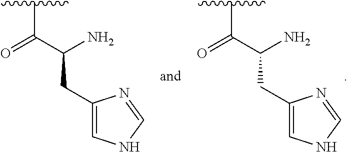 [SMILES: *C(=O)[C@@H](N)Cc1c[nH]cn1 ; *C(=O)[C@H](N)Cc1c[nH]cn1]

In some embodiments, at least 1% of R¹ substituents are selected from one of the following:

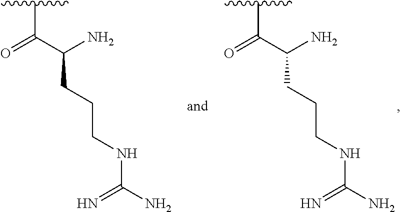 [SMILES: *C(=O)[C@@H](N)CCCNC(=N)N ; *C(=O)[C@H](N)CCCNC(=N)N]

AND at least 1% of R¹ substituents are selected from the following:

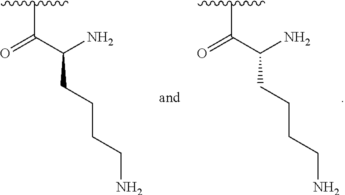 [SMILES: *C(=O)[C@@H](N)CCCCN ; *C(=O)[C@H](N)CCCCN]

In some embodiments, R² is amino and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

In some embodiments, R¹ is selected from one of the following:

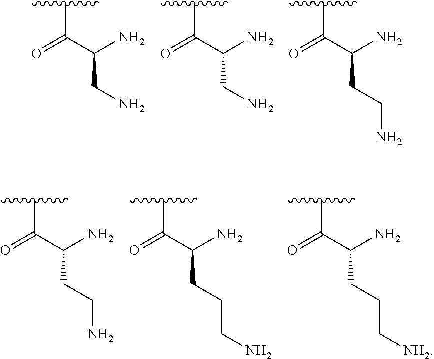

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

In some embodiments, R¹ is selected from one of the following:

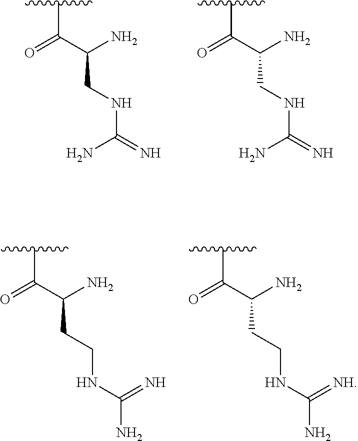 [SMILES: *C(=O)[C@@H](N)CNC(=N)N ; *C(=O)[C@H](N)CNC(=N)N ; *C(=O)[C@@H](N)CCNC(=N)N ; *C(=O)[C@H](N)CCNC(=N)N]

In some embodiments, R² is amino that is substituted with a nitrogen protecting group prior to substitution on chitosan and removed subsequent to substitution on chitosan.

In some embodiments, the nitrogen protecting group is tert-butyloxycarbonyl (Boc).

In some embodiments, in the synthetic process a nitrogen protecting group is used, which can provide an intermediate polymer having a nitrogen protecting group such as Boc.

In some embodiments, R² is amino.

In some embodiments, R² is hydrogen and R³ is amino.

In some embodiments, R² is hydrogen and R³ is guanidino.

In some embodiments, R² is hydrogen and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

In some embodiments, R¹ is selected from one of the following:

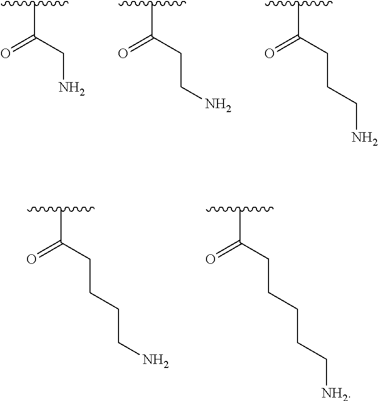 [SMILES: *C(=O)CN ; *C(=O)CCN ; *C(=O)CCCN ; *C(=O)CCCCN ; *C(=O)CCCCCN]

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

In some embodiments, R¹ is selected from one of the following:

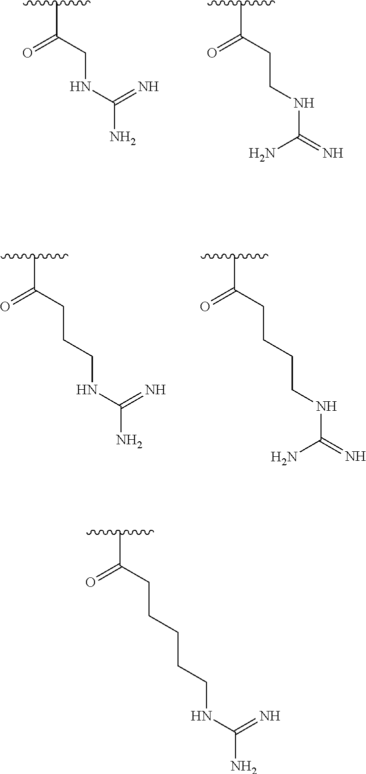 [SMILES: *C(=O)CNC(=N)N ; *C(=O)CCNC(=N)N ; *C(=O)CCCNC(=N)N ; *C(=O)CCCCNC(=N)N ; *C(=O)CCCCCNC(=N)N]

In some embodiments, at least 25% of R¹ substituents are H, at least 1% of R¹ substituents are acetyl, and at least 2% of R¹ substituents independently selected from any of the formulae specifically shown above.

In some embodiments, the functionalized chitosan of formula (I) may be further derivatized on the free hydroxyl moieties.

In some embodiments, the molecular weight of the functionalized chitosan is between 5,000 and 1,000,000 Da.

In some embodiments, the molecular weight of the functionalized chitosan is between 10,000 and 350,000 Da.

In some embodiments, the molecular weight of the functionalized chitosan is between 10,000 and 60,000 Da.

In some embodiments, the molecular weight of the functionalized chitosan is between 15,000 and 45,000 Da.

In some embodiments, the molecular weight of the functionalized chitosan is between 15,000 and 35,000 Da.

In some embodiments, the molecular weight of the functionalized chitosan is between 15,000 and 25,000 Da.

In some embodiments, the functionalized chitosan is soluble in aqueous solution between pH 6 and 8.

In some embodiments, the functionalized chitosan is soluble in aqueous solution between pH 6.8 and pH 7.4.

In some embodiments, the chitosan is functionalized at between 5% and 50%.

In a preferred embodiment, the chitosan is functionalized at between 20% and 30%.

In some embodiments, the degree of deacetylation (% DDA) of the derivatized chitosan is between 75% and 95%.

In some embodiments, the degree of deacetylation (% DDA) of the derivatized chitosan is between 80% and 90%.

In some embodiments, the polydispersity index (PDI) of the derivatized chitosan is between 1.0 and 2.5.

In some embodiments, the polydispersity index (PDI) of the derivatized chitosan is between 1.2 and 1.8.

In some embodiments, the functionalized chitosan is substantially free of other impurities, e.g., salt, e.g., NaCl.

In some embodiments, the soluble or derivatized chitosan has less than about 20%, 15%, 10%, 5%, 2%, or 1%, or is substantially free, of a chitosan polymer wherein one or more of the nitrogen-containing groups of the glucosamine monomer is substituted with a polymerized amino acid, e.g., polyarginine (e.g., diargine, triargine, etc).

In some embodiments, the soluble or derivatized chitosan has less than about 20%, 15%, 10%, 5%, 2%, or 1%, or is substantially free, of a chitosan polymer having a molecular weight of less than 15,000 Da, 10,000 Da, or 5,000 Da.

In one aspect, the invention features packaging for a food product, the packaging comprising: a tray comprising a soluble or derivatized chitosan; and optionally a packaging overwrap material.

In some embodiments, the tray comprises a sheet of material coated or impregnated with the soluble or derivatized chitosan, wherein the material is non-reactive with the soluble or derivatized chitosan.

In some embodiments, the sheet of material is selected from the group of polystyrene, blown polyvinyl chloride, molded pulp and polypropylene.

In some embodiments, the tray is in the form of a separate and/or removable food product tray.

In some embodiments, the tray comprises a perforated food product carrying surface, wherein the soluble or derivatized chitosan is present on the food product carrying surface.

In some embodiments, the tray contacts with the surface of the food product.

In some embodiments, the packaging further comprises an absorbent sheet or pad for absorbing liquid exuding from the food product.

In some embodiments, the packaging further comprises one or more preservatives for the food product.

In some embodiments, the preservative is selected from naturally occurring food preservatives that serve to maintain a pH level of a food product to be packaged in the packaging at or below 6.9.

In some embodiments, the preservative is selected from naturally occurring acids.

In some embodiments, the preservative is selected from one or more of citric acid, acetic acid, salts thereof, anhydride forms thereof, mixtures of such acids, salts and anhydride forms, and phosphoric acetate.

In some embodiments, the soluble or derivatized chitosan is soluble in aqueous solution from about pH 6.8 to about pH 7.4.

In some embodiments, the soluble or derivatized chitosan is soluble in aqueous solution from about pH 3 to about pH 9.

In some embodiments, the soluble chitosan is underivatized.

In some embodiments, the derivatized chitosan comprises a chitosan of the following formula (I):

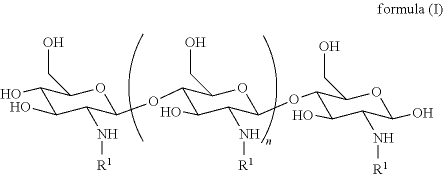

wherein:

n is an integer between 20 and 6000; and

each R¹ is independently selected for each occurrence from hydrogen, acetyl, and either:

a) a group of formula (II):

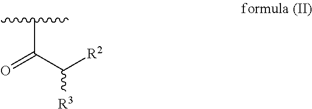

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, the derivatized chitosan comprises of the following formula (I) wherein at least 90% by number or weight of R¹ moieties are as defined in formula (I) (e.g., at least about 95%, at least about 96%, at least about 97%, at least about 98%, or at least about 99%):

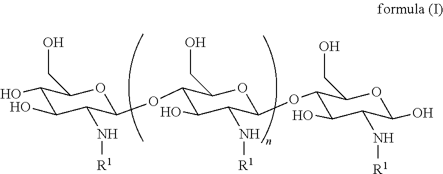

wherein:

n is an integer between 20 and 6000; and

each R¹ is independently selected for each occurrence from hydrogen, acetyl, and either:

a) a group of formula (II):

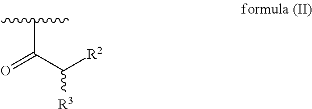

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, between 25-95% of R¹ substituents are hydrogen.

In some embodiments, between 55-90% of R¹ substituents are hydrogen.

In some embodiments, between 1-50% of R¹ substituents are acetyl.

In some embodiments, between 4-20% of R¹ substituents are acetyl.

In some embodiments, between 2-50% of R¹ substituents are a group of formula (II).

In some embodiments, between 4-30% of R¹ substituents are a group of formula (II).

In some embodiments, 55-90% of R¹ substituents are hydrogen, 4-20% of R¹ substituents are acetyl, 4-30% of R¹ substituents are a group of formula (II).

In some embodiments, R² is amino and R³ is an arginine side chain.

In some embodiments, R¹ is selected from one of the following:

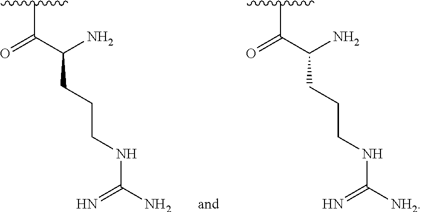 [SMILES: *C(=O)[C@@H](N)CCCNC(=N)N ; "and" ; *C(=O)[C@H](N)CCCNC(=N)N]

In some embodiments, R² is amino and R³ is a lysine side chain.

In some embodiments, R¹ is selected from one of the following:

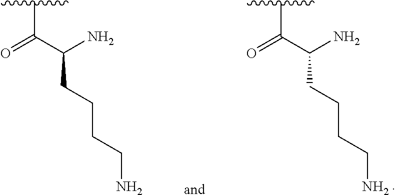 [SMILES: *C(=O)[C@@H](N)CCCCN ; *C(=O)[C@H](N)CCCCN ; "and" ; "."]

In some embodiments, R² is amino and R³ is a histidine side chain.

In some embodiments, R¹ is selected from one of the following:

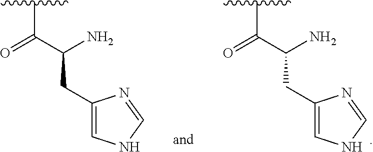 [SMILES: *C(=O)[C@@H](N)Cc1c[nH]cn1 ; *C(=O)[C@H](N)Cc1c[nH]cn1]

In some embodiments, at least 1% of R¹ substituents are selected from one of the following:

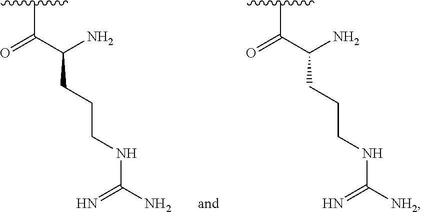 [SMILES: *C(=O)[C@@H](N)CCCNC(=N)N ; "and" ; *C(=O)[C@H](N)CCCNC(=N)N]

AND at least 1% of R¹ substituents are selected from the following:

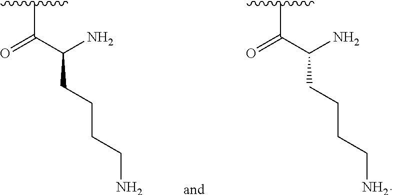 [SMILES: *C(=O)[C@@H](N)CCCCN ; *C(=O)[C@H](N)CCCCN ; "and" ; "."]

In some embodiments, R² is amino and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

In some embodiments, R¹ is selected from one of the following:

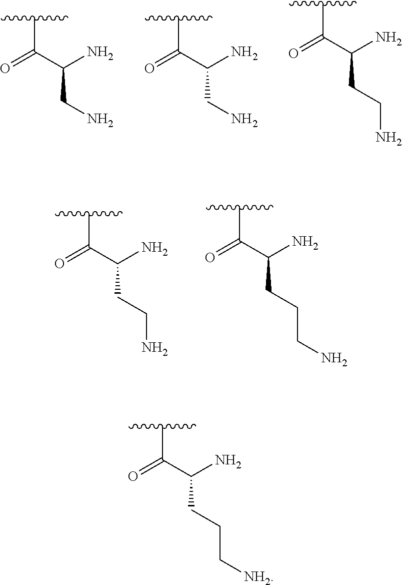 [SMILES: *C(=O)[C@@H](N)CN ; *C(=O)[C@H](N)CN ; *C(=O)[C@@H](N)CCN ; *C(=O)[C@H](N)CCN ; *C(=O)[C@@H](N)CCCN ; *C(=O)[C@H](N)CCCN]

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

In some embodiments, R¹ is selected from one of the following:

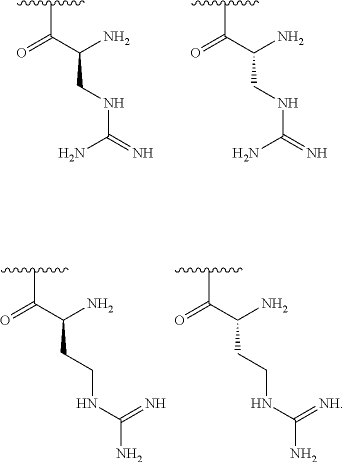 [SMILES: *C(=O)[C@@H](N)CNC(=N)N ; *C(=O)[C@H](N)CNC(=N)N ; *C(=O)[C@@H](N)CCNC(=N)N ; *C(=O)[C@H](N)CCNC(=N)N]

In some embodiments, R² is amino that is substituted with a nitrogen protecting group prior to substitution on chitosan and removed subsequent to substitution on chitosan.

In some embodiments, the nitrogen protecting group is tert-butyloxycarbonyl (Boc).

In some embodiments, in the synthetic process a nitrogen protecting group is used, which can provide an intermediate polymer having a nitrogen protecting group such as Boc.

In some embodiments, R² is amino.

In some embodiments, R² is hydrogen and R³ is amino.

In some embodiments, R² is hydrogen and R³ is guanidino.

In some embodiments, R² is hydrogen and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

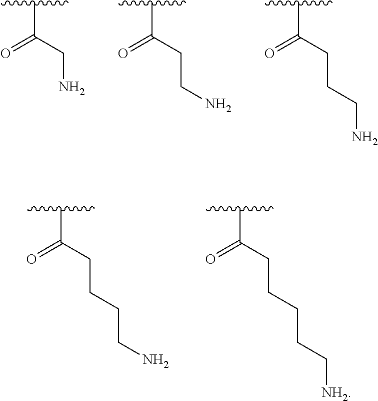 [SMILES: *C(=O)CN ; *C(=O)CCN ; *C(=O)CCCN ; *C(=O)CCCCN ; *C(=O)CCCCCN]

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

In some embodiments, R¹ is selected from one of the following:

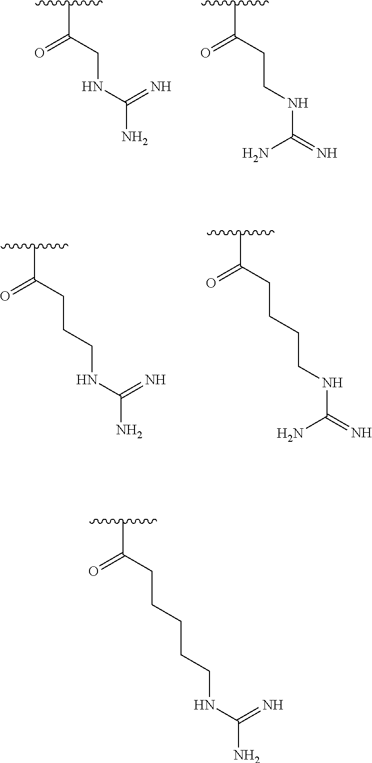 [SMILES: *C(=O)CNC(=N)N ; *C(=O)CCNC(=N)N ; *C(=O)CCCNC(=N)N ; *C(=O)CCCCNC(=N)N ; *C(=O)CCCCCNC(=N)N]

In some embodiments, at least 25% of R′ substituents are H, at least 1% of R′ substituents are acetyl, and at least 2% of R¹ substituents independently selected from any of the formulae specifically shown above.

In some embodiments, the functionalized chitosan of formula (I) may be further derivatized on the free hydroxyl moieties.

In some embodiments, the molecular weight of the functionalized chitosan is between 5,000 and 1,000,000 Da.

In some embodiments, the molecular weight of the functionalized chitosan is between 10,000 and 350,000 Da.

In some embodiments, the molecular weight of the functionalized chitosan is between 10,000 and 60,000 Da.

In some embodiments, the molecular weight of the functionalized chitosan is between 15,000 and 45,000 Da.

In some embodiments, the molecular weight of the functionalized chitosan is between 15,000 and 35,000 Da.

In some embodiments, the molecular weight of the functionalized chitosan is between 15,000 and 25,000 Da.

In some embodiments, the functionalized chitosan is soluble in aqueous solution between pH 6 and 8.

In some embodiments, the functionalized chitosan is soluble in aqueous solution between pH 6.8 and pH 7.4.

In some embodiments, the chitosan is functionalized at between 5% and 50%.

In a preferred embodiment, the chitosan is functionalized at between 20% and 30%.

In some embodiments, the degree of deacetylation (% DDA) of the derivatized chitosan is between 75% and 95%.

In some embodiments, the degree of deacetylation (% DDA) of the derivatized chitosan is between 80% and 90%.

In some embodiments, the polydispersity index (PDI) of the derivatized chitosan is between 1.0 and 2.5.

In some embodiments, the polydispersity index (PDI) of the derivatized chitosan is between 1.2 and 1.8.

In some embodiments, the functionalized chitosan is substantially free of other impurities, e.g., salt, e.g., NaCl.

In some embodiments, the soluble or derivatized chitosan has less than about 20%, 15%, 10%, 5%, 2%, or 1%, or is substantially free, of a chitosan polymer wherein one or more of the nitrogen-containing groups of the glucosamine monomer is substituted with a polymerized amino acid, e.g., polyarginine (e.g., diargine, triargine, etc).

In some embodiments, the soluble or derivatized chitosan has less than about 20%, 15%, 10%, 5%, 2%, or 1%, or is substantially free, of a chitosan polymer having a molecular weight of less than 15,000 Da, 10,000 Da, or 5,000 Da.

In another aspect, the invention features a food product tray for use in food packaging, the food product tray comprising a perforated food product carrying surface, wherein the food product carrying surface is coated or impregnated with a soluble or derivatized chitosan.

In some embodiments, the soluble or derivatized chitosan is soluble in aqueous solution from about pH 6.8 to about pH 7.4.

In some embodiments, the soluble or derivatized chitosan is soluble in aqueous solution from about pH 3 to about pH 9.

In some embodiments, the soluble chitosan is underivatized.

In some embodiments, the derivatized chitosan comprises a chitosan of the following formula (I):

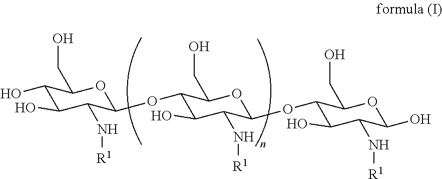

wherein:

n is an integer between 20 and 6000; and

each R¹ is independently selected for each occurrence from hydrogen, acetyl, and either:

a) a group of formula (II):

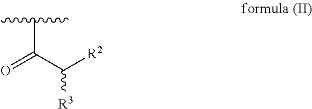

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, the derivatized chitosan comprises of the following formula (I) wherein at least 90% by number or weight of R¹ moieties are as defined in formula (I) (e.g., at least about 95%, at least about 96%, at least about 97%, at least about 98%, or at least about 99%):

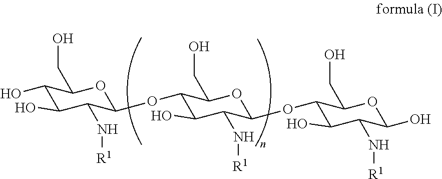

wherein:

n is an integer between 20 and 6000; and

each R¹ is independently selected for each occurrence from hydrogen, acetyl, and either:

a) a group of formula (II):

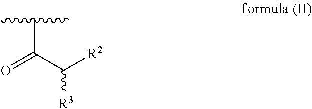

wherein R² is hydrogen or amino; and

R³ is amino, guanidino, C₁-C₆ alkyl substituted with an amino or guanidino moiety, or a natural or unnatural amino acid side chain;

or

b) R¹, when taken together with the nitrogen to which it is attached, forms a guanidine moiety;

wherein at least 25% of R¹ substituents are H, at least 1% of R¹ substituents are acetyl, and at least 2% of R¹ substituents are a group of formula (II) or are taken together with the nitrogen to which they are attached to form a guanidine moiety.

In some embodiments, between 25-95% of R¹ substituents are hydrogen.

In some embodiments, between 55-90% of R¹ substituents are hydrogen.

In some embodiments, between 1-50% of R¹ substituents are acetyl.

In some embodiments, between 4-20% of R¹ substituents are acetyl.

In some embodiments, between 2-50% of R¹ substituents are a group of formula (II).

In some embodiments, between 4-30% of R¹ substituents are a group of formula (II).

In some embodiments, 55-90% of R¹ substituents are hydrogen, 4-20% of R¹ substituents are acetyl, 4-30% of R¹ substituents are a group of formula (II).

In some embodiments, R² is amino and R³ is an arginine side chain.

In some embodiments, R¹ is selected from one of the following:

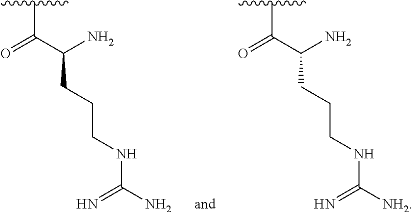 [SMILES: *C(=O)[C@@H](N)CCCNC(=N)N ; "and" ; *C(=O)[C@H](N)CCCNC(=N)N]

In some embodiments, R² is amino and R³ is a lysine side chain.

In some embodiments, R¹ is selected from one of the following:

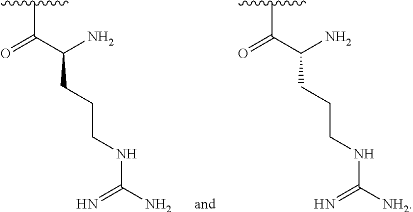 [SMILES: *C(=O)[C@@H](N)CCCNC(=N)N ; "and" ; *C(=O)[C@H](N)CCCNC(=N)N]

In some embodiments, R² is amino and R³ is a histidine side chain.

In some embodiments, R¹ is selected from one of the following:

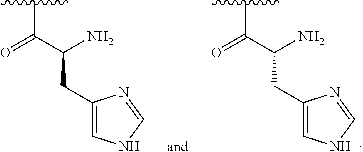 [SMILES: *C(=O)[C@@H](N)Cc1c[nH]cn1 ; "and" ; *C(=O)[C@H](N)Cc1c[nH]cn1 ; "."]

In some embodiments, at least 1% of R¹ substituents are selected from one of the following:

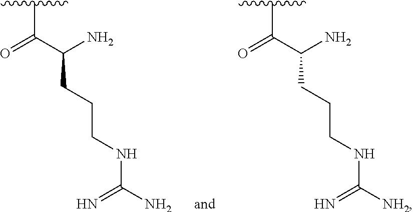 [SMILES: *C(=O)[C@@H](N)CCCNC(=N)N ; "and" ; *C(=O)[C@H](N)CCCNC(=N)N]

AND at least 1% of R¹ substituents are selected from the following:

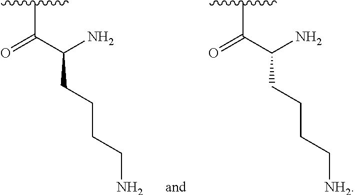 [SMILES: *C(=O)[C@@H](N)CCCCN ; "and" ; *C(=O)[C@H](N)CCCCN]

In some embodiments, R² is amino and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

In some embodiments, R¹ is selected from one of the following:

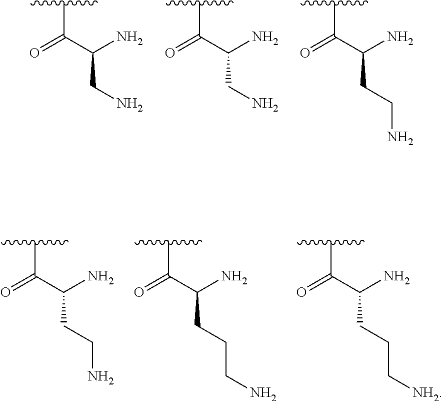 [SMILES: *C(=O)[C@@H](N)CN ; *C(=O)[C@H](N)CN ; *C(=O)[C@@H](N)CCN ; *C(=O)[C@H](N)CCN ; *C(=O)[C@@H](N)CCCN ; *C(=O)[C@H](N)CCCN]

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

In some embodiments, R¹ is selected from one of the following:

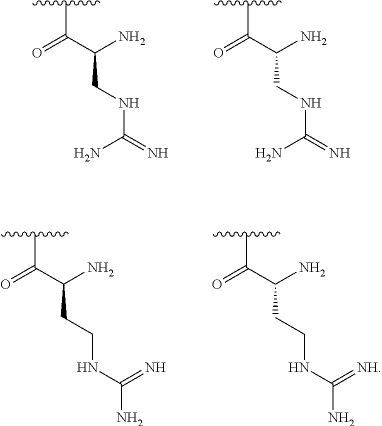 [SMILES: *C(=O)[C@@H](N)CNC(=N)N ; *C(=O)[C@H](N)CNC(=N)N ; *C(=O)[C@@H](N)CCNC(=N)N ; *C(=O)[C@H](N)CCNC(=N)N]

In some embodiments, R² is amino that is substituted with a nitrogen protecting group prior to substitution on chitosan and removed subsequent to substitution on chitosan.

In some embodiments, the nitrogen protecting group is tert-butyloxycarbonyl (Boc).

In some embodiments, in the synthetic process a nitrogen protecting group is used, which can provide an intermediate polymer having a nitrogen protecting group such as Boc.

In some embodiments, R² is amino.

In some embodiments, R² is hydrogen and R³ is amino.

In some embodiments, R² is hydrogen and R³ is guanidino.

In some embodiments, R² is hydrogen and R³ is a substituted C₁-C₆ alkyl.

In some embodiments, R³ is C₁-C₆ alkyl substituted with an amino group.

In some embodiments, R³ is C₁ alkyl substituted with an amino group.

In some embodiments, R³ is C₂ alkyl substituted with an amino group.

In some embodiments, R³ is C₃ alkyl substituted with an amino group.

In some embodiments, R³ is C₄ alkyl substituted with an amino group.

In some embodiments, R³ is C₅ alkyl substituted with an amino group.

In some embodiments, R³ is C₆ alkyl substituted with an amino group.

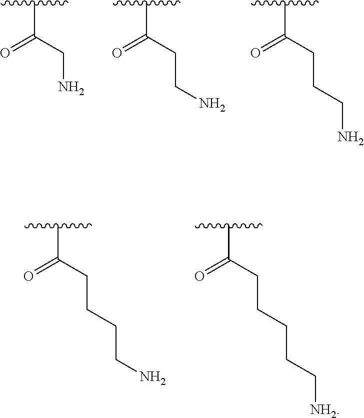 [SMILES: *C(=O)CN ; *C(=O)CCN ; *C(=O)CCCN ; *C(=O)CCCCN ; *C(=O)CCCCCN]

In some embodiments, R³ is C₁-C₆ alkyl substituted with a guanidino group.

In some embodiments, R³ is C₁ alkyl substituted with a guanidino group.

In some embodiments, R³ is C₂ alkyl substituted with a guanidino group.

In some embodiments, R³ is C₃ alkyl substituted with a guanidino group.

In some embodiments, R³ is C₄ alkyl substituted with a guanidino group.

In some embodiments, R³ is C₅ alkyl substituted with a guanidino group.

In some embodiments, R³ is C₆ alkyl substituted with a guanidino group.

In some embodiments, R¹ is selected from one of the following:

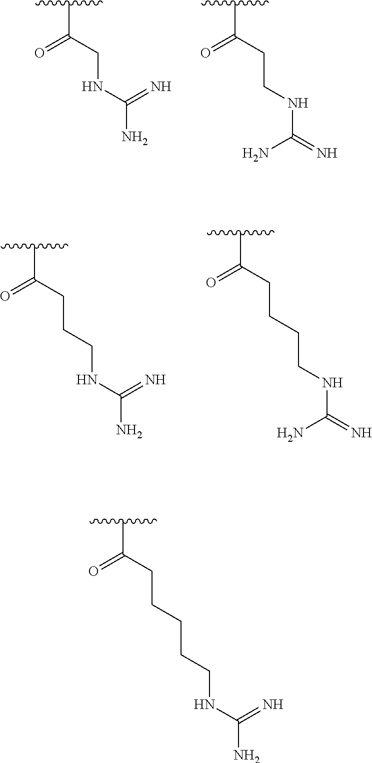 [SMILES: *C(=O)CNC(=N)N ; *C(=O)CCNC(=N)N ; *C(=O)CCCNC(=N)N ; *C(=O)CCCCNC(=N)N ; *C(=O)CCCCCNC(=N)N]

In some embodiments, at least 25% of R¹ substituents are H, at least 1% of R¹ substituents are acetyl, and at least 2% of R¹ substituents independently selected from any of the formulae specifically shown above.

In some embodiments, the functionalized chitosan of formula (I) may be further derivatized on the free hydroxyl moieties.

In some embodiments, the molecular weight of the functionalized chitosan is between 5,000 and 1,000,000 Da.

In some embodiments, the molecular weight of the functionalized chitosan is between 10,000 and 350,000 Da.

In some embodiments, the molecular weight of the functionalized chitosan is between 10,000 and 60,000 Da.

In some embodiments, the molecular weight of the functionalized chitosan is between 15,000 and 45,000 Da.

In some embodiments, the molecular weight of the functionalized chitosan is between 15,000 and 35,000 Da.

In some embodiments, the molecular weight of the functionalized chitosan is between 15,000 and 25,000 Da.

In some embodiments, the functionalized chitosan is soluble in aqueous solution between pH 6 and 8.

In some embodiments, the functionalized chitosan is soluble in aqueous solution between pH 6.8 and pH 7.4.

In some embodiments, the chitosan is functionalized at between 5% and 50%.

In a preferred embodiment, the chitosan is functionalized at between 20% and 30%.

In some embodiments, the degree of deacetylation (% DDA) of the derivatized chitosan is between 75% and 95%.

In some embodiments, the degree of deacetylation (% DDA) of the derivatized chitosan is between 80% and 90%.

In some embodiments, the polydispersity index (PDI) of the derivatized chitosan is between 1.0 and 2.5.

In some embodiments, the polydispersity index (PDI) of the derivatized chitosan is between 1.2 and 1.8.

In some embodiments, the functionalized chitosan is substantially free of other impurities, e.g., salt, e.g., NaCl.

In some embodiments, the soluble or derivatized chitosan has less than about 20%, 15%, 10%, 5%, 2%, or 1%, or is substantially free, of a chitosan polymer wherein one or more of the nitrogen-containing groups of the glucosamine monomer is substituted with a polymerized amino acid, e.g., polyarginine (e.g., diargine, triargine, etc).

In some embodiments, the soluble or derivatized chitosan has less than about 20%, 15%, 10%, 5%, 2%, or 1%, or is substantially free, of a chitosan polymer having a molecular weight of less than 15,000 Da, 10,000 Da, or 5,000 Da.

### BRIEF DESCRIPTION OF THE DRAWINGS

FIG. 1 shows a dose response of the sanitizing activity of chitosan-arginine (31% functionalized, 52 kDa, 89% DDA, 1.35 PDI) after 30 minutes on plastic contaminated with MRSA strain MW-2 (ATCC BAA-1707).

FIG. 2 shows the residual antibacterial activity of chitosan-arginine (43 kDa, 25% functionalized, 88% DDA, 2.28 PDI) toward Gram-negative Acinetobacter baumannii (ATCC 19606) after 24-hour prophylactic treatment of polystyrene surface.

FIG. 3 shows the residual antibacterial activity of chitosan-arginine (43 kDa, 25% functionalized, 88% DDA, 2.28 PDI) toward Gram-negative Acinetobacter baumannii (ATCC 19606) one week prophylactic treatment of polystyrene surface.

FIG. 4 shows the residual antibacterial activity of chitosan-arginine (43 kDa, 25% functionalized, 88% DDA, 2.28 PDI) toward Gram-positive Staphylococcus aureus strain MW-2 (clinical isolate from blood/CSF of community acquired disseminating infection) after 24-hour prophylactic treatment of polystyrene surface.

FIG. 5 shows the residual antibacterial activity of chitosan-arginine (43 kDa, 25% functionalized, 88% DDA, 2.28 PDI) toward Gram-positive Staphylococcus aureus strain MW-2 (clinical isolate from blood/CSF of community acquired disseminating infection) one week prophylactic treatment of polystyrene surface.

FIG. 6 shows a dose response of Acinetobacter baumannii prophylactic killing using chitosan-arginine (43 kDa, 25% functionalized, 88% DDA, 2.28 PDI) dried on a surface for 1 month.

FIG. 7 shows a dose response of MRSA prophylactic killing using chitosan-arginine (43 kDa, 25% functionalized, 88% DDA, 2.28 PDI) dried on a surface dried for 1 month.

FIG. 8 is an image of the chitosan-arginine film made of 0.4% chitosan-arginine (28% functionalization, 30 kDa, 88% DDA, 2.1 PDI), 2% HPMC, and 40% ethanol in water.

FIG. 9 shows the testing result of ET tubes coated with 0.2% chitosan-arginine (28% functionalization, 30 kDa, 88% DDA, 2.1 PDI), 2% HPMC, 40% ethanol, and 60% water or 0.4% chitosan-arginine (28% functionalization, 30 kDa, 88% DDA, 2.1 PDI), 2% HPMC, 20% ethanol, and 80% water for residual antibacterial activity against Acinetobacter baumannii (ATCC 19606) after 1-hour.

FIG. 10 shows the testing result of ET tubes coated with or 0.4% chitosan-arginine (25% functionalization, 100 kDa, 88% DDA, 3.2 PDI), 2% HPMC, 20% ethanol, and 80% water for residual antibacterial activity against Acinetobacter baumannii (ATCC 19606) after 1-hour.

FIG. 11 shows the remaining vCFU on the surfaces of plastic tissue culture plates with 12 μg/cm² of each chitosan derivative dried on the surface (see Table 4) and treated with MRSA strain MW-2 (ATCC BAA-1707) for 4 hours.

FIG. 12 shows the remaining vCFU on the surfaces of plastic tissue culture plates with 12 μg/cm² of each chitosan derivative dried on the surface (see Table 4) and treated with Acinetobacter baumannii (ATCC 19606) for 1 hour.

FIG. 13 shows chitosan-arginine (43 kDa, 25% functionalized, 88% DDA, 2.28 PDI) dose response against stationary MRSA MW-2 (ATCC BAA-1707) 2 day-old biofilms. Data is CFU recovered after 4-hour treatment.

FIG. 14 depicts the immediate dispersal of Acinetobacter baumannii (ATCC 19606) 2-day old stationary biofilms treated with 100 μg/ml chitosan-arginine (43 kDa, 25% functionalized, 88% DDA, 2.28 PDI). The biofilms were rinsed, stained with crystal violet and treated with either water or chitosan-arginine for 5 minutes and rinsed.

FIG. 15 shows chitosan-arginine (43 kDa, 25% functionalized, 88% DDA, 2.28 PDI) dose response against Klebsiella pneumoniae (ATCC 13883) 2 day-old biofilms grown on pegs. Data is CFU recovered after 5-hour treatment.

FIG. 16 shows chitosan-arginine (43 kDa, 25% functionalized, 88% DDA, 2.28 PDI) dose response against Acinetobacter baumannii (ATCC 19606) 2 day-old biofilms grown on pegs. Data is CFU recovered after 3-hour treatment.

FIG. 17 shows chitosan-arginine (43 kDa, 25% functionalized, 88% DDA, 2.28 PDI) dose response against Pseudomonas aeruginosa (ATCC BAA-47) 2 day-old biofilms grown on pegs. Data is CFU recovered after 3-hour treatment.

FIG. 18 depicts mixed wound biofilms (MRSA MW-2 ATCC BAA-1707, Psudomonas aeruginosa ATCC BAA-47, and Vancomycin-resistant Enterococcus faecalis ATCC 51299) grown in a flow cell overnight then treated with either water or 200 μg/mL chitosan-arginine (43 kDa, 25% functionalized, 88% DDA, 2.28 PDI) twice daily for two days and finally rinsed and sonicated for 30 seconds and stained with crystal violet.

FIG. 19 depicts the amount and consistency of material removed following the final rinse from flow cells treated with either water or chitosan-arginine (43 kDa, 25% functionalized, 88% DDA, 2.28 PDI) in FIG. 18.

FIG. 20 depicts dose-dependent effect of chitosan-arginine (0-500 μg ml⁻¹) on E. coli O157 survival in chicken juice samples stored at 4 or 20° C. Values represent means±SEM (n=3).

FIG. 21 depicts dose-dependent effect of chitosan-arginine (0-500 μg ml⁻¹) on E. coli O157 cell activity (luminescence) in chicken juice samples stored at 4 or 20° C. Values represent means±SEM (n=3).

FIG. 22 depicts changes in total viable counts (a, c) and coliforms (b, d) over 72 h post-incubation period in chicken juice ±500 μg ml⁻¹ chitosan-arginine (CH-Arg) when incubated at 4° C. and 20° C. Values represent means±SEM (n=3).

### DETAILED DESCRIPTION

Described herein are methods and compositions that are useful for treating a surface (e.g., an inert and/or non-animal surface, e.g., a synthetic or semi-synthetic surface (e.g., cellulose, ceramic, plastic, metal, glass, wood, or stone), in e.g., hospital, food processing or handling facility, school, nursing home, military facility, prison, kitchen, or restaurant; or a food or food product surface). Exemplary methods generally include use of a chitosan, e.g., a soluble chitosans or derivatized chitosan described herein, to reduce the bioburden on the surface (e.g., by killing bacteria), to reduce bacterial biofilms, or to prevent or inhibit (e.g., slow) formation of biofilm on a surface. The compounds and compositions described herein can be used in addition to (e.g., without changing, e.g., together with or after) one or more existing standard operating procedures (e.g., sanitizing and/or disinfection procedures and/or techniques), for example, in an institutional setting. Methods of processing food or preserving a food product are described herein. The method comprises contacting an effective amount of a composition described herein with the food or food product (e.g., at the surface of the food or food product), e.g., to increase shelf life, inhibit bacterial spoilage, or control bacterial contamination of the food or food product. Described herein are also food products and packaging for a food product comprising a chitosan (e.g., a soluble derivatized chitosan described herein). In some embodiments, the soluble chitosans or derivatized chitosans exhibit one or more of the following characteristics: for example, biocompatibility (nontoxicity), biodegradability, long shelf life, ability to be stored as a dry powder, ability to dissolve in water, saline, or other neutral solution, and to be dispersed as needed.

The compositions and compounds described herein, e.g., non-pharmaceutical compositions (e.g., liquid compositions (e.g., aqueous solutions) or dry powder compositions) described herein, can be used to treat a surface (e.g., an inert and/or non-animal surface, e.g., a synthetic or semi-synthetic surface (e.g., cellulose, plastic, metal, glass, wood or stone), in e.g., a hospital, food processing or handling facility, nursing home, school, military facility, prison, public transportation, kitchen, or restaurant; or a food or food product surface). Exemplary compounds include, but not limited to, soluble chitosan compounds, chitosan-arginine compounds, chitosan-guanidine compounds, chitosan-unnatural amino acid compounds, chitosan-acid-amine compounds, chitosan-natural amino acid compounds, and co-derivatives of the just described compounds and the salts thereof. These compounds and their antimicrobial activity are disclosed in U.S. patent application Ser. Nos. 11/657,382 and 11/985,057, which is herein incorporated by reference. Exemplary compounds also include neutral chitosan compounds (e.g., monosaccharide-containing chitosan compounds and chitosan-lactobionic acid compounds), chitosan-glycolic acid compounds, and co-derivatives of these compounds and the salts thereof.

### DEFINITIONS

As used herein, a “disinfectant” refers to an antimicrobial agent that is applied to non-living objects to destroy microorganisms, e.g., cleaning an article of some or all of the pathogenic organisms which may cause infection. A disinfectant generally kills all detectable microorganisms upon application in less than 5 minutes.

As used herein, a “sanitizer” refers to a substance that reduces the number of microorganisms to a safe level, e.g., capable of killing 99.99%, of a specific bacterial test population, within a specified period of time.

As used herein, “bioburden” refers to the number of microorganisms with which an object is contaminated.

As used herein, “nosocomial infection” refers to infection which is a result of treatment in a hospital or a healthcare service unit, but secondary to the patient's original condition. Infections are considered nosocomial if they first appear 48 hours or more after hospital admission or within 30 days after discharge. This type of infection is also known as a hospital-acquired infection (or more generically healthcare-associated infections).

As used herein, “community-acquired infection” refers also to infection which is a result of activity in a highly populated facility or area. Any infection acquired in the community, that is, contrasted with those acquired in a health care facility (nosocomial infection). An infection would be classified as community-acquired if the patient had not recently been in a health care facility or been in contact with someone who had been recently in a health care facility.

As used herein, “resistant microorganism or bacterium” means an organism which has become resistant to an anti-bacterial agent. Also, resistant microorganism or bacterium means its effective MIC has exceeded the effective dosage according to Clinical Laboratory Standards Institute (CLSI) resistance breakpoints, predefined national or internationally accepted limits, at or above which administration of an effective dose of antibiotic produces undesirable side effects. In some embodiments, the minimum inhibitory concentration of a resistant bacterium is at least, 2, 5, 10, or 100 greater than for that seen with a non-resistant bacterium for a selected anti-bacterial agent.

As used herein, “substantially free” means less than e.g., about 20%, 10%, 8%, 6%, 4%, 2%, 1%, 0.5%, 0.1%, 0.01%, or 0.005% of the composition described herein is free of a substance described herein.

As used herein, “prophylactic activity” refers to an activity that prevents or slows down (e.g., lessens) the growth of bacteria and/or the formation of bacterial biofilms on a surface described herein.

As used herein, “residual activity” refers to an activity that prevents or slows down (e.g., lessens) the growth of bacteria and/or the formation of bacterial biofilms on a surface described herein other than the sanitizing activity of the composition described herein.

As used herein, “biocompatibility” refers to the ability of the compounds or compositions described herein to perform one or more functions described herein (e.g., sanitizing activity, or prophylactic activity) without eliciting one or more undesirable local or systemic biological effects, e.g., a toxic or injurious effect on biological systems, or an uncontrolled activation of immune response. In some embodiments, the compounds or compositions described herein elicit minimal or do not elicit any undesirable local or systemic biological effects. In some embodiments, the compounds or compositions described herein can generate one or more beneficial biological effects, e.g., supporting appropriate cellular activities, or promoting wound healing.

As used herein, “biodegradation” refers to the chemical breakdown of the compounds or compositions described herein by a physiological environment.

### Methods of Use as a Sanitizer

A chitosan-containing compound described herein (e.g., a soluble chitosan or derivatized chitosan described herein) can be applied to a surface (e.g., an inert and/or non-animal surface, or a food or food product surface), thereby reducing the bioburden on the surface and providing sanitization. For example, a composition comprising a chitosan (e.g., a soluble chitosan or derivatized chitosan described herein) can be sprayed, evaporated, or wiped onto a surface. The consequence of deposition on the surface is to sanitize the bacteria present on the surface. In some embodiments, the chitosan (e.g., a soluble chitosan or derivatized chitosan described herein) on the surface can reduce (e.g., disrupt) bacterial biofilms, prevent or inhibit (e.g., slow) the formation of a biofilm, or prevent or inhibit bacteria to grow on that surface.

Existing standard operating procedures (e.g., sanitizing and/or disinfection procedures and/or techniques) such as alcohols, aldehydes, oxidizing agents (e.g., sodium hypochlorite, calcium hypochlorite, chloramine, chlorine dioxide, hydrogen peroxide, Accelerated Hydrogen Peroxide (AHP®), iodine, ozone, acidic electrolyzed water, peracetic acid, lactic acid, performic acid, potassium permanganate, potassium peroxymonosulfate), phenolics (e.g., phenol, o-phenylphenol, chloroxylenol, hexachlorophene, thymol), and quanternary ammonium compounds (quats), are potentially harmful (e.g., toxic) to humans or animals and are generally not eco-friendly. The compounds and compositions described herein are, biocompatible (e.g., non-toxic) and/or biodegradable (e.g., eco-friendly), e.g., compared to existing standard operating procedures (e.g., sanitizing and/or disinfection procedures and/or techniques), for example, in an institutional setting. Therefore, the compounds and composition described herein can be allowed to remain on the surface, e.g., until the sanitizing activity of the compound and composition described herein diminishes, or until next disinfection.

Exemplary surfaces include inert and/or non-animal surfaces, e.g., synthetic or semi-synthetic surfaces, e.g. polymer surfaces. For example, the surface can be a cellulose surface, a ceramic surface, a plastic surface (e.g., Bakelite, polystyrene, polyvinyl chloride (PVC), poly(methyl methacrylate) (PMMA, also known as acrylic glass)), a metal surface, a glass surface, a wood surface, a rubber surface, a stone surface (e.g., granite, marble, nanocrystal stone, nanoquartz stone), or a hybrid thereof. In some embodiments, the surface is a non-porous surface.

In some embodiments, the surfaces are present in a high traffic and/or high population density area such as a hospital or medical/dental facility, a nursing home, a laboratory, a pharmaceutical or medical device manufacturing facility, a school or preschool, a childcare center, a military facility, a prison, a restaurant, a kitchen, a food processing and/or handling facility, a bathroom or toilet facility, a gym or fitness center, a barbershop or beauty salon, a library, a museum, a public transportation (e.g., a plane, train or bus), an airport, a train or bus station, a hotel, a steam room, a spa, or a paper mill.

In some embodiments, the surfaces are present on a medical or dental device or a portion thereof (such as a tube, e.g., a ventilation tube), e.g., that can be attached to a subject (e.g., a patient). Exemplary medical or dental devices include ventilators, aspirators, transfusion units, electrosurgical units, fetal monitors, heart-lung machines, incubators, infusion pumps, invasive blood pressure units, pulse oximeters, radiation-therapy machines, stents, ultrasound sensors, endoscopes, implantable RFID chips, surgical drills and saws, laparoscopic insufflators, electronic thermometer, breast pumps, surgical microscope, ultrasonic nebulizers, sphygmomanometers, surgical table, mouth mirror, dental probes, dental retractors, dental drills, dental excavators, and dental scalers.

In some embodiments, the surfaces are present in a food processing or handling facility. For example, the surfaces can be present on a food processing or handling platform or machine.

Methods of Use as a Residual Surface Agent with Prophylactic Activity

A chitosan-containing compound described herein (e.g., a soluble chitosan or derivatized chitosan described herein) can be applied to a surface (e.g., an inert and/or non-animal surface; or a food or food product surface), dried onto that surface and left as a coating on the surface that reduces the ability of bacteria to thrive or to prevent or inhibit (e.g., slow) a biofilm to form on the surface, for at least 1 month subsequent to the application of the derivatized chitosan to that surface. For example, a composition comprising chitosan (e.g., a soluble chitosan or derivatized chitosan described herein) can be sprayed, evaporated, or wiped onto a surface. This chitosan containing composition can be allowed to dry on the surface, rather than being wiped from the surface, allowing the chitosan (e.g., a soluble chitosan or derivatized chitosan described herein) to remain on the surface providing residual or prophylactic activity. In some embodiments, the chitosan (e.g., a soluble chitosan or derivatized chitosan described herein) on the surface can help to prevent or inhibit (e.g., slow) the formation of a biofilm on that surface. In some embodiments, the chitosan (e.g., a soluble chitosan or derivatized chitosan described herein) on the surface provides residual activity for at least 1 month, when not washed, wiped, rinsed, scraped or abraded.

The methods described herein can be used in addition to (e.g., without changing, e.g., together with or after) one or more existing standard operating procedures (e.g., sanitizing and/or disinfection procedures and/or techniques), for example, in an institutional setting. Existing standard sanitizing and disinfection procedures and techniques include, e.g., alcohols, aldehydes, oxidizing agents (e.g., sodium hypochlorite, calcium hypochlorite, chloramine, chlorine dioxide, hydrogen peroxide, Accelerated Hydrogen Peroxide (AHP®), iodine, ozone, acidic electrolyzed water, peracetic acid, lactic acid, performic acid, potassium permanganate, potassium peroxymonosulfate), phenolics (e.g., phenol, o-phenylphenol, chloroxylenol, hexachlorophene, thymol), and quanternary ammonium compounds (quats). The compounds and compositions described herein are biocompatible (e.g., non-toxic) and/or biodegradable (e.g., eco-friendly), e.g., compared to existing standard sanitizing and/or disinfection procedures or techniques. Therefore, the compounds and composition described herein can be allowed to remain on the surface, e.g., until the sanitizing activity of the compound and composition described herein diminishes, or until next disinfection.

Exemplary surfaces include inert and/or non-animal surfaces, e.g., synthetic or semi-synthetic surfaces, e.g. polymer surfaces. For example, the surface can be a cellulose surface, a ceramic surface, a plastic surface (e.g., Bakelite, polystyrene, polyvinyl chloride (PVC), poly(methyl methacrylate) (PMMA, also known as acrylic glass)), a metal surface, a glass surface, a wood surface, a rubber surface, a stone surface (e.g., granite, marble, nanocrystal stone, nanoquartz stone), or a hybrid thereof. In some embodiments, the surface is a non-porous surface. In some embodiments, the surfaces are present in a high traffic and/or high population density area such as a hospital or medical/dental facility, a nursing home, a laboratory, a pharmaceutical or medical device manufacturing facility, a school or preschool, a childcare center, a military facility, a prison, a restaurant, a kitchen, a food processing and/or handling facility, a bathroom or toilet facility, a gym or fitness center, a barbershop or beauty salon, a library, a museum, a public transportation (e.g., a plane, train or bus), an airport, a train or bus station, a hotel, a steam room, a spa, or a paper mill.

In some embodiments, the surfaces are present on a medical or dental device or a portion thereof (such as a tube), e.g., that can be attached to a subject (e.g., a patient). Exemplary medical or dental devices include ventilators, aspirators, transfusion units, electrosurgical units, fetal monitors, heart-lung machines, incubators, infusion pumps, invasive blood pressure units, pulse oximeters, radiation-therapy machines, stents, ultrasound sensors, endoscopes, implantable RFID chips, surgical drills and saws, laparoscopic insufflators, electronic thermometers, breast pumps, surgical microscopes, ultrasonic nebulizers, sphygmomanometers, surgical tables, mouth mirrors, dental probes, dental retractors, dental drills, dental excavators, and dental scalers.

### Soluble Chitosans and Chitosan Derivatives

Methods, compounds and compositions for reducing bacteria already on a surface and preventing formation of biofilm on a surface (e.g., an inert and/or non-animal surface, e.g., a synthetic or semi-synthetic surface (e.g., cellulose, ceramic, plastic, metal, glass, wood, or stone), in e.g., hospital, food processing or handling facility, nursing home, school, military facility, prison, kitchen, or restaurant; or a food or food product surface) are described herein. The compounds and compositions described herein are, biocompatible (e.g., non-toxic) and/or biodegradable (e.g., eco-friendly), compared to existing standard operating procedures (e.g., sanitizing and/or disinfection procedures and/or techniques), for example, in an institutional setting.

Chitosan is an insoluble polymer derived from chitin, which is a polymer of N-acetylglucosamine that is the main component of the exoskeletons of crustaceans (e.g. shrimp, crab, lobster). Chitosan is formed from chitin by deacetylation, and as such is not a single polymeric molecule, but a class of molecules having various molecular weights and various degrees of deacetylation. The percent deacetylation in commercial chitosans is typically between 50-100%. The chitosan derivatives described herein are generated by functionalizing the resulting free amino groups with positively charged or neutral moieties, as described herein. The degrees of deacetylation and functionalization impart a specific charge density to the functionalized chitosan derivative. The resulting charge density affects solubility, and the strength of interaction with cell membranes. The molecular weight is also an important factor in the tenacity of cell membrane interaction and thus drug delivery capacity. Thus, in accordance with the present invention, the degree of deacetylation, the functionalization and the molecular weight must be optimized for optimal efficacy. The derivatized chitosans described herein have a number of properties which are advantageous including solubility at physiologic pH and drug delivery capacity when in solution at pH less than about 9.

A soluble chitosan as described herein, refers to a water soluble chitosan that is not derivatized on the hydroxyl or amine moieties. A soluble chitosan is comprised of glucosamine and acetylglucosamine monomers. Generally a water soluble chitosan has a molecular weight of less than or equal to about 10 kDa and a degree of deactylation equal or greater than 80%. The soluble chitosans described herein are soluble at neutral and physiological pH. Water soluble is defined as being fully dissolvable in water at pH 7.

The chitosan derivatives described herein are generated by functionalizing the resulting free amino groups with positively charged or neutral moieties, as described herein.

Chitosans with any degree of deacetylation (DDA) greater than 50% are used in the present invention, with functionalization between 2% and 50% of the available amines. The degree of deacetylation determines the relative content of free amino groups to total monomers in the chitosan polymer. Methods that can be used for determination of the degree of deacetylation of chitosan include, e.g, ninhydrin test, linear potentiometric titration, near-infrared spectroscopy, nuclear magnetic resonance spectroscopy, hydrogen bromide titrimetry, infrared spectroscopy, and first derivative UV-spectrophotometry. Preferably, the degree of deacetylation of a soluble chitosan or a derivatized chitosan described herein is determined by quantitative infrared spectroscopy. Percent functionalization is determined as the % of derivatized amines relative to the total number of available amino moieties prior to reaction on the chitosan polymer. Preferably, the percent functionalization of a derivatized chitosan described herein is determined by H-NMR or quantitative elemental analysis. The degrees of deacetylation and functionalization impart a specific charge density to the functionalized chitosan derivative. The resulting charge density affects solubility, and strength of interaction with cell membranes. The molecular weight is also an important factor in the tenacity of cell membrane interaction and thus drug delivery capacity. Thus, in accordance with the present invention, these properties must be optimized for optimal efficacy. Exemplary chitosan derivatives are described in Baker et al; Ser. No. 11/657,382 filed on Jan. 24, 2007, which is incorporated herein by reference.

The chitosan derivatives described herein have a range of polydispersity index (PDI) between about 1.0 to about 2.5. As used herein, the polydispersity index (PDI), is a measure of the distribution of molecular weights in a given polymer sample. The PDI calculated is the weight averaged molecular weight divided by the number averaged molecular weight. This calculation indicates the distribution of individual molecular weights in a batch of polymers. The PDI has a value always greater than 1, but as the polymer chains approach uniform chain length, the PDI approaches unity (1). The PDI of a polymer derived from a natural source depends on the natural source (e.g. chitin or chitosan from crab vs. shrimp vs. fungi) and can be affected by a variety of reaction, production, processing, handling, storage and purifying conditions. Methods to determine the polydispersity include, e.g., gel permeation chromatography (also known as size exclusion chromatography); light scattering measurements; and direct calculation from MALDI or from electrospray mass spectrometry. Preferably, the PDI of a soluble chitosan or a derivatized chitosan described herein is determined by HPLC or SEC and multi angle light scattering methods.

The chitosan derivatives described herein have a variety of selected molecular weights that are soluble at neutral and physiological pH, and include for the purposes of this invention molecular weights ranging from 5-1,000 kDa. Embodiments described herein are feature medium range molecular weight of derivatized chitosans (25 kDa, e.g., from about 15 to about 300 kDa) which can have drug delivery properties.

The functionalized chitosan derivatives described herein include the following:

(A) Chitosan-arginine compounds;

(B) Chitosan-natural amino acid derivative compounds;

(C) Chitosan-unnatural amino acid compounds;

(D) Chitosan-acid amine compounds;

(E) Chitosan-guanidine compounds; and

(F) Neutral chitosan derivative compounds.

(A) Chitosan-Arginine Compounds

In some embodiments, the present invention is directed to chitosan-arginine compounds, where the arginine is bound through a peptide (amide) bond via its carbonyl to the primary amine on the glucosamines of chitosan:

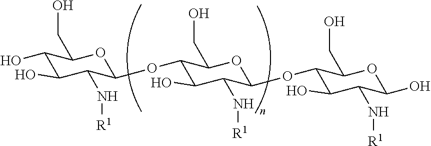

wherein each R¹ is independently selected from hydrogen, acetyl, and a group of the following formula:

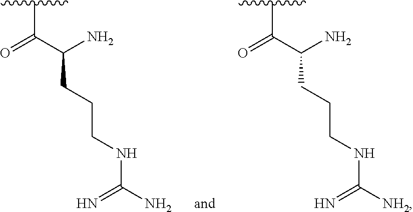 [SMILES: *C(=O)[C@@H](N)CCCNC(=N)N ; "and" ; *C(=O)[C@H](N)CCCNC(=N)N]

or a racemic mixture thereof,

wherein at least 25% of R¹ substituents are H, at least 1% are acetyl, and at least 2% are a group of the formula shown above.

(B) Chitosan-Natural Amino Acid Derivative Compounds

In some embodiments, the present invention is directed to chitosan-natural amino acid derivative compounds, wherein the natural amino acid may be histidine or lysine. The amino is bound through a peptide (amide) bond via its carbonyl to the primary amine on the glucosamines of chitosan:

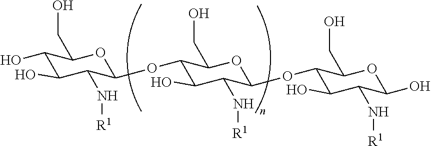

wherein each R¹ is independently selected from hydrogen, acetyl, and a group of the following formula:

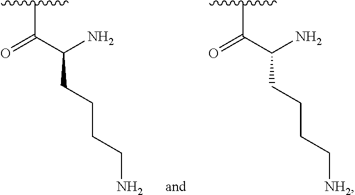 [SMILES: *C(=O)[C@@H](N)CCCCN ; "and" ; *C(=O)[C@H](N)CCCCN]

or a racemic mixture thereof, wherein at least 25% of R¹ substituents are H, at least 1% are acetyl, and at least 2% are a group of the formula shown above; OR a group of the following formula:

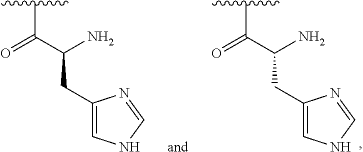 [SMILES: *C(=O)[C@@H](N)Cc1c[nH]cn1 ; "and" ; *C(=O)[C@H](N)Cc1c[nH]cn1 ; ","]

or a racemic mixture thereof, wherein at least 25% of R¹ substituents are H, at least 1% are acetyl, and at least 2% are a group of the formula shown above.

(C) Chitosan-Unnatural Amino Acid Compounds

In some embodiments, the present invention is directed to chitosan-unnatural amino acid compounds, where the unnatural amino acid is bound through a peptide (amide) bond via its carbonyl to the primary amine on the glucosamines of chitosan:

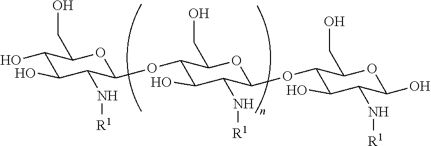

wherein each R¹ is independently selected from hydrogen, acetyl, and a group of the following formula:

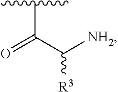

wherein R³ is an unnatural amino acid side chain, and wherein at least 25% of R¹ substituents are H, at least 1% are acetyl, and at least 2% are a group of the formula shown above.

Unnatural amino acids are those with side chains not normally found in biological systems, such as ornithine (2,5-diaminopentanoic acid). Any unnatural amino acid may be used in accordance with the invention. In some embodiments, the unnatural amino acids coupled to chitosan have the following formulae:

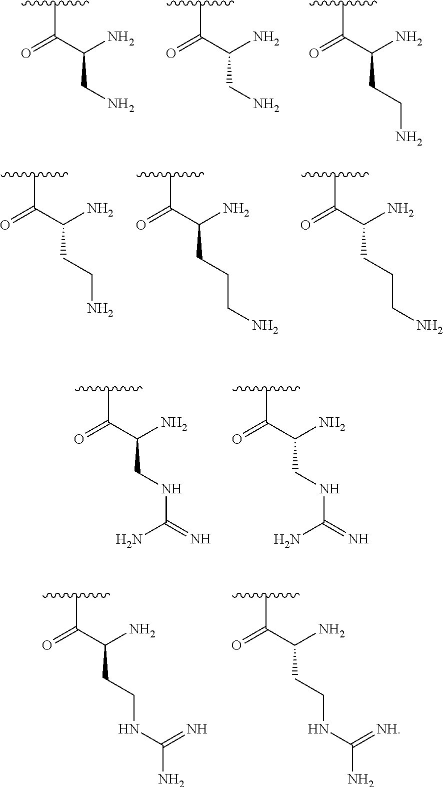

(D) Chitosan-Acid Amine Compounds

In some embodiments, the present invention is directed to chitosan-acid amine compounds, or their guanidylated counterparts. The acid amine is bound through a peptide (amide) bond via its carbonyl to the primary amine on the glucosamines of chitosan:

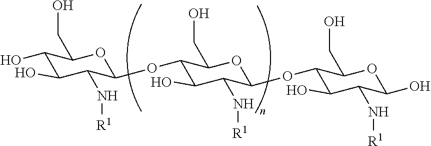

wherein each R¹ is independently selected from hydrogen, acetyl, and a group of the following formula:

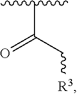

wherein R³ is selected from amino, guanidino, and C₁-C₆ alkyl substituted with an amino or a guanidino group, wherein at least 25% of R¹ substituents are H, at least 1% are acetyl, and at least 2% are a group of the formula shown above

In some embodiments, R¹ is selected from one of the following:

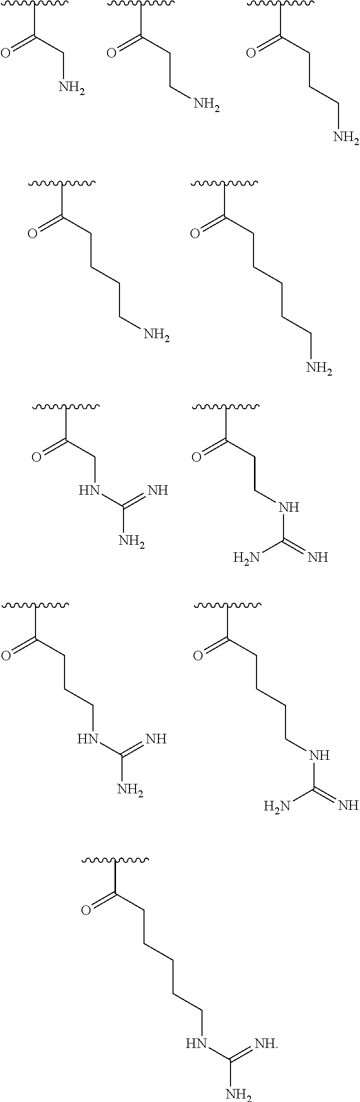

(E) Chitosan-Guanidine Compounds

In some embodiments, the present invention is directed to chitosan-guanidine compounds.

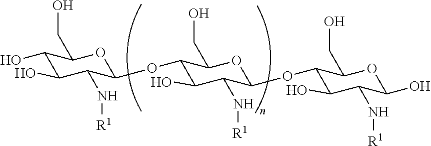

wherein each R¹ is independently selected from hydrogen, acetyl, and a group in which R¹, together with the nitrogen to which it is attached, forms a guanidine moiety; wherein at least 25% of R¹ substituents are H, at least 1% are acetyl, and at least 2% form a guanidine moiety together with the nitrogen to which it is attached.

(F) Neutral Chitosan Derivative Compounds

In some embodiments, the present invention is directed to neutral chitosan derivative compounds. Exemplary neutral chitosan derivative compounds include those where one or more amine nitrogens of the chitosan has been covalently attached to a neutral moiety such as a sugar:

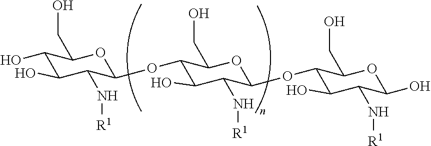

wherein each R¹ is independently selected from hydrogen, acetyl, and a sugar (e.g., a naturally occurring or modified sugar) or an α-hydroxy acid. Sugars can be monosaccharides, disaccharides or polysaccharides such as glucose, mannose, lactose, maltose, cellubiose, sucrose, amylose, glycogen, cellulose, gluconate, or pyruvate. Sugars can be covalently attached via a spacer or via the carboxylic acid, ketone or aldehyde group of the terminal sugar. Examples of α-hydroxy acids include glycolic acid, lactic acid, and citric acid. In some preferred embodiments, the neutral chitosan derivative is chitosan-lactobionic acid compound or chitosan-glycolic acid compound. Exemplary salts and coderivatives include those known in the art, for example, those described in US 2007/0281904, the contents of which is incorporated by reference in its entirety.

### Formulations

The compounds described herein can be formulated in a variety of manners including liquid composition, e.g., aqueous solution (e.g., surface spray), or dry powder composition, e.g., that is dispersible or dissolvable in an aqueous solution. In general, the compounds are formulated in an aqueous or substantially aqueous solution. In some embodiments the composition includes one or more volatile solvents such as an alcohol (e.g., ethanol or isopropanol). In some embodiments, the material is prepared from a dried powder of the soluble chitosan or derivatized chitosan.

A chitosan, e.g., a soluble chitosan or derivatized chitosan described herein can be formulated in an amount that provides a uniform coating on a surface from about 0.1 to about 100 μg/cm², about 0.5 to about 100 μg/cm², about 1.0 to about 100 μg/cm², about 2.0 to about 100 μg/cm², about 5.0 to about 100 μg/cm², about 10 to about 100 μg/cm², about 20 to about 100 μg/cm², about 50 to about 100 μg/cm², about 75 to about 100 μg/cm², about 0.1 to about 75 μg/cm², about 0.1 to about 50 μg/cm², about 0.1 to about 20 μg/cm², about 0.1 to about 10 μg/cm², about 0.1 to about 5.0 μg/cm², about 0.1 to about 2.0 μg/cm², about 0.1 to about 1.0 μg/cm², or about 0.1 to about 0.5 μg/cm².

With a spray or evaporative solution, the soluble chitosan or derivatized chitosan can be formulated from about 10 to about 1000 ppm, about 20 to about 1000 ppm, about 50 to about 1000 ppm, about 100 to about 1000 ppm, about 200 to about 1000 ppm, about 500 to about 1000 ppm, about 750 to about 1000 ppm, about 10 to about 750 ppm, about 10 to about 500 ppm, about 10 to about 200 ppm, about 10 to about 100 ppm, about 10 to about 50 ppm, or about 10 to about 20 ppm.

With a spray or evaporative solution, the soluble chitosan or derivatized chitosan can be formulated from about 10 to about 1000 μg/mL, about 20 to about 1000 μg/mL, about 50 to about 1000 μg/mL, about 100 to about 1000 μg/mL, about 200 to about 1000 μg/mL, about 500 to about 1000 μg/mL, about 750 to about 1000 μg/mL, about 10 to about 750 μg/mL, about 10 to about 500 μg/mL, about 10 to about 200 μg/mL, about 10 to about 100 μg/mL, about 10 to about 50 μg/mL, or about 10 to about 20 μg/mL.

The high volatility alcohol-based or organic solvent, e.g., methanol, ethanol, propanol, isopropanol, acetone, esters, or ethers, can be added to the composition. The volatile organic component in the solvent is present in the composition in an amount of from about 10.0 vol % to about 75.0 vol %, about 20.0 to about 70.0 vol %, about 30.0 to about 60.0 vol %, about 40.0 to about 50.0 vol %. Preferred embodiments are ethanol at from about 30 to about 70 vol % or isopropanol from about 30 to about 70 vol %.

A buffer, e.g., sodium borate decahydrate and trisodium phosphate, can be present in the composition in an amount of from about 0.01 to about 10.0 wt per vol %, about 0.02 to about 5.0 wt per vol %, about 0.1 to about 1.0 wt per vol %, or about 0.2 to about 0.5 wt per vol %. The buffer should be present in a sufficient amount within this range so that the pH of the composition is from about 5.0 to about 9.0, about 5.5 to about 8.5, about 6.0 to about 8.0, or about 6.5 to about 7.5.

A water softener or chelating agent can also be present in the composition, which is effective to tie up any metal ions which may be present (e.g., Ca⁺⁺, Mg^{±±}). The chelating agent may be present an in amount from about 0.01 to about 1.0 wt per vol %, about 0.02 to about 0.5 wt per vol %, or about 0.05 to about 0.1 wt per vol %. Tetrasodium ethylenediamine tetraacetic acid (EDTA) and nitrilotriacetic acid (NTA) are examples of suitable chelating agents.

A mild abrasive cleansing agent may also be added to the composition, such as sodium metasilicate, cesium oxide, and alumina, which may be present in an amount about 0.01 to 10 wt per vol %, about 0.1 to 5 wt per vol %, about 0.2 to about 2.5 wt per vol %, or about 0.5 to about 1.5 wt per vol %.

A sanitizing agent may also be added to the composition, such as a quaternary ammonium compound (“quats”). Examples of these “quats” include benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride, and domiphen bromide.

A rapid disinfectant agent may also be added to the composition. In some embodiments, the active ingredients are not stored together, but are mixed immediately prior to disinfection or sanitization. Suitable disinfection agents include alcohols, oxidizing agents (e.g. chlorine, sodium hypochlorite, calcium hypochlorite, chloramine, chloramine-T, chlorine dioxide, hydrogen peroxide, iodine, acidic electrolyzed water, peracetic acid, performic acid, potassium permanganate, potassium peroxymonosulfate (e.g., Virkon)), biguanide polymers, sodium bicarbonate, and phenolics (e. g. phnol, chloroxylenol, hexachlorophene, thymol).

The composition described herein may further contain a fragrant or odorant which may be present in an amount about 0.1% to about 10%, about 0.2% to about 5.0%, about 0.5% to about 2.0%, or about 1.0% to about 1.5% by volume. The fragrant can be selected from among simple esters (i.e., acids containing 1 to 5 carbon atoms linked with alcohols containing 2 to 4 carbon atoms), such as ethyl butyrate and butyl acetate.

The remainder of the composition described herein includes, e.g., water, calculated on a volume percent basis.

The composition described herein can be diluted by mixing a concentrated solution with water in amounts ranging from a dilution of about 1:1, about 1:2, about 1:5, about 1:10, about 1:20, about 1:50, or about 1:100. The composition described herein can be prepared by preparation from a dry powder to prepare the suitable concentration.

A suitable quantity of the powder or liquid composition described herein can be added to a desired container. A wide variety of containers, e.g., squeeze bottles, flexible tubes, and finger actuated pump dispensers, can be used for enabling the liquid composition described herein to be dispensed. The container is closed by mounting a suitable dispensing valve or cap to the open portal of the container. If a spray product is desired, a spray product valve is employed. If a foam product is desired, a foam producing dispensing valve or cap is mounted to the container within which the liquid composition is retained.

In some embodiments, the dispensers comprise a movable, finger-operated dispensing head or cap mounted to a container in which the liquid composition of the present invention is retained. The movable, finger operated dispensing head/cap is constructed to draw the liquid composition from the container into the cap and force the composition through various screens while intermixing air therewith to produce a dispensed product. In some embodiments, the delivery dispenser comprises a soft pliable bottle in combination with a dispensing cap/head structure which allows the user to squeeze the soft pliable bottle to force the composition in the container to pass through the cap and deliver the desired foam mousse product. In some embodiments, the delivery dispenser comprises a hand pump spray mechanism. In some embodiments, the delivery mechanism is a mechanical fogger with variable coverage (e. g. a region of a room, an entire room, a wall, a multiple of walls, a ceiling, a floor, items in the room or a combination thereof)

### Combination Usage

Compositions and compounds described herein, e.g. liquid compositions (e.g., aqueous solutions) and dry powder compositions, can be used with one or more other agents (e.g., a disinfectant or sanitizer) to treat a surface (e.g., an inert and/or non-animal surface, e.g., a synthetic or semi-synthetic surface (e.g., cellulose, plastic, metal, glass, wood or stone), in e.g., a hospital, nursing home, school, military facility, prison, or restaurant; or a food or food product surface), e.g., to provide a bacteria killing activity, e.g., a bacteria killing activity described herein, to reduce bacterial biofilms, or to prevent or inhibit (e.g., slow) the formation of a biofilm. In some embodiments, the combination usage of the agents is spaced sufficiently close together such that a synergistic effect is achieved.

Exemplary disinfectants and sanitizers that can be used in combination with the composition and compound described herein include, but not limited to, alcohols (e.g., ethanol or isopropanol), aldehydes (e.g., Glutaraldehyde or ortho-phthalaldehyde), oxidizing agents (chlorine, sodium hypochlorite, calcium hypochlorite, chloramine, chloramine-T, chlorine dioxide, hydrogen peroxide, iodine, acidic electrolyzed water, peracetic acid, performic acid, potassium permanganate, potassium peroxymonosulfate (e.g., Virkon)), phenolics (e.g., phenol, O-phenylphenol, chloroxylenol (e.g., Dettol), hexachlorophene, thymol), Quaternary ammonium compounds (Quats) (e.g., benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride, and domiphen bromide), polyaminopropyl biguanide, or sodium bicarbonate.

Exemplary food preservatives that can be used in combination with the compounds and compositions described herein include, but not limited to, antimicrobial (e.g., calcium propionate, sodium nitrate, sodium nitrite, sulfites (e.g., sulfur dioxide, sodium bisulfite, potassium hydrogen sulfite), and disodium EDTA), and antioxidant (e.g., BHA, BHT).

### Kits

A compound described herein (e.g., a soluble chitosan or a derivatized chitosan) can be provided in a kit. The kit includes (a) a composition that includes a compound described herein, and, optionally (b) informational material. The informational material can be descriptive, instructional, marketing or other material that relates to the methods described herein and/or the use of the compound described herein for the methods described herein.

The informational material of the kits is not limited in its form. In some embodiments, the informational material can include information about production of the compound, molecular weight of the compound, concentration, date of expiration, batch or production site information, and so forth. In some embodiments, the information material relates to the use of the compound described herein to provide a sanitizing effect on a bacterial bioburden on a surface described herein. In some embodiments, the information material relates to the use of the compound described herein to reduce (e.g., disrupt) bacterial biofilms on a surface described herein. In some embodiments, the informational material relates to use of the compound described herein to prevent or inhibit (e.g., slow) the formation of biofilm on a surface described herein.

The informational material of the kits is not limited in its form. In many cases, the informational material, e.g., instructions, is provided in printed matter, e.g., a printed text, drawing, and/or photograph, e.g., a label or printed sheet. However, the informational material can also be provided in other formats, such as computer readable material, video recording, or audio recording. In another embodiment, the informational material of the kit is contact information, e.g., a physical address, email address, website, or telephone number, where a user of the kit can obtain substantive information about a compound described herein and/or its use in the methods described herein. Of course, the informational material can also be provided in any combination of formats.

In addition to a compound described herein, the composition of the kit can include other ingredients, such as a solvent or buffer, a stabilizer, a preservative, and/or a second compound for reducing bacteria, reducing (e.g., disrupting) bacterial biofilm, or preventing or inhibiting (e.g., slowing) the formation of biofilm on a surface described herein. Alternatively, the other ingredients can be included in the kit, but in different compositions or containers than the compound described herein. In such embodiments, the kit can include instructions for admixing the compound described herein and the other ingredients, or for using a compound described herein together with the other ingredients.

The compound described herein can be provided in liquid form. The liquid solution preferably is an aqueous solution, with a sterile aqueous solution being preferred. The compound described herein can also be provided in dry powder, e.g., that is dispersible or dissolvable, e.g., in an aqueous solution. It is preferred that the compound described herein be substantially pure and/or sterile.

The kit can include one or more containers for the composition containing the compound described herein. In some embodiments, the kit contains separate containers, dividers or compartments for the composition and informational material. For example, the composition can be contained in a bottle (e.g., a spray bottle that can squirt, spray or mist fluids) or a can, and the informational material can be contained in a plastic sleeve or packet. In other embodiments, the separate elements of the kit are contained within a single, undivided container. For example, the composition is contained in a bottle that has attached thereto the informational material in the form of a label.

The kit can include a device suitable for dispensing, e.g., spraying, the composition, on a surface. In a preferred embodiment, the device is a liquid holding container being closed by a liquid or foam dispensing valve or cap, such that when a consumer activates the valve or cap, generating the desired spray for application to a surface. In some embodiments, the device suitable for dispensing the composition described herein can use a positive displacement pump that acts directly on the fluid. The pump can draw liquid up a siphon tube from the bottom of the liquid holding container, and the liquid is forced out a nozzle. The nozzle may or may not be adjustable, so as to select between squirting a stream, aerosolizing a mist, or dispensing a spray on the surface described herein.

### Bioburden

Compositions and compounds described herein, e.g. liquid compositions (e.g., aqueous solutions) or dry powder compositions, can be used to treat a surface (e.g., an inert and/or non-animal surface, e.g., a synthetic or semi-synthetic surface (e.g., cellulose, ceramic, plastic, metal, glass, wood or stone), in e.g., a hospital, school, nursing home, military facility, prison or restaurant; or a food or food product surface), e.g., to reduce bioburden on the surface.

Bioburden or microbial limit testing can be performed on pharmaceutical products and medical products as a quality control measure. Products or components used in the pharmaceutical or medical field require control of microbial levels during processing and handling. Bioburden or microbial limit testing on these products can prove that the requirements are met.

Bioburden can be defined as the number of microorganisms with which an object is contaminated. This unit is measured in CFU (colony forming units) per gram of product. In industry the number of measured CFU should not exceed an un-processed bulk action limit. These limits are required by the FDA and similar regulatory bodies to ensure the acceptability of a drug product. The drug is also required to be tested as a bulk drug substance (bds).

### Bacterial Pathogens

Compositions and compounds described herein are useful for reducing (e.g., killing) bacteria, reducing (e.g., disrupting) bacterial biofilm, or preventing or inhibiting (e.g., slowing) the formation of a biofilm on a surface (e.g., an inert and/or non-animal surface, e.g., synthetic or semi-synthetic surface (e.g., cellulose, ceramic, plastic, metal, glass, wood or stone), in e.g., a hospital, nursing home, school, military facility, prison, or restaurant; or a food or food product surface). Exemplary bacteria include bacteria that cause nosocomial or community based infection (e.g., MRSA, such as CA-MRSA and HA-MRSA), that are resistant to antibiotics (e.g., MRSA, such as CA-MRSA and HA-MRSA), and that cause food-borne illness.

Exemplary nosocomial pathogens include, e.g., commensal bacteria found in normal flora of healthy humans (e.g., cutaneous coagulase negative Staphylococci in intravascular line infection, and intestinal Escherichia coli in urinary infection), and pathogenic bacteria having greater virulence and causing infections (sporadic or epidemic) regardless of host status (e.g., Anaerobic Gram-positive rods (e.g. Clostridium), Gram-positive bacteria (e.g., Staphylococcus aureus, and beta-haemolytic Streptococci), Gram-negative bacteria (e.g., Enterobacteriacae (e.g. Escherichia coli, Proteus, Klebsiella, Enterobacter, Serratia marcescens), and Pseudomonas spp.), and other bacteria (e.g., Legionella species).

Exemplary pathogens that cause resistant bacterial infections include, e.g., Methicillin resistant Staphylococcus aureus, Fluoroquinolone resistant Staphylococcus aureus, Vancomycin intermediate resistant Staphylococcus aureus, Linezolid resistant Staphylococcus aureus, Penicillin resistant Streptococcus pneumoniae, Macrolide resistant Streptococcus pneumoniae, Fluorocμiinolone resistant Streptococcus pneumoniae. Vancomycin resistant Enterococcus faecalis, Linezolid resistant Enterococcus faecalis, Fluoroquinolone resistant Enterococcus faecalis, Vancomycin resistant Enterococcus faecium, Linezolid resistant Enterococcus faecium, Fluoroquinolone resistant Enterococcus faecium, Ampicillin resistant Enterococcus faecium, Macrolide resistant Haemophilus influenzae, β-lactam resistant Haemophilus influenzae, Fluoroquinolone resistant Haemophilus influenzae, β-lactam resistant Moraxella catarrhalis, Methicillin resistant Staphylococcus epidermidis, Methicillin resistant Staphylococcus epidermidis. Vancomycin resistant Staphylococcus epidermidis, Fluoroquinolone resistant Staphylococcus epidermidis, Macrolide resistant Mycoplasma pneumoniae, Isoniazid resistant Mycobacterium tuberculosis, Rifampin resistant Mycobacterium tuberculosis, Methicillin resistant Coagutase negative staphylcocci, Fluoroquinolone resistant Coagulase negative staphylcocci, Glycopeptide intermediate resistant Staphylococcus aureus, Vancomycin resistant Staphylococcus aureus, Hetero vancomycin intermediate resistant Staphylococcus aureus, Hetero vancomycin resistant Staphylococcus aureus, Macrolide-Lincosamide-Streptogramin resistant Staphylococcus, β-lactam resistant Enterococcus faecalis, β-lactam resistant Enterococcus faecium, Ketolide resistant Streptococcus pneumoniae, Ketolide resistant Streptococcus pyogenes, Macrolide resistant Streptococcus pyogenes, Vancomycin resistant Staphylococcus epidermidis, multidrug resistant Clostridium difficile, or multidrug resistant E. coli.

In an embodiment, the bacterial pathogens comprise Salmonella choleraesuis, Staphylococcus aureus, Klebsiella pneumoniae, Enterobacter aerogenes, Pseudomonas aeruginosa, MRSA, E. coli, vancomycin resistant Enterococcus faecalis, Acinetobacter baumannii, MDR Acinetobacter baumannii, or MDR Klebsiella pneumoniae.

Exemplary food-borne bacteria or bacteria associated with a food-borne illness or a symptom of a food-borne illness include, but not limited to, Campylobacter jejuni, Clostridium perfringens, Salmonella spp., Escherichia coli O157:H7 enterohemorrhagic (EHEC), Bacillus cereus, Escherichia coli, other virulence properties, such as enteroinvasive (EIEC), enteropathogenic (EPEC), enterotoxigenic (ETEC), enteroaggregative (EAEC or EAgEC), Listeria monocytogenes, Shigella spp., Staphylococcus aureus, Streptococcus, Vibrio cholerae, including O1 and non-O1, Vibrio parahaemolyticus, Vibrio vulnificus, Yersinia enterocolitica, Yersinia pseudotuberculosis, Brucella spp., Corynebacterium ulcerans, Coxiella burnetii or Q fever, Plesiomonas shigelloides, Clostridium botulinum, Aeromonas hydrophila, Aeromonas caviae, and Aeromonas sobria.

### Biofilm

Compositions and compounds described herein can be used to treat a surface (e.g., an inert and/or non-animal surface, e.g., a synthetic or semi-synthetic surface (e.g., cellulose, ceramic, plastic, metal, glass, wood or stone), in e.g., a hospital, food processing or handling facility, nursing home, school, military facility, nursing home, prison, kitchen, or restaurant; or a food or food product surface), e.g., to reduce (e.g., disrupt) bacterial biofilms, or to prevent or inhibit (e.g., slow) the formation of biofilm on the surface.

A biofilm is a structured community of microorganisms encapsulated within a self-developed polymeric matrix and adherent to a living or inert surface. Biofilms are also often characterized by surface attachment, structural heterogeneity, genetic diversity, complex community interactions, and an extracellular matrix of polymeric substances.

Formation of a biofilm begins with the attachment of free-floating microorganisms to a surface. These first colonists adhere to the surface initially through weak, reversible van der Waals forces. If the colonists are not immediately separated from the surface, they can anchor themselves more permanently using cell adhesion structures such as pili. The first colonists facilitate the arrival of other cells by providing more diverse adhesion sites and beginning to build the matrix that holds the biofilm together. Once colonization has begun, the biofilm grows through a combination of cell division and recruitment. The final stage of biofilm formation is known as development, and is the stage in which the biofilm is established and may only change in shape and size. This development of biofilm environment and communication pathway allows for the cells to become more antibiotic resistant.

Biofilms can contain many different types of microorganism, e.g. bacteria, archaea, protozoa, fungi and algae; each group performing specialized metabolic functions. Microorganisms can also form monospecies films.

The biofilm is held together and protected by a matrix of excreted polymeric compounds called Extracellular polymeric substance (EPS). This matrix protects the cells within it and facilitates communication among them through biochemical signals.

Bacteria living in a biofilm can have different properties from free-floating bacteria of the same species, as the dense and protected environment of the film allows them to cooperate and interact in various ways. One benefit of this environment is increased resistance to detergents and antibiotics, as the dense extracellular matrix and the outer layer of cells protect the interior of the community.

Exemplary bacteria associated with biofilm include Gram-positive (e.g., Staphylococcus aureus (e.g., strain MW-2), Streptococcus mutans, Clostridium perfringens, Streptococcus pyogenes (GAS), Clostridium difficile and Streptococcus sanguis) and Gram-negative bacteria (E. coli (e.g., strain 0:157 H:7), Shigella flexneri, Salmonella typhimurium, Acinetobacter baumannii, Pseudomonas aeruginosa and Legionella bacteria (e.g., L. pneumophila)). In some embodiments, the biofilm comprises two or more different bacterial populations.

In some embodiments, bacteria associated with biofilms can include antibiotic resistant bacteria such as Methicillin resistant Staphylococcus aureus, Mupirocin resistant Staphylococcus aureus, Mupirocin and Methicillin resistant Staphylococcus aureus, Fluoroquinolone resistant Staphylococcus aureus, Vancomycin intermediate resistant Staphylococcus aureus, Linezolid resistant Staphylococcus aureus, Penicillin resistant Streptococcus pneumoniae, Macrolide resistant Streptococcus pneumoniae, Fluoroquinolone resistant Streptococcus pneumoniae. Vancomycin resistant Enterococcus faecalis, Linezolid resistant Enterococcus faecalis, Fluoroquinolone resistant Enterococcus faecalis, Vancomycin resistant Enterococcus faecium, Linezolid resistant Enterococcus faecium. Fluoroquinolone resistant Enterococcus faecium, Ampicillin resistant Enterococcus faecium, Macrolide resistant Haemophilus influenzae, β-lactam resistant Haemophilus influenzae, Fluoroquinolone resistant Haemophilus influenzae, β-lactam resistant Moraxella catarrhalis, Methicillin resistant Staphylococcus epidermidis, Methicillin resistant Staphylococcus epidermidis, Vancomycin resistant Staphylococcus epidermidis, Fluoroquinolone resistant Staphylococcus epidermidis, Macrolide resistant Mycoplasma pneumoniae, Isoniazid resistant Mycobacterium tuberculosis, Rifampin resistant Mycobacterium tuberculosis, Methicillin resistant coagulase negative Staphylococci, Fluoroquinolone resistant coagulase negative Staphylococci, Glycopeptide intermediate resistant Staphylococcus aureus, Vancomycin resistant Staphylococcus aureus, Hetero vancomycin intermediate resistant Staphylococcus aureus, Hetero vancomycin resistant Staphylococcus aureus, Macrolide-Lincosamide-Streptogramin resistant Staphylococcus, β-lactam resistant Enterococcus faecalis, β-lactam resistant Enterococcus faecium, Ketolide resistant Streptococcus pneumoniae, Ketolide resistant Streptococcus pyogenes, Macrolide resistant Streptococcus pyogenes, Vancomycin resistant Staphylococcus epidermidis, multidrug resistant Clostridium difficile, multidrug resistant Acinetibacter baumannii, multidrug resistant Kelbsiella pneumoniae, or multidrug resistant Escherichia coli.

As used herein resistant microorganism or bacterium means, an organism which has become resistant to an antibacterial agent. Also, resistant microorganism or bacterium means its effective MIC has exceeded the effective dosage according to Clinical Laboratory Standards Institute (CLSI) resistance breaktpoints, predefined national or internationally accepted limits, at or above which administration of an effective dose of antibiotic produces undesirable side effects. In some embodiments, the minimum inhibitory concentration of an antibacterial agent for a resistant bacterium will be at least, 2, 5, 10, or 100 fold greater than that seen with a sensitive bacterium for a selected antibacterial agent.

In an embodiment, bacteria associated with biofilm can include, e.g., Salmonella choleraesuis, Staphylococcus aureus, Klebsiella pneumoniae, Enterobacter aerogenes, Pseudomonas aeruginosa, MRSA, E. coli, vancomycin resistant Enterococcus faecalis, Acinetobacter baumannii, MDR Acinetobacter baumannii, or MDR Klebsiella pneumoniae.

In an embodiment, bacteria associated with biofilm can include food-borne bacteria or bacteria associated with a food-borne illness or a symptom of a food-borne illness, e.g., Campylobacter jejuni, Clostridium perfringens, Salmonella spp., Escherichia coli O157:H7 enterohemorrhagic (EHEC), Bacillus cereus, Escherichia coli, other virulence properties, such as enteroinvasive (EIEC), enteropathogenic (EPEC), enterotoxigenic (ETEC), enteroaggregative (EAEC or EAgEC), Listeria monocytogenes, Shigella spp., Staphylococcus aureus, Streptococcus, Vibrio cholerae, including O1 and non-O1, Vibrio parahaemolyticus, Vibrio vulnificus, Yersinia enterocolitica, Yersinia pseudotuberculosis, Brucella spp., Corynebacterium ulcerans, Coxiella burnetii or Q fever, Plesiomonas shigelloides, Clostridium botulinum, Aeromonas hydrophila, Aeromonas caviae, and Aeromonas sobria.

Biofilms can be associated with a variety of diseases or conditions, e.g., urinary tract infections, catheter infections, middle-ear infections, formation of dental plaque, gingivitis, dental caries, halitosis, gastrointestinal tract infections, respiratory tract infections (e.g., lung infections and chronic sinusitis), complications of contact lenses, endocarditis, complications (e.g., infections) of cystic fibrosis, complications (e.g., infections) in immunocompromised patient, impairing cutaneous wound healing, skin and tissue infection, infections due to burns, reducing topical antibacterial efficacy in infected skin wounds, or infections of permanent indwelling devices such as joint prostheses, intrauterine devices or heart valves.

Exemplary bacteria associated with biofilm also include bacteria causing urinary tract infections, catheter infections, middle-ear infections, formation of dental plaque, gingivitis, dental caries, halitosis, gastrointestinal tract infections, respiratory tract infections (e.g., lung infections and chronic sinusitis), complications of contact lenses, endocarditis, complications (e.g., infections) of cystic fibrosis, complications (e.g., infections) in immunocompromised patient, impairing cutaneous wound healing, skin and tissue infection, infections due to burns, reducing topical antibacterial efficacy in infected skin wounds, or infections of permanent indwelling devices such as joint prostheses, intrauterine devices or heart valves.

In some embodiments, at least about 10%, 20%, 30%, 40%, 50%, 60%, 70%, 80%, 90%, 95%, or 99% of the bacterial population in the biofilm are in the stationary phase. In some embodiments, the biofilm is at least about 1, 2, 3, 4, 5, 6, or 7 days old.

### Food Processing, Preservation, and Packaging

Methods, compositions, and compounds described herein can be used in food processing. As used herein, food processing refers to one or more methods or techniques used to transform raw ingredients into food products or to transform food into other forms for consumption by humans or animals either in the home or by the food processing industry. Food processing typically takes clean, harvested crops or butchered animal products and uses these to produce marketable and often long shelf-life food products. Similar processes can be used to produce animal feed.

Methods, compositions, and compounds described herein can also be used in food preservation. As used herein, food preservation refers to one or more methods or processes of treating and/or handling food to stop or slow down spoilage (e.g., loss of quality, edibility or nutritional value), or to control bacterial contamination, and thus allow for longer storage and increased shelf life.

Food preservation typically involves preventing the growth of bacteria, yeasts, fungi, and other micro-organisms (although some methods work by introducing benign bacteria, or fungi to the food), as well as retarding the oxidation of fats which cause rancidity. Food preservation can also include processes which inhibit visual deterioration that can occur during food preparation; such as the enzymatic browning reaction in apples after they are cut.

Methods, compositions, and compounds described herein can be used before, during, or after one or more standard food processing and/or preservation methods, e.g., heating to kill or denature micro-organisms (e.g., boiling), oxidation (e.g., use of sulfur dioxide), ozonation (e.g., use of ozone or ozonated water to kill undesired microbes), toxic inhibition (e.g., smoking, use of carbon dioxide, vinegar, alcohol etc.), dehydration (drying), osmotic inhibition (e.g., use of syrups), low temperature inactivation (e.g., refrigeration, freezing), ultra high pressure (e.g., Fresherized®; intense water pressure kills microbes which cause food deterioration and affect food safety), vacuum packing, salting or curing, sugaring, artificial food additives (e.g., antimicrobial (e.g., calcium propionate, sodium nitrate, sodium nitrite, sulfites (e.g., sulfur dioxide, sodium bisulfite, potassium hydrogen sulfite), and disodium EDTA), antioxidant (e.g., BHA, BHT)), irradiation, pickling, lye, canning, bottling, jellying, potting, jugging, pulsed electric field processing, modifying atmosphere, or combinations of these methods.

Methods, compositions, and compounds described herein can be used in food packaging. As used herein, food packaging refers to packaging for food. The functions of food packaging include, e.g., physical protection (e.g., protection from shock, vibration, compression, temperature), barrier protection (e.g., a barrier from oxygen, water vapor, dust, bacteria), containment or agglomeration, information transmission, security (e.g., during shipment), and marketing. Food packaging types can include, e.g., aseptic processings, plastic trays, bags, boxes, cans, cartons, flexible packaging, pallets, and wrappers.

Methods, compositions, and compounds described herein can be used to treat a surface on a food packaging machine, e.g, to prevent or reduce bacterial growth or to prevent or reduce bacterial biofilm formation on the surface. Exemplary machines for food packaging include, lister, skin and vacuum packaging machines; capping, over-capping, lidding, closing, seaming and sealing machines; cartoning machines; case and tray forming, packing, unpacking, closing and sealing machines; check weighing machines; cleaning, sterilizing, cooling and drying machines; conveying, accumulating and related machines; feeding, orienting, placing and related machines; filling machines (handling liquid and powdered products); package filling and closing machines; form, fill and seal machines; inspecting, detecting and checkweighing machines; palletizing, depalletizing, pallet unitizing and related machines; product identification (e.g., labelling, marking); wrapping machines; converting machines; and other specialty machinery.

Methods, compounds, and compositions described herein can be used to process, preserve, and/or package various food or food products. Exemplary foods or food products include, but not limited to, foods or food products of animal source (e.g., meat (e.g., beef, pork, fish, poultry), dairy products (e.g., cheese, butter), egg, blood (e.g., in the form of blood sausage)), foods or food products of plant source (e.g., vegetable, fruit, grain), and edible fungi (e.g., mushroom).

### Food-Borne Bacteria and Illness

Methods, compositions, and compounds described herein can be used to prevent, delay, or reduce the growth of food-borne bacteria or bacteria associated with a food-borne illness or a symptom of a food-borne illness, on a food or food product surface. The compositions and compounds described herein can also reduce (e.g., disrupt) bacterial biofilm formation on a food or food product surface.

Food-borne illness typically arises from improper food handling, preparation, or storage. Symptoms of food-borne illnesses include, e.g., abdominal cramps, nausea, vomiting, diarrhea (sometimes bloody), fever, and dehydration. Compositions and compounds described herein can be used before, during, or after food preparation to reduce the chances of contracting an illness. Exemplary food-borne bacteria or bacteria associated with a food-borne illness or a symptom of a food-borne illness include, but not limited to, Campylobacter jejuni, Clostridium perfringens, Salmonella spp., Escherichia coli O157:H7 enterohemorrhagic (EHEC), Bacillus cereus, Escherichia coli, other virulence properties, such as enteroinvasive (EIEC), enteropathogenic (EPEC), enterotoxigenic (ETEC), enteroaggregative (EAEC or EAgEC), Listeria monocytogenes, Shigella spp., Staphylococcus aureus, Streptococcus, Vibrio cholerae, including O1 and non-O1, Vibrio parahaemolyticus, Vibrio vulnificus, Yersinia enterocolitica, Yersinia pseudotuberculosis, Brucella spp., Corynebacterium ulcerans, Coxiella burnetii or Q fever, Plesiomonas shigelloides, Clostridium botulinum, Aeromonas hydrophila, Aeromonas caviae, and Aeromonas sobria.

### EXAMPLES

### Example 1

### Sanitizing Activity of Chitosan-Arginine

Sanitization was performed for plastic and metal surfaces with chitosan-arginine in a 70% isopropanol solution. Contamination was initiated by resuspending broth cultures of MRSA, vancomycin-resistant E. faecalis (VRE), MDR-A. baumannii, or MDR-K. pneumoniae in PBS to approximately 10⁷ CFU/ml and depositing 20 μl of the solution on the bottom of a flat plastic, non-tissue culture treated 12-well plate. The chitosan derivative was delivered in a 70% isopropanol solution at a concentration between 38-300 μg/ml. The solution was sprayed (≈10 μl) on the contaminated surface and allowed to dry for approximately 30 minutes. Media was added to the wells where the sanitization occurred to enumerate the number of surviving cells via dilutions and plating for CFU. Controls consisted of untreated bacteria and 70% isopropanol solutions. In all cases contamination treated with 70% isopropanol only (vehicle solution) was less effective than the chitosan derivative formulation.

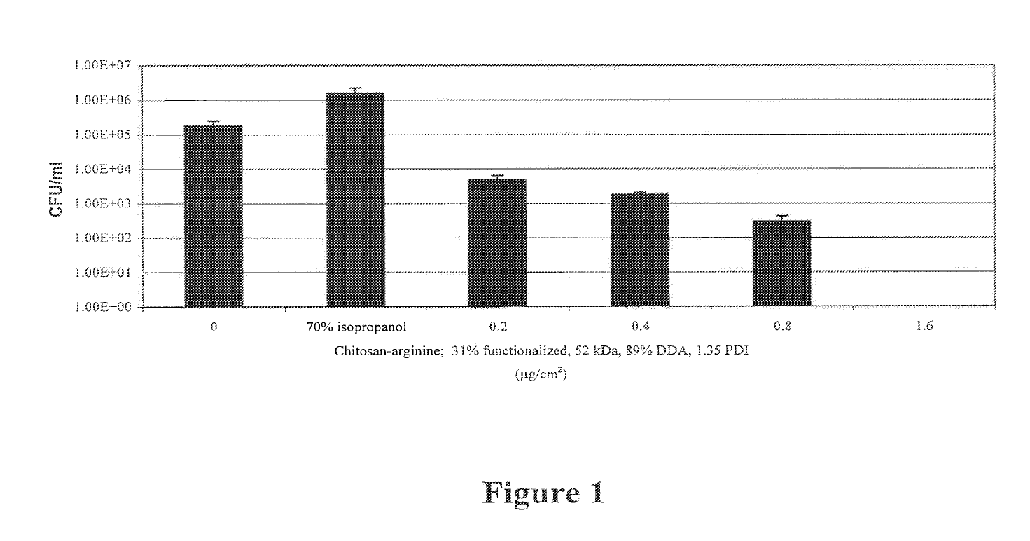

Table 1 shows the amount of chitosan-arginine needed to achieve 99.9% reduction of various bacteria on plastic surface. A dose response for sanitization on a plastic surface is shown in FIG. 1. Doses of chitosan-argnine (31% functionalization, 52 kDa, 89% DDA, 1.35 PDI) were sprayed on surfaces contaminated with MRSA strain MW-2 (ATCC BAA-1707, a wound isolate) and allowed to dry for 30 minutes. The enumerated surviving cells by dose indicate sterilization at 1.6 μg/cm² of chitosan-arginine, indicating high sensitivity of MRSA to chitosan-arginine surface spray.

TABLE 1

| | 99.9% Reduction on Plastic |
|---|---|
| Strain | Chitosan-arginine (μg/cm²) |
| MRSA | 0.6 |
| VRE | 0.6 |
| MDR-A. baumannii | 0.6 |
| MDR-K. pneumoniae | 1.5 |

Table 2 shows the amount of chitosan-arginine needed to achieve 99.9% reduction of various bacteria on metal surface.

TABLE 2

| | 99.9% Reduction on Metal |
|---|---|
| Strain | Chitosan-arginine (μg/cm²) |
| MRSA | 1 |
| VRE | 0.25 |
| MDR-A. baumannii | 0.25 |
| MDR-K. pneumoniae | 0.25 |

In another experiment, Staphylococcus aureus ATCC 6538, Pseudomonas aeruginosa ATCC 15447, and P. aeruginosa strain PA01 ATCC BAA-47 were tested. 10 test carriers were inoculated at concentrations ranging from 2 to 7×10⁵ cfu and dried for 40 minutes. Chitosan-arginine in 70% isopropanol disinfectant was sprayed to coat the contaminated carriers then left in petri dishes for 18 hours (single exposure duration). Each set of carriers was transferred in staggered intervals for vortexing. Remaining bacteria were quantified by standard dilution methods. All organisms were reduced by >99.9% for all test samples.

### Example 2

### Prophylactic Activity of Chitosan-Arginine

### Example 2.1

### Dose Response of MRSA, Acinetobacter baumannii, and Vancomycin-Resistant E. faecalis Killing with Surface Dried Chitosan-Arginine

MRSA strains MW-2 and MNDON, Acinetobacter baumannii, and vancomycin-resistant E. faecalis (VRE) were exposed to chitosan-arginine that had been dried onto the surface of polystyrene plates (24 hours) in dose response and exposure time dependent assays. A volume of 200 μL of the working concentration of each material was placed on 12-well plates. Chitosan-arginine was in a solution of 90% ethanol in water. Following the drying of the material on the plates, 200 μL containing approximately 10⁶ MRSA strains MW-2 and MNDON, A. baumannii, or vancomycin-resistant E. faecalis was placed in each of the wells resulting in a thin layer of liquid on the bottom of the well. Chitosan-arginine (31% functionalization, 52 kDa, 89% DDA, 1.35 PDI) exposure occurred for 1, 4 and 24 hours after which the contents of the wells were scraped into vials. The surviving bacteria were resuspended in water, diluted, and plated for determination of CFU. The 95% ethanol treated wells did not show a significant difference from the bacteria recovered from the positive controls (bacteria only). The results are summarized in Table 3 in units describing the absolute amount of material per 1000 cells needed to cause a 99.9% reduction, based on the total amount of material dried in the well.

TABLE 3

| | | 99.9% reduction | | |
|---|---|---|---|---|
| | Material | (C/A μg/1000 bacteria) | | |
| Organism | (Dry) | 1 Hour | 4 Hours | 24 Hours |
| A. baumannii | chitosan- | <5.45 × 10⁻⁴ | <5.45 × 10⁻⁴ | <5.45 × 10⁻⁴ |
| | arginine | | | |
| MRSA MW-2 | chitosan- | 4.14 | 0.13 | 1.09 × 10⁻³ |
| | arginine | | | |
| MRSA MNDON | chitosan- | 0.36 | 0.18 | 0.18 |
| | arginine | | | |
| VRE | chitosan- | 1.48 | 0.74 | 0.05 |
| | arginine | | | |

### Example 2.2

### Prophylactic Activity of Chitosan-Arginine after 24 Hours and 7 Days

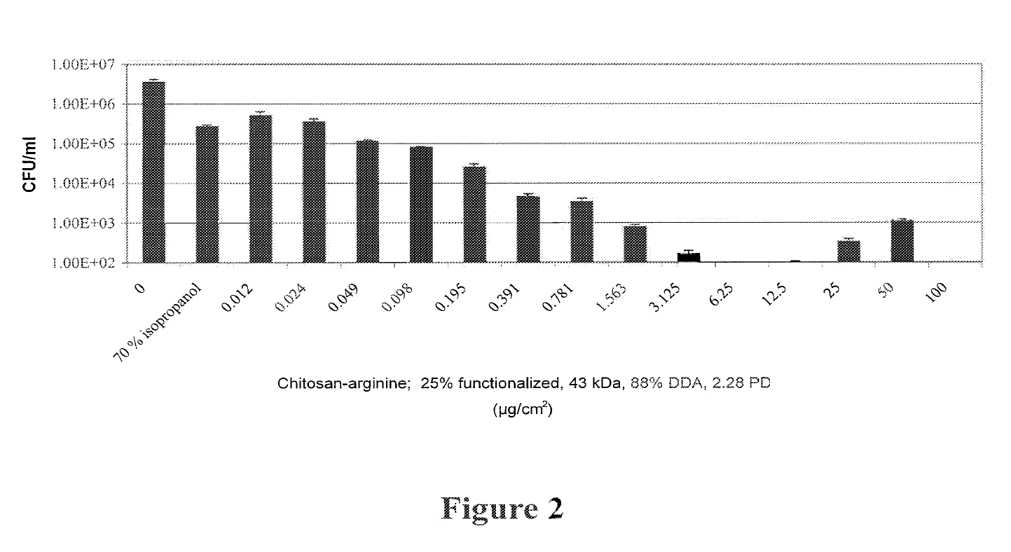

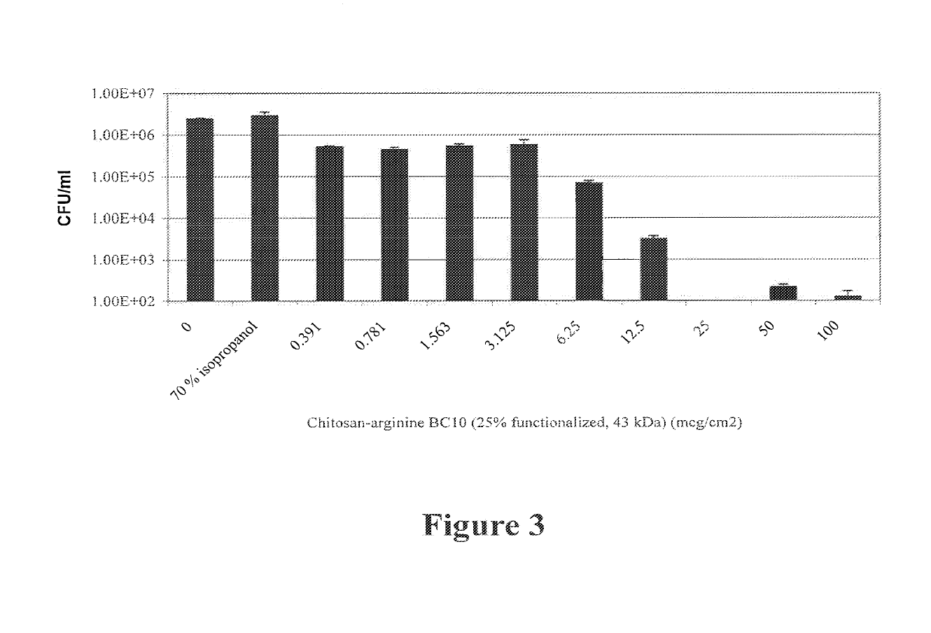

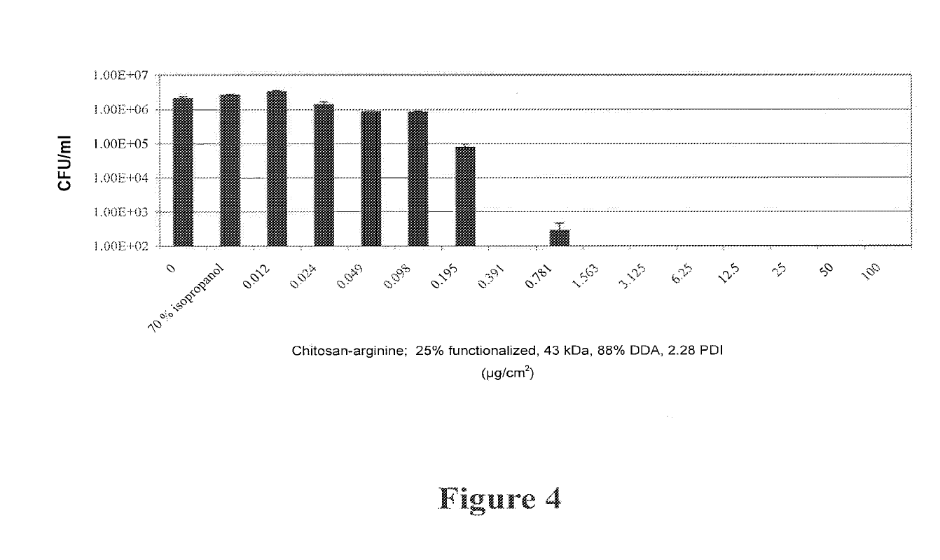

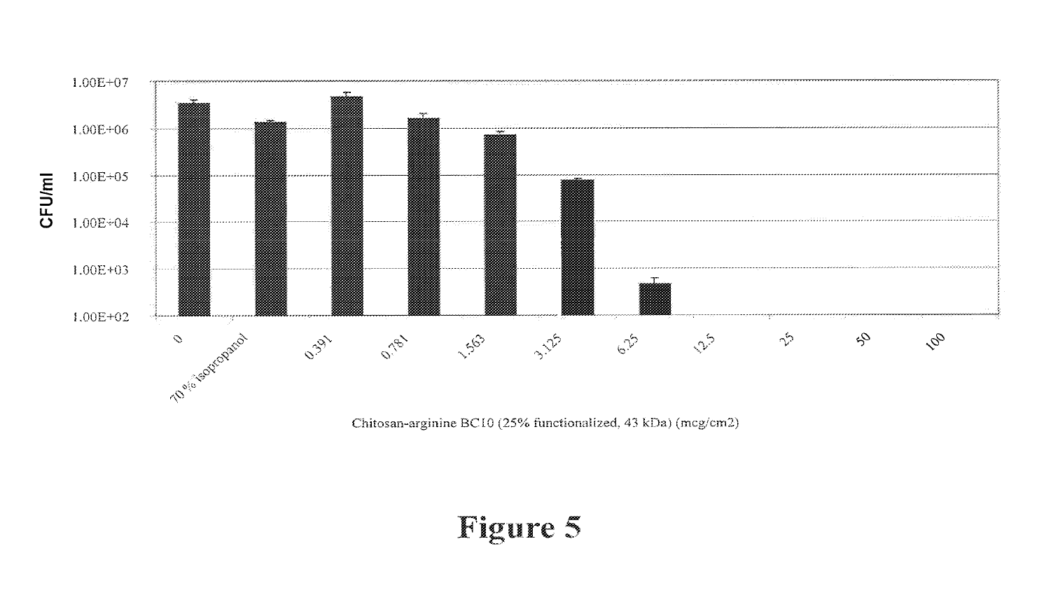

The ability of residual chitosan-arginine to maintain antibacterial activity on a surface was tested. Increasing concentrations (0.0125-100 μg/cm²) of chitosan-arginine in 70% isopropanol solution were applied to the surfaces of 24 well polystyrene plates in triplicate and dried at room temperature of 24 hours or 1 week. Following the drying of the material on the plates, 200 μL containing approximately 10⁶ MRSA was placed in each of the wells resulting in a thin layer of liquid on the bottom of the well. Bacteria were exposed to the treated surface for 1-hour after which the contents of the wells were scraped and placed in to 96-well plates. Excess chitosan-arginine was removed by centrifugation. The surviving bacteria were resuspended in water, diluted, and plated for the determination of CFU. FIG. 2 shows the susceptibility of Acinetobacter baumannii to chitosan-arginine in one hour following 24 hours prophylactic treatment of the surface. This indicates as little as 3.125 μg/cm² of chitosan-arginine is required to be considered bactericidal (4-log reduction in CFU). FIG. 3 shows the susceptibility of Acinetobacter baumannii to chitosan-arginine in one hour a week after prophylactic treatment of the surface was completed. This indicates 25 μg/cm² of chitosan-arginine was bactericidal (4-log reduction in CFU) after one week. FIG. 4 shows the susceptibility of MRSA strain MW-2 to chitosan-arginine in one hour following 24 hours prophylactic treatment of the surface. This indicates as little as 0.391 μg/cm² of chitosan-arginine is required to be considered bactericidal (4-log reduction in CFU). FIG. 5 shows the susceptibility of MRSA strain MW-2 to chitosan-arginine in one hour a week after prophylactic treatment of the surface was completed. This indicates 6.25 μg/cm² of chitosan-arginine was bactericidal (4-log reduction in CFU) after one week.

### Example 2.3

### Prophylactic Activity of Chitosan-Arginine after 1 Month

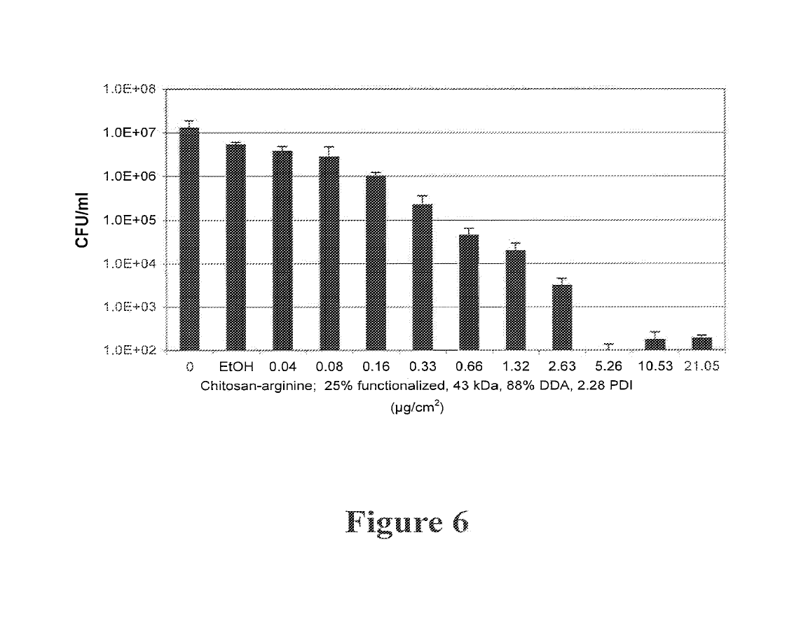

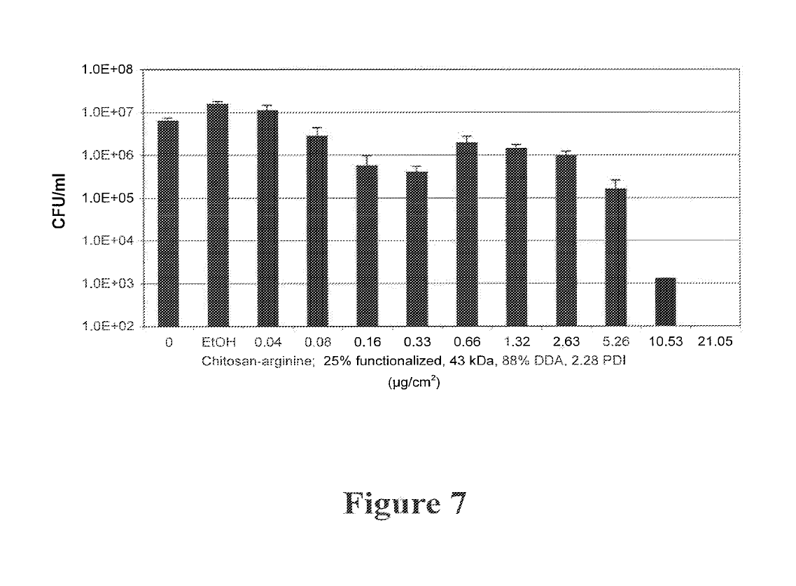

To quantify the longer term, prophylactic activity of the decontaminant, sterile surfaces of plastic (24 well format with 2 cm² surface area) were coated with 0.04-21 μg/cm² chitosan-arginine (31% functionalization, 52 kDa, 89% DDA, 1.35 PDI) in 70% isopropanol. The treated surfaces were exposed to the environment for 1 month. Then approximately 10⁶ bacteria were applied to the treated surface and the number of surviving bacteria after 1 hour exposure was quantified via cfu. Chitosan-arginine dried on a plastic surface is demonstrated to maintain antimicrobial activity against Gram-negative and Gram-positive bacteria for up to 1 month. A 99.9% reduction of Acinetobacter baumanii and MRSA with 2.63 and 10.53 μg/cm² chitosan-arginine on the surface for 1 month was observed, respectively. Dose responses of Acinetobacter baumanii and MRSA prophylactic killing with surface dried after 1 month are shown in FIGS. 6 and 7, respectively.

In summary, residual self-sanitizing activity of chitosan-arginine persists after 24 hours up to at least 1 month. The antimicrobial activity against Gram-negative and Gram-positive bacteria is 99.9% effective after 1 hour exposure to less than 11 μg/cm².

### Example 2.4

### The Ability of Chitosan-Arginine to Maintain Antimicrobial Activity on Surfaces Up to 4 Weeks

Staphylococcus aureus strain MW-2 ATCC BAA-1707 (MRSA) and A. baumannii ATCC 19606) were tested. Plastic surfaces (12 well format with 3.8 cm² surface area) were sterilized and coated with chitosan-arginine at varying concentrations. Treated surfaces were exposed to the environment for 4 weeks. Surfaces were exposed to approximately 1×10⁶ bacteria in water for 1 hour. The number of surviving bacteria was quantified. Residual levels of A. baumannii and MRSA were reduced by >99.99% upon exposure to >5 μg/cm² and >10 μg/cm² of chitosan-arginine, respectively. The test demonstrates the ability of chitosan-arginine, when applied to solid surfaces, to maintain antimicrobial activity against Gram-negative and Gram-positive bacteria for up to 4 weeks when higher treatment concentrations are utilized.

### Example 3

### Residual Antibacterial Activity of Chitosan Derivatives Coated on Tubes

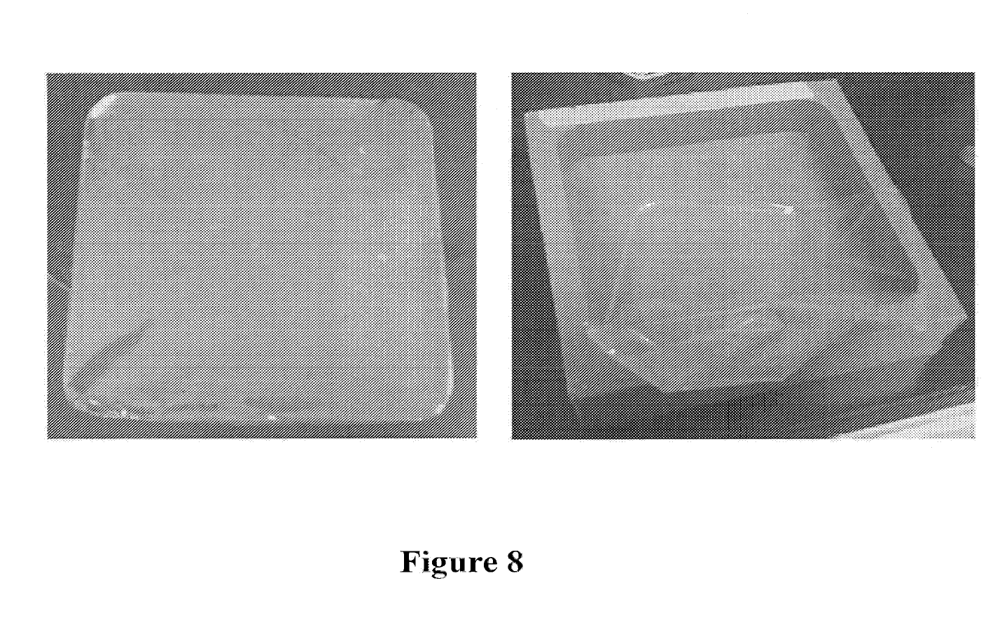

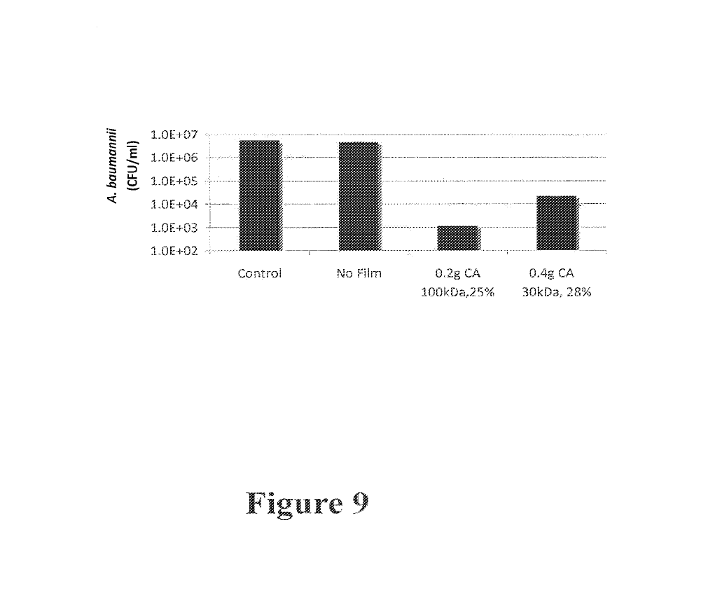

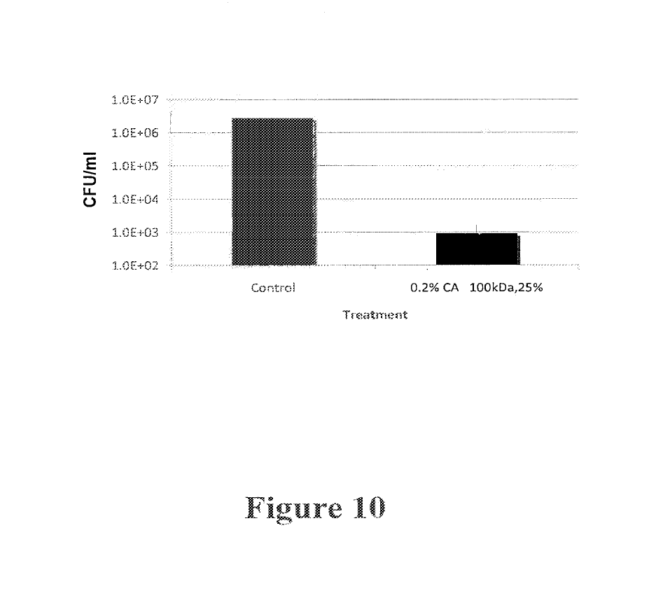

A thin film or coating treatment was developed to coat ventilation tubes and other surfaces of medical devices and instruments that might be used in hospitalized patients to reduce the incidence of nosocomial diseases such as ventilator induced respiratory infections. In this study the chitosan-arginine film was made by mixing 0.4% chitosan-arginine (28% functionalization, 30 kDa, 88% DDA, 2.1 PDI), 2% HPMC, and 40% ethanol with water and poured evenly into a 4×4′ Teflon mold. The mold was left in a biological hood for 48 hours to allow the ethanol to evaporate. The residual film is shown in FIG. 8. Then, two Hudson RCI uncuffed ET tubes were coated with a solution made of 0.2% chitosan-arginine (28% functionalization, 30 kDa, 88% DDA, 2.1 PDI), 2% HPMC, 40% ethanol, and 60% water. Two other ET tubes were coated with 0.4% chitosan-arginine (28% functionalization, 30 kDa, 88% DDA, 2.1 PDI), 2% HPMC, 20% ethanol, and 80% water. The tubes were allowed to dry overnight in a fume hood. The films were then evaluated for antimicrobial activity against A. baumannii, the most frequent cause of ventilator-associated pneumonia. The coated tubes and control tubes (no treatment) were cut in 2 cm sections and then in half and placed in 1.5 ml microfuge tubes. Then, 1 ml of A. baumannii in water at approximately 10⁶ cfu/ml was added to the tube to submerge it and incubated at room temperature for 1-hour. Following incubation the solution in the tube was mixed and an aliquant was removed, diluted and plated for cfu. We observed approximately 3.5-logs reduction in the bacteria with the sample made up with 100 kDa, 25% functionalization, 88% DDA, 3.2 PDI chitosan-arginine as opposed to a 2-log reduction in bacteria with 30 kDa, 28% functionalization, 88% DDA, 2.1 PDI chitosan-arginine (FIG. 9). The experiment was repeated using chitosan-arginine 100 kDa, 25% functionalization, 88% DDA, 3.2 PDI coating six tube sections with the same solution and the antibacterial activity were evaluated as previously described and showed that the observation was reproducible and a 3.5 log reduction in A. baumannii cfu/ml after 1-hour was observed (FIG. 10).

### Example 4

### Comparison of Chitosan Derivatives for Bactericidal Activity

Using a Gram-positive and a Gram-negative strain, we compared the rapid bactericide of several chitosan derivatives when dried on a surface in order to assure that the dried materials retained antibacterial activity. The chitosan-derivatives in Table 4 were diluted into 70% ethanol at a concentrations of 150 μg/mL and 25 μL of the solution was added to the wells of a 96 well plate and allowed to dry overnight, giving a final surface concentration of approximately 12 g/cm². After drying, 25 μL of bacterial culture at a concentration of 10⁶ cfu/mL were added to the wells. The cells were allowed to sit for 1 or 4 hours for A. baumannii or MRSA (MW-2 strain), respectively. Then the plates containing the bacteria were centrifuged at 4000 rpm for 10 minutes. The bacteria were then resuspended in 100 μL of appropriate culture media, Luria-Bertani broth (LB) for A. Baumannii or Todd Hewitt broth (TH) for MRSA, and the OD₅₉₅ was recorded for 18 hours at 5 minute intervals at 37° C. The time to reach an arbitrary threshold of 0.25 was then calculated, and from that value, virtual CFU (vCFU) was calculated using previously recorded the growth curves implementing the high through-put microtiter method (Brewster, J. D. J Microbiol Methods 2003; 53:77-86) to quantify virtual colony forming units (vCFU). In this method, a standard curve is generated using each bacterial culture adjusted to 0.1 OD₅₉₅ and several ten-fold dilutions of each culture. Each dilution was measured at 595 nm and grown up on agar plates to determine the corresponding colony forming units (CFU). The OD increased as the number of CFU's increases. These bacterial cultures were grown up in media at 37° C. with OD₅₉₅ readings taken every 5 minutes after a shaking step. An arbitrary threshold value OD₅₉₅=0.25 was used to determine a threshold time to achieve the same density of cells. The time it takes a sample to reach the threshold value OD₅₉₅=0.25 was inversely proportional to the number of cells present in the original sample, i.e. it takes more time to achieve an OD of 0.25 if the culture starts with fewer bacteria. The threshold times obtained are fit to the growth curve equation to obtain the vCFU for any measurement of this particular bacterium.

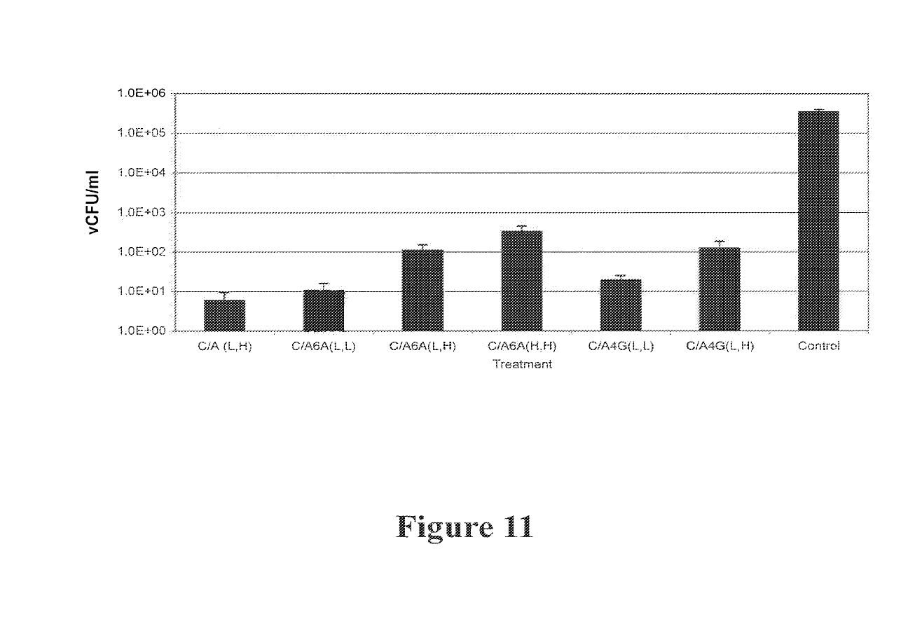

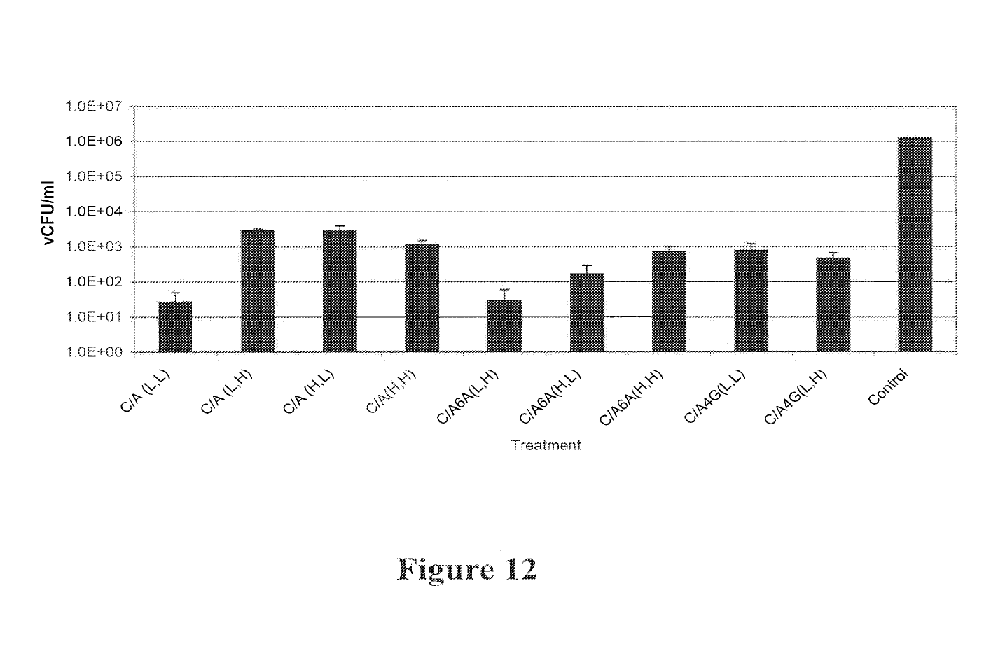

As shown in FIGS. 11 and 12, the chitosan derivatives were able to reduced A. baumannii and MRSA by approximately 3-logs after 1 or 4 hours exposure on the surface, respectively.

TABLE 4
Characterization of the chitosan derivatives used in FIGS. 11 and 12.

| | | | Molecular | |
|---|---|---|---|---|
| Derivative | PDI | Functionalization | Weight | Designation |
| Chitosan-arginine | 2.1 | 16% | 32 kDa | C/A(L, L) |
| Chitosan-arginine | 2.6 | 15% | 103 kDa | C/A(L, H) |
| Chitosan-arginine | 1.3 | 31% | 52 kDa | C/A(H, L) |
| Chitosan-arginine | 2.0 | 31% | 73 kDa | C/A(H, H) |
| Chitosan- | 2.6 | 12% | 57 kDa | C/A6A(L, L) |
| Aminocaproic | | | | |
| Acid | | | | |
| Chitosan- | 1.8 | 12% | 126 kDa | C/A6A(L, H) |
| Aminocaproic | | | | |
| Acid | | | | |
| Chitosan- | 1.9 | 34% | 43 kDa | C/A6A(H, L) |
| Aminocaproic | | | | |
| Acid | | | | |
| Chitosan- | 2.6 | 34% | 92 kDa | C/A6A(H, H) |
| Aminocaproic | | | | |
| Acid | | | | |
| Chitosan- | 2.3 | 13% | 31 kDa | C/A4G(L, L) |
| Guanidinobutyric | | | | |
| acid | | | | |
| Chitosan- | 3.5 | 12% | 84 kDa | C/A4G(L, H) |
| Guanidinobutyric | | | | |
| acid | | | | |

The % DDA for all these derivatives is 89%.
L, L refers to low functionalization, low molecular weight;
L, H refers to low functionalization, high molecular weight;
H, L refers to high functionalization, low molecular weight;
H, H refers to high functionalization, high molecular weight.

### Example 5

### Chitosan-Arginine Dose Response Against Stationary Bacterial Biofilms

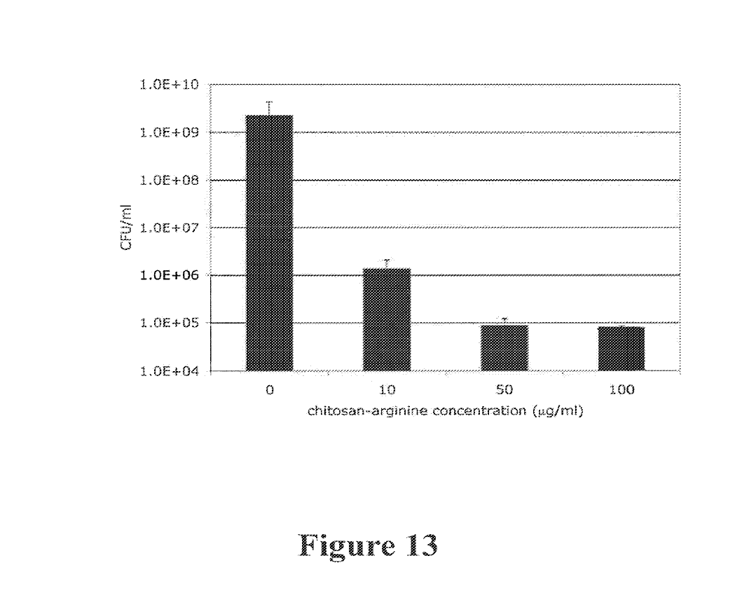

The MRSA (MW-2 strain) biofilms were grown in 12-well untreated tissue culture plates containing Brain Heart Infusion broth (BHI) media for approximately 2 days. The biofilms were rinsed with water three times and treated with increasing doses of chitosan-arginine for 4-hours. Following treatment the biofilms were rinsed three times and the chitosan-arginine treated biofilms were resuspended, sonicated, diluted and plated to obtain CFU remaining. As shown in FIG. 13, a 4-log reduction was achieved with 50 μg/ml treatment.

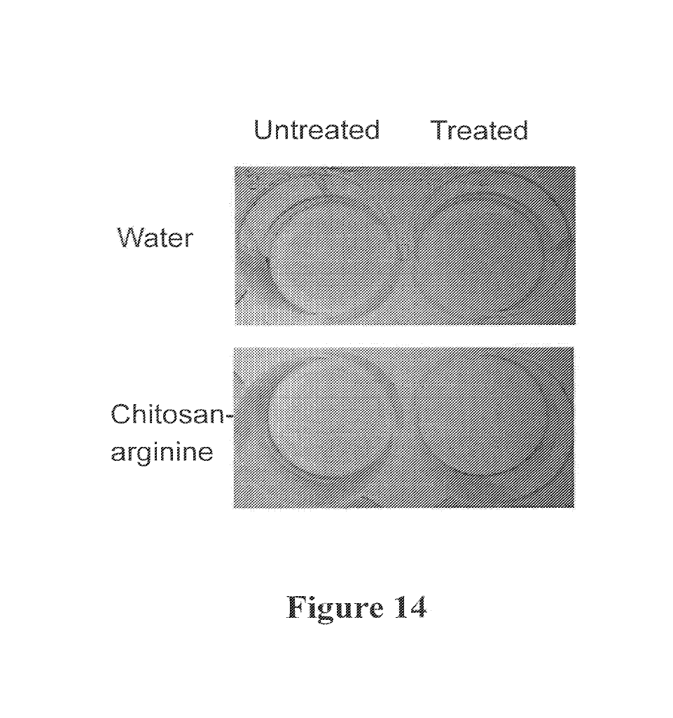

In a related experiment, the 3-day old MRSA MW-2 biofilms were rinsed with water three times and stained with crystal violet for 2 minutes. The biofilms were rinsed with water three times then treated with 100 μg/ml of chitosan-arginine or water for 5-minutes. Following treatment the biofilms were rinsed three times. As shown in FIG. 14, chitosan-arginine treated biofilms were removed from the surface while the water only treated biofilm was unaffected.

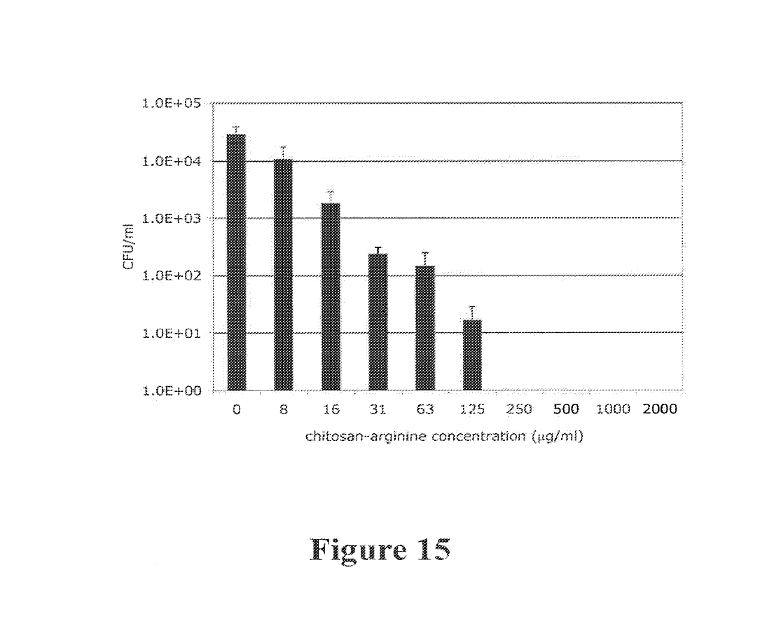

Chitosan-arginine was analyzed with respect to reduction of mature K. pneumoniae biofilms with previously established methods (Harrison J. J. et al., Environ. Microbiol. 7:981-994 (2005). The biofilms were grown according to MBEC™ for High-throughput Screening (Innovotech, Edmonton, AB Canada) methods on a peg lid placed in trough containing LB media for 36 hours. The pegs were rinsed and placed into a 96-well plate with serial dilutions of the chitosan derivative or controls and exposed for 5 hours at room temperature. The biofilms were rinsed, and the pegs removed and placed into microfuge tubes in 200 μl of water. The tubes were sonicated to remove the peg biofilm. Aliquots of recovered biofilms were diluted and plated onto LB agar to quantify growth. Testing was done in duplicate and representative assays are depicted. The K. pneumoniae biofilms showed that the bacterial CFU were significantly reduced by chitosan-arginine. As shown in FIG. 15, a 3-log reduction was observed with 125 μg/ml treatment.

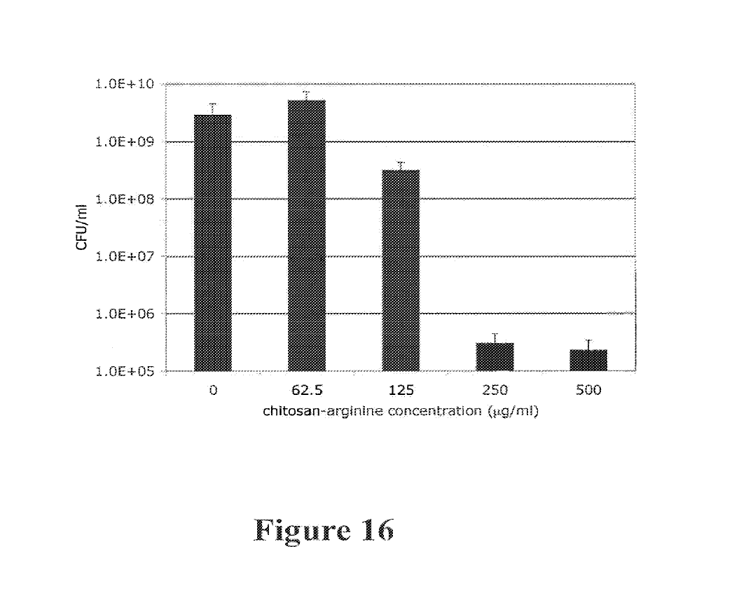

Chitosan-arginine was analyzed with respect to reduction of mature A. baumannii biofilms with previously established methods (Harrison J. J. et al., Environ. Microbiol. 7:981-994 (2005). The biofilms were grown according to MBEC™ for High-throughput Screening (Innovotech, Edmonton, AB Canada) methods on a peg lid placed in trough containing LB media for 36 hours. The pegs were rinsed and placed into a 96-well plate with serial dilutions of the chitosan derivative or controls and exposed for 3 hours at room temperature. The biofilms were rinsed, and the pegs removed and placed into microfuge tubes in 200 μl of water. The tubes were sonicated to remove the peg biofilm. Aliquots of recovered biofilms were diluted and plated onto LB agar to quantify growth. Testing was done in duplicate and representative assays are depicted. The A. baumannii biofilms showed that the bacterial CFU were significantly reduced by chitosan-arginine. As shown in FIG. 16, a 4-log reduction was observed with 250 μg/ml treatment.

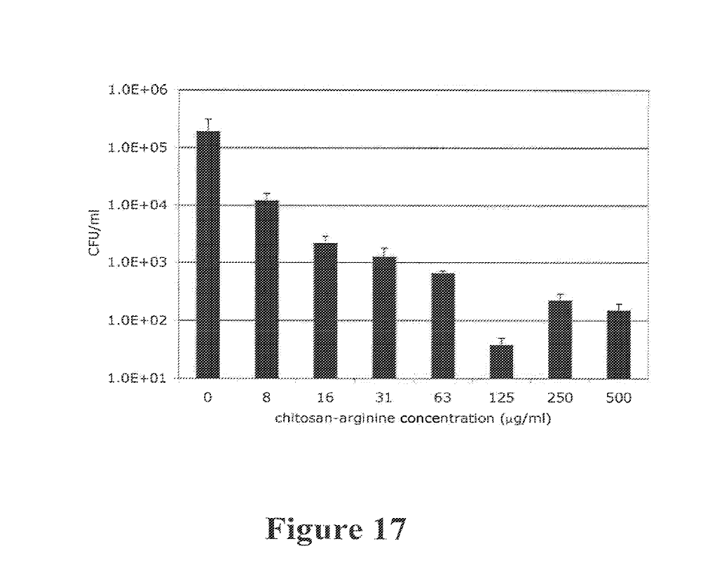

Chitosan-arginine was analyzed with respect to reduction of mature P. aeruginosa biofilms with previously established methods (Harrison J. J. et al., Environ. Microbiol. 7:981-994 (2005). The biofilms were grown according to MBEC™ for High-throughput Screening (Innovotech, Edmonton, AB Canada) methods on a peg lid placed in trough containing LB media for 36 hours. The pegs were rinsed and placed into a 96-well plate with serial dilutions of the chitosan derivative or controls and exposed for 3 hours at room temperature. The biofilms were rinsed, and the pegs removed and placed into microfuge tubes in 200 μl of water. The tubes were sonicated to remove the peg biofilm. Aliquots of recovered biofilms were diluted and plated onto LB agar to quantify growth. Testing was done in duplicate and representative assays are depicted. The P. aeruginosa biofilms showed that the bacterial CFU were significantly reduced by chitosan-arginine. As shown in FIG. 17, a 3-log reduction in CFU was observed with 125 μg/ml chitosan-arginine treatment.

### Example 6

### The Effect of Chitosan Derivatives on Biofilms Consisting of Mixed Bacterial Populations

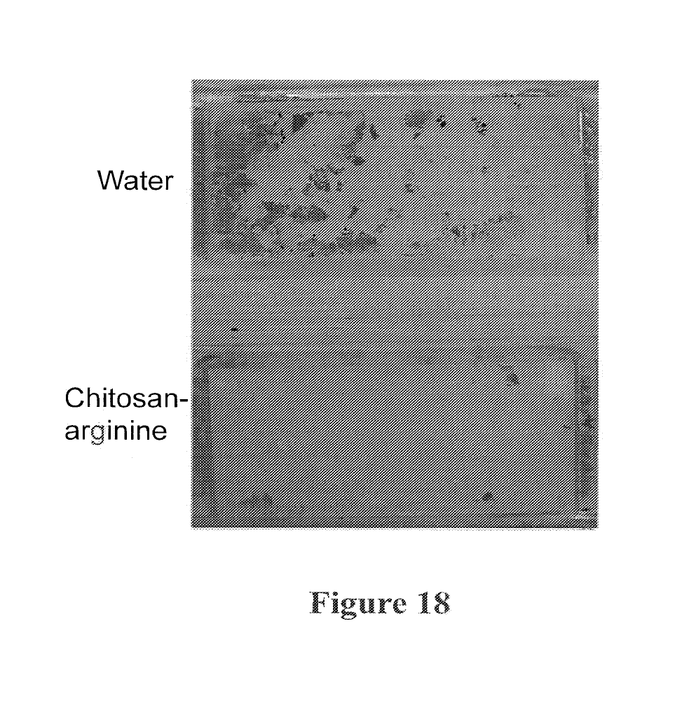

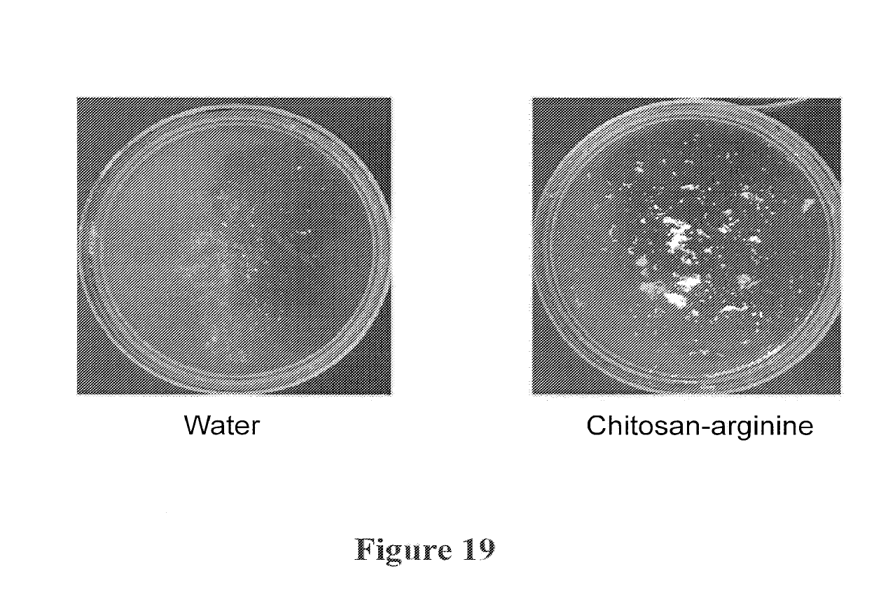

The interactions of chitosan derivatives with biofilms were evaluated in more detail in order to determine the effect of mixed populations in biofilms. In these experiments mixed bacterial populations consisting of MRSA MW-2, P. aeruginosa PA01, and Vancomycin-resistant E. faecalis were use to initiate biofilm growth in a flow cell to examine biofilm cohesion and in an artificial model. This experiment examined the ability of chitosan-arginine to reduce the cohesion of mixed biofilms. Each convertible flow cell slide chamber (Stovall Life Science Inc., CFCAS0003) was assembled into the convertible flow cell apparatus (Stovall Life Science Inc., CFCAS0001) including a bubble trap (Stovall Life Science Inc., ACCFL0002). The bacteria were grown overnight in LB media at 37° C. under anaerobic conditions, centrifuged and resuspended approximately 10⁸ cfu/ml of each in LB media. Each flow cell was primed with approximately 10 ml of the bacterial suspension. An initial attachment phase was carried out for 1 hour with a flow rate of 1.5 ml/min facilitated by an IsmaTec Low Flow, High Accuracy Multichannel Peristaltic Pump (Stovall Life Science Inc., ACCFL0013). Following the attachment phase the flow cells were rinsed and LB media was pumped in at a flow rate of 0.24 ml/min for 8-hours. The flow cells were rinsed for 2 minutes at approximately 29 ml/min with either water or chitosan-arginine at 200 μg/ml then media pumping was resumed overnight. Rinses were repeated at 22 and 26 hours post attachment. For the final rinse the flow cells were disconnected and place in a Petri dish full of water for 5 minutes. Excess water was wiped or drained from the slide careful not to disrupt the biofilm, then dried in a humid chamber 37° C. for 10 minutes. Cohesion was examined by submerging each slide in a beaker of water then sonicating for 30 seconds at amplitude 18 μm at the liquid surface. The slides were removed and excess water was wiped or drained from the slide careful not to disrupt the biofilm, then dried in a humid chamber 37° C. for 10 minutes. The slides were stained with crystal violet for 2-minutes, rinsed and qualitative assessment of biofilm remaining following mechanical disruption to simulate debridment was completed. As shown in FIG. 18, mixed biofilms treated with chitosan-arginine were less cohesive and were more easily dispersed than untreated biofilms. Further, as shown in FIG. 19, the material removed from the chitosan-arginine treated flow cell during the final rinse was more aggregated and dense and in a larger amount than the untreated mixed biofilm.

### Example 7

### Antibacterial Action of Chitosan Derivatives Against Food-Borne Bacteria in Chicken Juice

Verocytotoxin-producing Escherichia coli (VTEC) represents one of the most harmful food-borne pathogens that can enter the human food chain. In this study the antibacterial activity of functionalized chitosan was tested against pathogenic Escherichia coli O157 in chicken juice. The chicken juice was representative of the liquid which accumulates in food packaging and which is frequently implicated in food poisoning incidents. Briefly, aliquots of chicken juice (50 ml) were inoculated with a lux-marked strain of E. coli O157 to approximately 10⁵ cells ml⁻¹. Samples were subsequently mixed with chitosan-arginine of varying concentrations (0-500 mg l⁻¹) and incubated at 4 or 20° C. to mimic refrigeration and room temperatures respectively. Pathogen persistence and activity was subsequently quantified in the liquor at 0 (immediately after mixing), 3, 12, 24, 48, and 72 h post-incubation. The presence of chitosan-arginine significantly reduced both the numbers and metabolic activity of the pathogen in a dose-dependent manner with greater inhibition seen at higher temperatures. In addition, it also suppressed the growth of general food spoilage bacterial, reduced malodor prevented pathogen re-growth up to 72 h. These results indicate that the use of water soluble chitosan derivatives can help maintain both product shelf life and freshness as well minimizing the risk of food poisoning in both retail outlets and domestic homes.

### Materials and Methods

### Preparation of Chitosan-Arginine Solution

Chitosan-arginine (85% deacetylated with arginine constituting 25% of the total monomers on the polymer backbone; 71 kDa, purity>99%) was synthesized by Synedgen, Inc., Claremont, Calif., USA. A chitosan-arginine stock solution (1 g l⁻¹) was made in distilled water and the solution sterilized by passage through a 0.2 μm syringe filter for storage and later use.

Preparation of E. coli O157 Inoculum

A strain of E. coli O157 (#3704 Tn5 LuxCDABE; Ritchie et al., 2003) was prepared from a fresh overnight LB broth (Difco Ltd., Teddington, Surrey, UK; 37° C., 18 h, with shaking 150 rev min⁻¹) (Williams et al., FEMS Microbiology Letters, 287, 168-173, 2008) with 10% (v/v) added glycerol (Fisher Scientific, Itasca, Ill.). A 1 ml aliquot of the strain was allocated to 100 ml LB broth (Difco Ltd., Teddington, Surrey, UK; 37° C., 12 h, 150 rev min⁻¹). Cells were washed three times in ¼-strength Ringer's solution and concentrated by centrifugation as described in Avery et al. (Journal of Applied Microbiology, 98, 814-822, 2005). The strain has been proven to be non-toxigenic due to the absence of toxin activity; however it still accurately reflects survival patterns of toxigenic strains (Ritchie et al., Applied and Environment Microbiology 69, 3359-3367, 2003).

### Preparation of Chicken Juice

A total of six processed intact raw chickens (i.e. defeathered and eviscerated), were purchased from a commercial supermarket in Bangor, North Wales, UK. Each chicken was placed in a sterile stomacher bag and repeatedly washed with sterile distilled water to obtain a final wash solution volume of 600 ml per chicken. Chicken juice was selected as the testing media because it reflects a high nutrient enrichment environment typical of that in food packaging in which E. coli O157 multiplies. It also represents one of the major risk pathways for surface contamination and subsequent cross-contamination in the home. Changes in the chemistry of the chicken juice ±chitosan (500 μg ml⁻¹) were also monitored. Samples were chemically characterized in terms of their pH (pH-209 meter; Hanna Instruments Inc., Woonsocket, R.I.), electrical conductivity (CDM210 meter; Jenway Ltd., Dunmow, UK) and total organic C and N (TOC-VN analyser; Shimadzu Corp., Kyoto. Japan) at two time points, namely, 0 (immediately after addition) and 72 h post-incubation.

### Antibacterial Testing

Enumeration of E. coli O157 Counts and Metabolic Activity:

Chicken juice (30 ml) was aliquoted into 21×50 ml sterilized polypropylene tubes. Overnight cultures of the lux-marked E. coli O157 (grown to log phase) were then inoculated into the chicken juice to approximately 10⁵ cells ml⁻¹. Chitosan-arginine was then added to the tubes to get a range of final concentrations of 100, 200, 400, 500 μg ml⁻¹. Samples were taken for microbial enumeration at 0 (immediately after incubation), 3, 12, 24, 48, 72 h post-incubation and numbers of E. coli O157 determined by the drop-plate method. Briefly, 0.1 ml of the samples was spread onto three SMAC plates (Oxoid CM813) supplemented with cefixime (0.05 mg l⁻¹) and potassium telluride (2.5 mg l⁻¹), which were then incubated at 37° C. for 48 h. Presumptive E. coli O157 colonies (non-sorbitol-fermenting) were confirmed by agglutination with a latex test kit (Oxoid DR0620). Luminescence of E. coli O157 was measured at the same sampling points using a Tecan Infinite 200® PRO luminometer (Tecan Austria GmbH, Grodig, Austria). Results of luminescence measurements were displayed in RLU (Relative Luminescence Units) where 1 RLU corresponds to 1 count s⁻¹. All treatments were preformed in triplicate.

### Enumeration of Coliforms and Total Viable Counts:

Total viable counts (indicator of a food product's general microbiological load and shelf-life determinant; Forsythe, 2000) and coliforms in control chicken juice (not inoculated with E. coli O157) ±500 μg ml⁻¹ chitosan-arginine were enumerated in triplicate. Samples (0.1 ml) were diluted 10-fold and 0.1 ml was subsequently spread onto plate count agar (Oxoid, CM813) and incubated at 37° C. for 48 h. Another 0.1 ml of each sample was diluted in a similar way and spread onto Oxoid Brilliance™ E. coli/coliform selective agar (Oxoid CM 1046).

### Statistical Analyses

Data were analyzed using SPSS Statistics (IBM version 16.0 for Windows). All plate count data for E. coli O157 were log 10 (x+1) transformed prior to analysis to meet the assumptions of ANOVA. Multivariate analyses were used to analyze the effects of chitosan-arginine concentration on luminescence and transformed cell counts, whereas t-tests were used to analyze the effect of environmental temperature on these two dependent variables. Post-hoc tests using Tukey HSD at p<0.05 were adopted to identify significant differences between each treatment condition. Student t-tests were performed with 2-tailed significance to detect the effects of temperature (4° C. versus 20° C.) and chitosan-arginine on total viable counts and coliform numbers.

### Results

### Changes in Chicken Juice Chemistry During Storage

The chemical characteristics of the chicken juice samples are shown in Table 5. Overall, the pH values did not change significantly across the 72 h post-incubation period within the samples, although the chicken juice treated with chitosan-arginine exhibited a significantly higher pH (p<0.001). Similarly, total C and N concentrations remained relatively constant over time, although the chicken juice treated with chitosan-arginine had significantly lower concentrations than the controls (p<0.001).

TABLE 5
Chemical characterization of chicken juice and chicken juice amended
with 500 μg ml⁻¹ chitosan-arginine. Time refers to hours post-
addition with the chitosan-arginine (0 h refers to immediately after
additions). Values represent means ± SEM (n = 3).

| | | | Chicken juice + chitosan- | |
|---|---|---|---|---|
| | Chicken juice | | arginine | |
| | 0 h | 72 h | 0 h | 72 h |
| pH | 6.42 ± 0.01 | 6.39 ± 0.03 | 6.76 ± 0.01 | 6.74 ± 0.02 |
| Electrical | 1.56 ± 0.01 | 1.67 ± 0.01 | 0.77 ± 0.01 | 0.88 ± 0.01 |
| conductivity | | | | |
| (mS cm⁻¹) | | | | |
| Total | 6.86 ± 0.08 | 7.19 ± 0.02 | 4.22 ± 0.05 | 4.45 ± 0.10 |
| organic C | | | | |
| (mg C l⁻¹) | | | | |
| Total | 3.99 ± 0.19 | 4.08 ± 0.05 | 1.80 ± 0.13 | 1.98 ± 0.02 |
| organic N | | | | |
| (mg N l⁻¹) | | | | |

Effects of Chitosan-Arginine on E. coli O157 Cell Counts

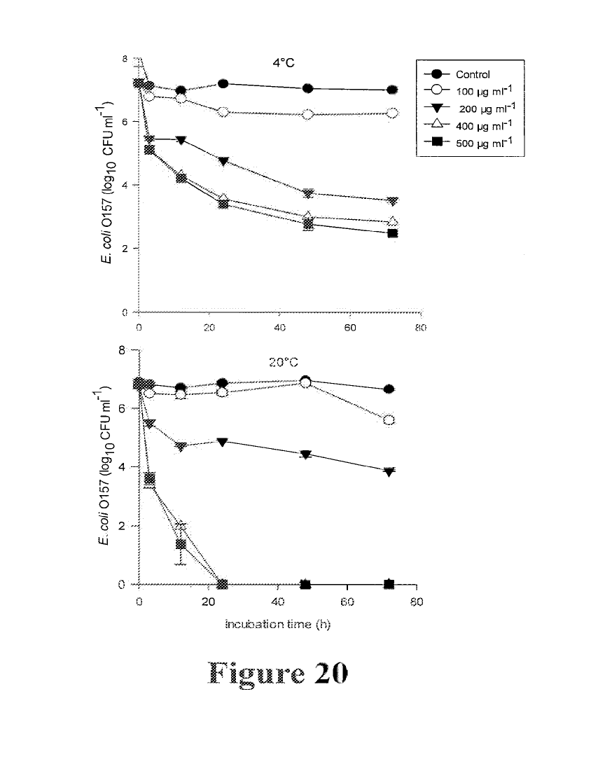

The antimicrobial action of chitosan-arginine against E. coli O157 in chicken juice is shown in FIG. 20. At both 4 and 20° C., post-hoc LSD pairwise comparisons showed that chicken juice amended with chitosan-arginine caused significant reductions in pathogen cell counts, compared with the control treatment (p<0.001). This antimicrobial effect is immediate as evidenced by the dramatic reduction in E. coli cell counts within 3 h. Over the subsequent 72 h period, cell counts continued to progressively decline. The bactericidal effect of chitosan-arginine was concentration-dependent, with higher concentrations (400-500 μg ml⁻¹) causing significantly greater cell count reductions than at lower concentrations (100-200 μg ml⁻¹). Overall, the addition of chitosan-arginine at higher concentrations caused a 4.25 log count reductions at 4° C. and a 7 log count reduction at 20° C. after 72 h. In contrast, chitosan-arginine added at the lowest concentration (100 μg ml⁻¹) only reduced numbers by only 0.5 log cell count at 4° C., and 1.5 log cell counts at 20° C. Statistical analysis revealed that temperature was a significant factor regulating chitosan-arginine's antimicrobial effects (p=0.003, 2-tailed t-test), with higher environmental temperatures leading to a stronger antimicrobial action.

Effects of Chitosan-Arginine on E. coli O157 Cell Activity

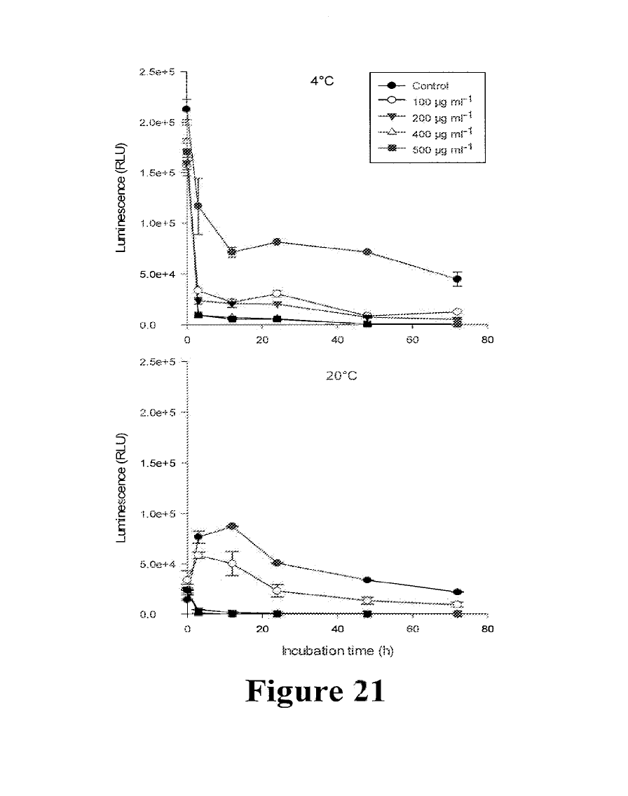

Statistical analysis indicated that chitosan-arginine had a significant inhibitory effect against E. coli O157 activity as indexed by the reduction in luminescence (FIG. 21). At 4° C., E. coli cell activity was immediately reduced in all treatments within 3 h post-incubation, however, the addition of chitosan-arginine caused a significantly greater reduction (p<0.001), although its action was relatively independent of chitosan-arginine concentration. At 20° C., E. coli O157 activity initially increased in the control and 100 μg ml⁻¹ chitosan-arginine treatments, however, after 12 h bacterial cell activity progressively declined. For the other treatment groups with chitosan-arginine concentrations ranging from 200-500 μg ml⁻¹, bacterial luminescence dropped close to zero within 3 h post-incubation. Statistical analysis again indicated that temperature was a significant regulator of chitosan-arginine's inhibitory action (p<0.001), with higher temperatures increasing chitosan-arginine's inhibitory effect.

### Effects of Chitosan-Arginine on Coliforms and Total Viable Counts

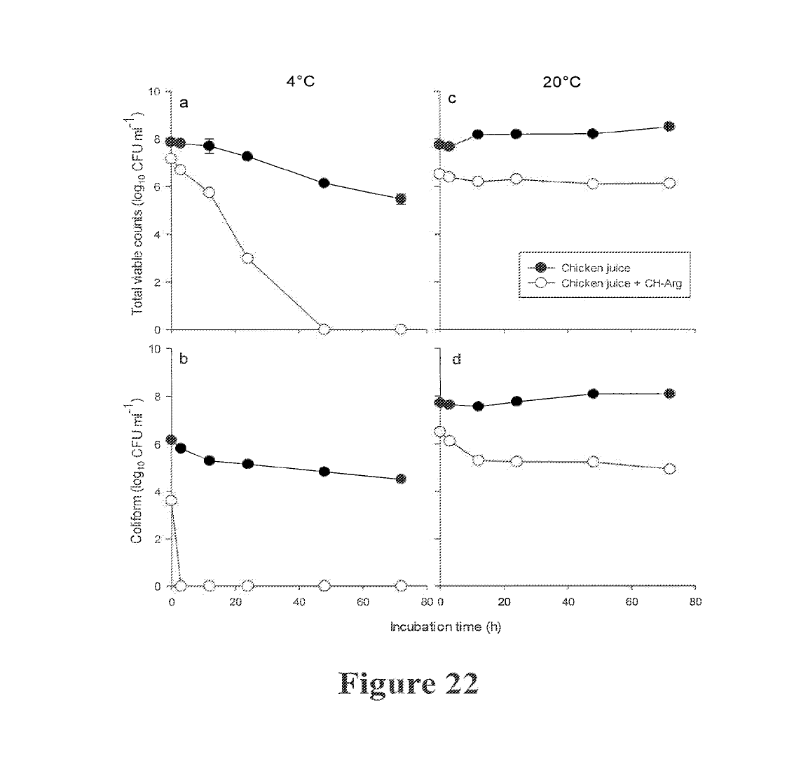

Statistical analyses revealed that both total viable counts and coliform numbers were significantly less in chicken juice samples treated with chitosan-arginine in comparison to the control treatment (p<0.001; FIG. 22). Importantly, at 4° C., chitosan-arginine induced a rapid decline in total viable counts and coliforms (FIG. 22a, b); whereas at 20° C., the presence of chitosan-arginine led to a moderate decline (FIG. 22c, d). Compared with an industry standard (Malpass et al., Food Microbiology, 27, 521-525, 2010), total viable counts and coliform numbers at both temperatures were sufficiently low to be fit for human consumption.

1. A method of reducing bacteria on an inert surface and/or a non-animal surface, the method comprising:
contacting an effective amount of a composition comprising a derivatized chitosan with the surface,
thereby reducing bacteria, e.g., bacterial contamination, on the surface.

2. (canceled)

3. The method of claim 1, wherein the derivatized chitosan comprises a chitosan of the following formula (I): 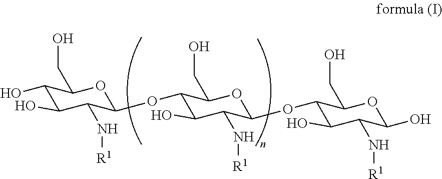
wherein:
n is an integer between 20 and 6000; and
each R¹ is independently selected for each occurrence from hydrogen, acetyl, 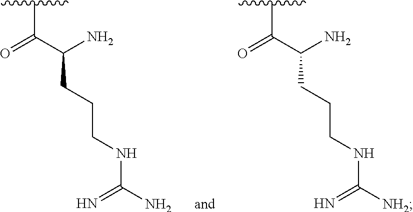 [SMILES: *C(=O)[C@@H](N)CCCNC(=N)N ; "and" ; *C(=O)[C@H](N)CCCNC(=N)N]
wherein at least 25% of R¹ substituents are H, at least 1% of R¹ substituents are acetyl, and at least 2% of R¹ substituents are

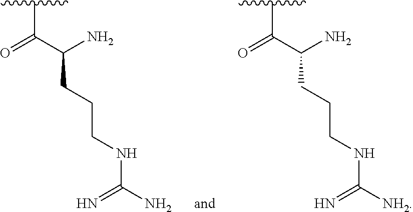 [SMILES: *C(=O)[C@@H](N)CCCNC(=N)N ; "and" ; *C(=O)[C@H](N)CCCNC(=N)N]

4-5. (canceled)

6. The method of claim 3, wherein between 1-50% of R¹ substituents are acetyl.

7. The method of claim 3, wherein between 2-50% of R¹ substituents are

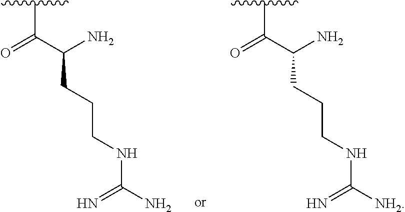 [SMILES: *C(=O)[C@@H](N)CCCNC(=N)N ; "or" ; *C(=O)[C@H](N)CCCNC(=N)N]

8. The method of claim 3, wherein 55-90% of R¹ substituents are hydrogen, 4-20% of R¹ substituents are acetyl, 4-30% of R¹ substituents are

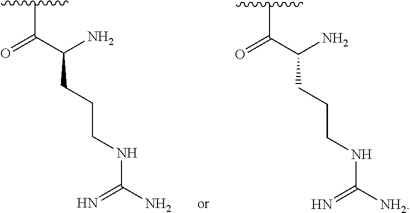 [SMILES: *C(=O)[C@@H](N)CCCNC(=N)N ; *C(=O)[C@H](N)CCCNC(=N)N]

9-34. (canceled)

35. The method of claim 3, wherein the chitosan is functionalized at between 5% and 50%.

36-40. (canceled)

41. The method of claim 1, wherein the composition sanitizes the surface.

42. The method of claim 1, wherein the composition is biocompatible or biodegradable, compared to an existing standard operating procedure.

43. The method of claim 1, wherein the composition is a liquid composition.

44. The method of claim 1, further comprising allowing the liquid to be removed or the surface to dry after the composition has been contacted with the surface.

45. The method of claim 1, wherein the composition is a dry powder composition.

46. (canceled)

47. The method of claim 1, wherein the composition reduces the bacteria by at least 90%.

48. The method of claim 1, wherein the effective amount is between about 0.1 and about 2.0 μg/cm².

49. The method of claim 1, wherein the surface is a synthetic or semi-synthetic surface.

50. The method of claim 1, wherein the surface is selected from the group consisting of a cellulose surface, a ceramic surface, a plastic surface, a metal surface, a glass surface, a wood surface, a rubber surface, a stone surface, and a hybrid thereof.

51. The method of claim 1, wherein the surface is a non-porous surface.

52. (canceled)

53. The method of claim 1, wherein the bacteria comprise Gram-negative and/or Gram-positive bacteria.

54. (canceled)

55. The method of claim 1, wherein the bacteria are resistant to one or more of antibiotics.

56. The method of claim 1, wherein the bacteria comprise Salmonella choleraesuis, Staphylococcus aureus, Klebsiella pneumoniae, Enterobacter aerogenes, Pseudomonas aeruginosa, MRSA, E. coli, vancomycin resistant Enterococcus faecalis, Acinetobacter baumannii, MDR Acinetobacter baumannii, or MDR Klebsiella pneumoniae.

57. (canceled)

58. A method of reducing the ability of a biofilm to form, or bacteria to grow, on an inert surface or a non-animal surface, the method comprising:
contacting an effective amount of a composition comprising a derivatized chitosan with the surface,
thereby reducing the ability of a biofilm to form, or bacteria to grow, on the surface.

59-67. (canceled)
